(19) United States
(12) Patent Application Publication
(10) Pub. No.: US 2025/0140843 A1
(43) Pub. Date: May 1, 2025

(54) POSITIVE ELECTRODE ACTIVE MATERIAL AND SECONDARY BATTERY

(71) Applicant: SEMICONDUCTOR ENERGY LABORATORY CO., LTD., Atsugi-shi (JP)

(72) Inventors: Mayumi MIKAMI, Atsugi (JP); Jo SAITO, Atsugi (JP); Teruaki OCHIAI, Atsugi (JP); Masahiro TAKAHASHI, Atsugi (JP); Tatsuyoshi TAKAHASHI, Atsugi (JP); Yohei MOMMA, Isehara (JP); Kazutaka KURIKI, Ebina (JP); Kazune YOKOMIZO, Tokyo (JP); Shunpei YAMAZAKI, Tokyo (JP); Rihito WADA, Atsugi (JP)

(21) Appl. No.: 18/927,228

(22) Filed: Oct. 25, 2024

(30) Foreign Application Priority Data
Oct. 31, 2023 (JP) 2023-186796
Nov. 28, 2023 (JP) 2023-200455
Feb. 19, 2024 (JP) 2024-022686
Apr. 11, 2024 (JP) 2024-063843

(51) Int. Cl. H01M 4/525; H01M 4/02; H01M 4/36; H01M 10/052; H01M 10/0568; H01M 10/0569

(52) U.S. Cl. CPC H01M 4/525; H01M 4/366; H01M 10/052; H01M 10/0568; H01M 10/0569; H01M 2004/028

(57) ABSTRACT

To provide a positive electrode active material in which a phase transition is inhibited and a secondary battery including the positive electrode active material. An unprecedented synthesis method has been developed in which lithium cobalt oxide particles are treated with a molten salt of MgF₂—LiF as a reaction accelerator to facilitate the diffusion and doping of magnesium into lithium cobalt oxide bulk and to form a stable coating layer in the particle surface portion. Ex situ XRD analysis confirms the inhibition of the harmful phase transition and the emergence of a novel phase as the modified LiCoO₂ is charged up to 4.7 V. The modified LiCoO₂ shows high electrochemical performance during high-voltage operation. This technology provides a guideline for suppressing fundamental degradation associated with phase transition and achieving ultra-high energy density LiCoO₂ positive electrodes.

### BACKGROUND OF THE INVENTION

### 1. Field of the Invention

One embodiment of the present invention relates to an object, a method, or a manufacturing method. The present invention relates to a process, a machine, manufacture, or a composition of matter. One embodiment of the present invention relates to a power storage device, a semiconductor device, a display device, a light-emitting device, a lighting device, an electronic device each including a secondary battery, or a manufacturing method thereof.

Note that electronic devices in this specification mean all devices including power storage devices, and electro-optical devices including power storage devices, information terminal devices including power storage devices, and the like are all electronic devices.

### 2. Description of the Related Art

The emergence of portable electronic devices, such as smartphones or tablets, has significantly transformed human life. The demand for high-capacity secondary batteries demonstrates continuous growth with the continuous integration and enhancement of device features. Owing to its superior energy density, lithium cobalt oxide (LiCoO₂; hereinafter also referred to as LCO) remains the most promising candidate for high-capacity lithium-ion batteries, widely adopted in mobile devices. Lithium cobalt oxide has a theoretical capacity of 274 mAh/g. However, its highly delithiated state, i.e., a high cut-off voltage charged state, degrades the battery performance, forcing recent lithium cobalt oxide-based products to be used at a cut-off voltage of 4.47 V for full cells. The above potential for full cells correspond to a potential of approximately 4.55 V versus Li⁺/Li and a discharge capacity of 200 mAh/g.

Factors, such as side reactions on lithium cobalt oxide surface, cobalt dissolution, oxygen release, crystal structure change, and crack formation, contribute to the degradation in capacity during charge/discharge cycling. To mitigate the degradations at high cut-off voltage, various techniques have been applied to lithium cobalt oxide and secondary batteries including lithium cobalt oxide by elemental doping, surface coating, and improvement of an electrolyte solution (Non-Patent Documents 1 to 20).

Lithium cobalt oxide exhibits an α-NaFeO₂ (layered rock salt) crystal structure in the R-3m space group, and it belongs to the O3 phase, which is characterized by ABCABC oxygen stacking sequence. When lithium is extracted from lithium cobalt oxide at a high voltage, lithium cobalt oxide undergoes a phase transition from the O3 phase to the H1-3 phase and then to the O1 phase (note that the O1 phase represents ABAB oxygen stacking and the H1-3 phase is a hybrid of the O1 phase and the O3 phase with ABABCACABCBC oxygen stacking). This transition involves a structural change, which is equivalent to gliding of the CoO₂ slabs, generating stress in the crystal. This structural change may induce crack formation and/or crystallinity degradation, thereby compromising the performance of batteries including lithium cobalt oxide. Hence, effectively preventing the phase transition from the O3 phase to the H1-3 phase is crucial for achieving stable charge/discharge cycling when the cut-off voltage exceeds 4.55 V versus Li⁺/Li. Generally, the phase transition and volume change caused by electrochemical insertion/extraction of cations are common issues that result in the degradation of electrochemical properties. Therefore, effective mitigation of these phenomena is not only critical for lithium cobalt oxide but also for the development of other positive electrode active materials.

### REFERENCES

### Non-Patent Documents

[Non-Patent Document 1] Tukamoto, H. & West, A. R. Electronic conductivity of LiCoO₂ and its enhancement by magnesium doping. J. Electrochem. Soc. 144, 3164-3168 (1997).
[Non-Patent Document 2] Bae, J. G. et al. Structural evolution of Mg-doped single-crystal LiCoO₂ cathodes: importance of morphology and Mg-doping sites. ACS Appl. Mater. Interfaces 15, 7939-7948 (2023).
[Non-Patent Document 3] Mladenov, M., Stoyanova, R., Zhecheva, E. & Vassilev, S. Effect of Mg doping and MgO-surface modification on the cycling stability of LiCoO₂ electrodes. Electrochem. Commun. 3, 410-416 (2001).
[Non-Patent Document 4] Jang Y. I. et al. Synthesis and characterization of LiAl_{y}Co_{1-y}O₂ and LiAl_{y}Ni_{1-y}O₂. J. Power Sources 81-82, 589-593 (1999).
[Non-Patent Document 5] Luo, W. & Dahn, J. R. Comparative study of Li[Co_{1-z}Al_{z}]O₂ prepared by solid-state and co-precipitation methods. Electrochim. Acta 54, 4655-4661 (2009).
[Non-Patent Document 6] Liu, A., Li, J., Shunmugasundaram, R. & Dahn, J. R. Synthesis of Mg and Mn doped LiCoO₂ and effects on high voltage cycling. J. Electrochem. Soc. 164, A1655-A1664 (2017).
[Non-Patent Document 7] Zhang, J. N. et al. Trace doping of multiple elements enables stable battery cycling of LiCoO₂ at 4.6V. Nat. Energy 4, 594-603 (2019).
[Non-Patent Document 8] Kong, W. et al. Unraveling the distinct roles of Mg occupation on Li or Co sites on high-voltage LiCoO₂. J. Electrochem. Soc. 168, 030528 (2021).
[Non-Patent Document 9] Shim, J-H., Lee, S. & Park, S. S. Effects of MgO coating on the structural and electrochemical characteristics of LiCoO₂ as cathode materials for lithium ion battery. Chem. Mater. 26, 2537-2543 (2014).
[Non-Patent Document 10] Cho, J., Kim, Y. J. & Park, B. Novel LiCoO₂ cathode material with Al₂O₃ coating for a Li ion cell. Chem. Mater. 12, 3788-3791 (2000).
[Non-Patent Document 11] Lee, J. G., Kim, B., Cho, J., Kim, Y. W. & Park, B. Effect of AlPO₄-nanoparticle coating concentration on high-cutoff-voltage electrochemical performances in LiCoO₂. J. Electrochem. Soc. 151, A801-A805 (2004).
[Non-Patent Document 12] Qian, J. et al. Electrochemical surface passivation of LiCoO₂ particles at ultrahigh voltage and its applications in lithium-based batteries. Nat. Commun. 9, 4918 (2018).
[Non-Patent Document 13] Moon, S. H. et al. TiO₂-coated LiCoO₂ electrodes fabricated by a sputtering deposition method for lithium-ion batteries with enhanced electrochemical performance. RSC Adv. 9, 7903-7907 (2019).
[Non-Patent Document 14] Taguchi, N., Akita, T., Tatsumi, K. & Sakaebe, H. Characterization of MgO-coated-LiCoO₂ particles by analytical transmission electron microscopy. J. Power Sources 328, 161-166 (2016).
[Non-Patent Document 15] He, Y. et al. A bi-functional strategy involving surface coating and subsurface gradient co-doping for enhanced cycle stability of LiCoO₂ at 4.6 V. J. Energy Chem. 77, 553-560 (2023).
[Non-Patent Document 16] Orikasa, Y. et al. Origin of surface coating effect for MgO on LiCoO₂ to improve the interfacial reaction between electrode and electrolyte. Adv. Mater. Interfaces 1, 1400195 (2014).
[Non-Patent Document 17] Yang, X. et al. Pushing lithium cobalt oxides to 4.7 V by lattice-matched interfacial engineering. Adv. Energy Mater. 12, 2200197 (2022).
[Non-Patent Document 18] Takahashi, Y. et al. Structure and electron density analysis of electrochemically and chemically delithiated LiCoO₂ single crystals. J. Solid State Chem. 180, 313-321 (2007).
[Non-Patent Document 19] Chen, Z., Lu, Z. & Dahn, J. R. Staging phase transitions in LiₓCoO₂. J. Electrochem. Soc. 149, A1604-A1609 (2002).
[Non-Patent Document 20] Van der Ven, A., Aydinol, M. K., Ceder, G., Kresse, G. & Hafner, J. First-principles investigation of phase stability in LiₓCoO₂. Phys. Rev. B 58, 2975-2987 (1998).
[Non-Patent Document 21] Momma, K. & Izumi, F. VESTA3 for three-dimensional visualization of crystal, volumetric and morphology data. J. Appl. Crystallogr. 44, 1272-1276 (2011).

### SUMMARY OF THE INVENTION

Magnesium doping and coating can improve the electrochemical performance of lithium cobalt oxide at a high voltage. Recent research has shown that doping of Mg²⁺ ions in the lithium sites of lithium cobalt oxide can improve its electrochemical performance by serving as pillars between adjacent CoO₂ slabs (Non-Patent Documents 14 and 17 and the like). However, studies have failed to achieve satisfactory electrochemical reversibility of lithium insertion/extraction during high-voltage charging.

In view of the above, an object of one embodiment of the present invention is to provide a positive electrode active material in which a phase transition due to charging and discharging at a cut-off voltage higher than 4.55 V (versus Li⁺/Li) is inhibited. Another object of one embodiment of the present invention is to provide a positive electrode active material or a composite oxide with which a decrease in discharge capacity due to charge/discharge cycles is inhibited. Another object of one embodiment of the present invention is to provide a positive electrode active material or a composite oxide having a crystal structure that is unlikely to be broken by repeated charging and discharging. Another object of one embodiment of the present invention is to provide a positive electrode active material or a composite oxide with high discharge capacity. Another object of one embodiment of the present invention is to provide a secondary battery with high safety or high reliability.

Another object of one embodiment of the present invention is to provide a positive electrode active material, a composite oxide, a power storage device, or a manufacturing method thereof.

Note that the description of these objects does not preclude the existence of other objects. In one embodiment of the present invention, there is no need to achieve all these objects. Other objects can be derived from the description of the specification, the drawings, and the claims.

To solve any of the above problems, as one embodiment of the present invention, the present inventors propose a method for the effective integration of magnesium into lithium cobalt oxide through treatment with molten fluoride salt as an additive. Moreover, the incorporation of nickel and aluminum as added elements further increases the electrochemical stability.

A magnesium-enriched rock salt structure emerges in the surface portion of lithium cobalt oxide after synthesis, forming a coherent bond with the bulk material. Ex situ X-ray diffraction (XRD) analysis can prove that the lithium cobalt oxide of one embodiment of the present invention experiences a phase transition to a compressed O3 phase (referred to as “O3′ phase” in this specification and the like) at 4.7 V without undergoing a transformation to the H1-3 phase. The lithium cobalt oxide of one embodiment of the present invention achieves excellent results: capacity retention of 96.4% and 72.7% after 100 cycles at cut-off voltages of 4.6 V and 4.7 V, respectively.

By including a mixture of a fluorine-substituted organic solvent and propane sultone as a solvent of an electrolyte solution, a secondary battery can have higher charge/discharge cycling performance even at a high cut-off voltage.

One embodiment of the present invention is a positive electrode active material including lithium cobalt oxide to which magnesium, fluorine, nickel, and aluminum are added. The positive electrode active material in a discharged state has a layered rock salt crystal structure belonging to an R-3m space group. The layered rock salt crystal structure in the discharged state has a c lattice parameter greater than 14.055 Å and has goodness-of fit (GOF) less than or equal to 1.4 when fitted as LiCoO₂ with the R-3m space group and subjected to Rietveld refinement. The positive electrode active material includes a surface portion and a bulk region. The surface portion includes a magnesium-rich rock salt structure region. The magnesium-rich rock salt structure region is coherently bonded to the bulk region.

In the above, the c lattice parameter is preferably less than 14.060 Å.

Another embodiment of the present invention is a positive electrode active material including lithium cobalt oxide to which magnesium, fluorine, nickel, and aluminum are added. A narrow-scan spectrum of Mg 1s of the positive electrode active material obtained by X-ray photoelectron spectroscopy exhibits a maximum intensity at a binding energy between a binding energy at which a narrow-scan spectrum of Mg 1s of magnesium oxide obtained by X-ray photoelectron spectroscopy exhibits a maximum intensity and a binding energy at which a narrow-scan spectrum of Mg 1s of magnesium fluoride obtained by X-ray photoelectron spectroscopy exhibits a maximum intensity.

In the above, the narrow-scan spectrum of Mg 1s of the positive electrode active material obtained by X-ray photoelectron spectroscopy preferably exhibits the maximum intensity at a binding energy greater than 1303.3 eV and less than 1306.3 eV.

When a cross section of a particle of the above positive electrode active material is analyzed with an electron probe microanalyzer, it is preferable that Mg/Co (atomic ratio) be greater than or equal to 0.005 and less than or equal to 0.015 and Al/Co (atomic ratio) be less than or equal to 0.005.

Another embodiment of the present invention is a positive electrode active material including lithium cobalt oxide to which magnesium, fluorine, nickel, and aluminum are added. The positive electrode active material in a discharged state has a layered rock salt crystal structure belonging to an R-3m space group. When a charge/discharge cycling test under a 25° C.-environment is conducted on a cell in which the positive electrode active material is used for a positive electrode, lithium metal is used for a negative electrode, and a mixture of lithium hexafluorophosphate, ethylene carbonate, and diethyl carbonate with 2 wt % vinylene carbonate is used as an electrolyte solution, and then, the positive electrode in a discharged state is analyzed by powder X-ray diffraction using Cu Kα₁ radiation, a peak with a half width less than or equal to 0.08° appears within a 2θ range of 18.7° to 19.0°, and a peak with a half width less than or equal to 0.12° appears within a 2θ range of 45.0° to 45.3°. In the charge/discharge cycling test, a charge/discharge cycle in which constant current charging at a current value of 0.5 C (note that 1 C=200 mA/g) is performed up to a voltage of 4.7 V, constant voltage charging is performed until the current value reaches 0.05 C, a rest period of 10 minutes is allowed, constant current discharging at a current value of 0.5 C is performed up to a voltage of 2.5 V, and then, a rest period of 10 minutes is allowed is repeated 100 times.

In the above, it is preferable that volumetric energy density calculated using true density of the positive electrode active material be higher than or equal to 4250 Wh/L, and gravimetric energy density calculated using true density of the positive electrode active material be higher than or equal to 865 Wh/kg.

Another embodiment of the present invention is a secondary battery which includes the above-described positive electrode active material and an electrolyte solution and in which the electrolyte solution includes 1 M LiPF₆ dissolved in FEC/MTFP at a volume ratio of 2:8 with 5 wt % PS.

According to one embodiment of the present invention, a positive electrode active material in which a phase transition due to charging and discharging at a cut-off voltage higher than 4.55 V (versus Li⁺/Li) is inhibited can be provided. According to another embodiment of the present invention, a positive electrode active material or a composite oxide with which a decrease in discharge capacity due to charge/discharge cycles is inhibited can be provided. According to another embodiment of the present invention, a positive electrode active material or a composite oxide having a crystal structure that is unlikely to be broken by repeated charging and discharging can be provided. According to another embodiment of the present invention, a positive electrode active material or a composite oxide with high discharge capacity can be provided. According to another embodiment of the present invention, a secondary battery with high safety or high reliability can be provided.

According to another embodiment of the present invention, a positive electrode active material, a composite oxide, a power storage device, or a manufacturing method thereof can be provided.

Note that the description of these effects does not preclude the existence of other effects. One embodiment of the present invention does not need to have all the effects. Other effects will be apparent from and can be derived from the description of the specification, the drawings, the claims, and the like.

### BRIEF DESCRIPTION OF THE DRAWINGS

In the accompanying drawings:

FIG. 1 is a schematic view illustrating a method for fabricating a positive electrode active material of one embodiment of the present invention and a surface and a bulk of the positive electrode active material;

FIG. 2 is a flowchart illustrating a fabrication process of a positive electrode active material of one embodiment of the present invention;

FIGS. 3A and 3B are graphs showing DSC results;

FIGS. 4A to 4C are graphs showing DSC results;

FIGS. 5A and 5B are graphs showing DSC results;

FIG. 6 is a schematic view illustrating phase changes in a reference positive electrode material and a positive electrode active material of one embodiment of the present invention;

FIGS. 7A and 7B illustrate calculation models;

FIGS. 8A to 8C illustrate a crystal structure of a positive electrode active material of one embodiment of the present invention, and FIGS. 8D and 8E illustrate examples of lithium arrangement;

FIGS. 9A to 9E illustrate examples of lithium arrangement;

FIG. 10 illustrates an example of lithium arrangement;

FIGS. 11A to 11C illustrate examples of lithium arrangement;

FIG. 12 illustrates an example of lithium arrangement;

FIGS. 13A to 13D each illustrate a positive electrode of one embodiment of the present invention;

FIGS. 14A and 14B illustrate lithium-ion batteries of embodiments of the present invention;

FIGS. 15A to 15C illustrate a lithium-ion battery of one embodiment of the present invention;

FIGS. 16A to 16D illustrate a lithium-ion battery and a power storage system of embodiments of the present invention;

FIGS. 17A to 17C illustrate a lithium-ion battery of one embodiment of the present invention;

FIGS. 18A to 18C illustrate a lithium-ion battery of one embodiment of the present invention;

FIGS. 19A to 19C illustrate an electric vehicle of one embodiment of the present invention;

FIGS. 20A to 20D illustrate transport vehicles of embodiments of the present invention;

FIGS. 21A to 21C illustrate a motorcycle and the like of embodiments of the present invention;

FIGS. 22A to 22D illustrate electronic devices and the like of embodiments of the present invention;

FIGS. 23A to 23D show examples of a device for space;

FIGS. 24A to 24C show XRD patterns of reference positive electrode active materials and a positive electrode active material of one embodiment of the present invention;

FIGS. 25A to 25J show SEM images, HAADF-STEM images, and nanobeam electron diffraction patterns of a reference positive electrode active material and a positive electrode active material of one embodiment of the present invention;

FIGS. 26A to 26J show SEM images and SEM-EDX mapping images of a positive electrode active material of one embodiment of the present invention in its synthesis steps;

FIGS. 27A to 27F show SEM images and SEM-EDX mapping images of a positive electrode active material of one embodiment of the present invention in its synthesis steps;

FIG. 28 shows XPS spectra of a reference positive electrode active material and a positive electrode active material of one embodiment of the present invention;

FIGS. 29A and 29B show XPS spectra of a positive electrode active material of one embodiment of the present invention in its synthesis steps;

FIGS. 30A to 30C are STEM-EDX elemental mapping images of a surface portion of a positive electrode active material of one embodiment of the present invention and graphs showing results of STEM-EDX line analysis of the surface portion;

FIG. 31 shows STEM-EDX elemental mapping images of a surface portion of a positive electrode active material of one embodiment of the present invention;

FIGS. 32A and 32B show charge/discharge cycling performance of a half cell including a reference positive electrode active material and a half cell including a positive electrode active material of one embodiment of the present invention;

FIGS. 33A and 33B are graphs showing charge/discharge curves and rate performance of a half cell including a reference positive electrode active material and a half cell including a positive electrode active material of one embodiment of the present invention;

FIG. 34 is a graph showing rate performance of a half cell including a reference positive electrode active material and a half cell including a positive electrode active material of one embodiment of the present invention;

FIGS. 35A and 35B are graphs showing charge/discharge cycling performance and charge/discharge curves of a half cell including a reference positive electrode active material and a half cell including a positive electrode active material of one embodiment of the present invention;

FIGS. 36A and 36B are graphs showing charge/discharge cycling performance of full cells including a positive electrode active material of one embodiment of the present invention;

FIGS. 37A to 37C show ex situ XRD patterns of a positive electrode including a reference positive electrode active material in a discharged state and a positive electrode including a positive electrode active material of one embodiment of the present invention in a discharged state;

FIGS. 38A to 38H are SEM images of a reference positive electrode active material and a positive electrode active material of one embodiment of the present invention after cycling;

FIGS. 39A and 39B show cycling performance of positive electrode active materials whose SEM images were obtained;

FIGS. 40A to 40D show HAADF-STEM images and nanobeam electron diffraction patterns of surface portions of a reference positive electrode active material and a positive electrode active material of one embodiment of the present invention after charge/discharge cycling tests;

FIGS. 41A to 41C show ex situ XRD patterns of positive electrodes including a reference positive electrode active material in charged states;

FIGS. 42A to 42C show ex situ XRD patterns of positive electrodes including a positive electrode active material of one embodiment of the present invention in charged states;

FIGS. 43A to 43C show ex situ XRD patterns of positive electrodes including a reference positive electrode active material in charged states;

FIGS. 44A to 44C show ex situ XRD patterns of positive electrodes including a positive electrode active material of one embodiment of the present invention in charged states;

FIG. 45 is a graph showing dQ/dV curves of a positive electrode active material of one embodiment of the present invention during charging and discharging;

FIGS. 46A to 46C show ex situ XRD patterns of positive electrodes including reference positive electrode active materials and a positive electrode including a positive electrode active material of one embodiment of the present invention in a charged state;

FIGS. 47A and 47B are graphs showing charge/discharge cycling performance of half cells including reference positive electrode active materials and a half cell including a positive electrode active material of one embodiment of the present invention;

FIGS. 48A to 48C are graphs showing ex situ XRD patterns of positive electrodes including reference positive electrode active materials and a positive electrode including a positive electrode active material of one embodiment of the present invention in a charged state;

FIGS. 49A and 49B are graphs showing charge/discharge cycling performance of half cells including reference positive electrode active materials and a half cell including a positive electrode active material of one embodiment of the present invention;

FIGS. 50A and 50B are graphs showing charge/discharge cycling performance of half cells including reference positive electrode active materials;

FIGS. 51A and 51B are graphs showing charge/discharge cycling performance of half cells including reference positive electrode active materials and a half cell including a positive electrode active material of one embodiment of the present invention;

FIGS. 52A and 52B are graphs showing charge/discharge cycling performance of half cells including reference positive electrode active materials and a half cell including a positive electrode active material of one embodiment of the present invention;

FIG. 53 is a graph showing volumetric energy densities and gravimetric energy densities of reference positive electrode active materials and a positive electrode active material of one embodiment of the present invention;

FIG. 54 shows ex situ XRD patterns of positive electrodes including a positive electrode active material of one embodiment of the present invention in discharged states;

FIGS. 55A and 55B show ex situ XRD patterns of positive electrodes including a positive electrode active material of one embodiment of the present invention in discharged states;

FIG. 56 shows ex situ XRD patterns of positive electrodes including a positive electrode active material of one embodiment of the present invention in charged states; and

FIGS. 57A and 57B show ex situ XRD patterns of positive electrodes including a positive electrode active material of one embodiment of the present invention in charged states.

### DETAILED DESCRIPTION OF THE INVENTION

Hereinafter, embodiment examples for carrying out the present invention will be described with reference to the drawings and the like. Note that the present invention should not be construed as being limited to the embodiment examples given below. Embodiments for carrying out the invention can be changed unless they deviate from the spirit of the present invention.

In the drawings, the size, the layer thickness, or the region is sometimes exaggerated for clarity. Therefore, the size, the layer thickness, or the region is not limited to the illustrated scale.

The ordinal numbers such as “first” and “second” in this specification and the like are used for convenience and do not denote the order of steps or the stacking order of layers. Therefore, for example, description can be made even when “first” is replaced with “second”, “third”, or the like as appropriate. In addition, the ordinal numbers in this specification and the like are not necessarily the same as those used to specify one embodiment of the present invention.

In this specification and the like, a space group is represented using the short symbol of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, crystal planes, crystal orientations, and space groups are sometimes expressed by placing a minus sign (−) in front of a number instead of placing a bar over the number. Furthermore, an individual direction that shows an orientation in crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”. A trigonal system represented by the R-3m space group is generally represented by a composite hexagonal lattice for easy understanding of the structure. In some cases, not only (hkl) but also (hkil) is used as the Miller index. Here, i is −(h+k). In this specification and the like, a crystal plane or the like in the R-3m space group is represented with use of a composite hexagonal lattice, unless otherwise specified.

In this specification and the like, description including a simple term “positive electrode active material” explains a plurality of positive electrode active material particles in some cases and explains one positive electrode active material particle in other cases, depending on an analysis method or the like. For example, when description relates to line analysis by a scanning transmission electron microscope-energy dispersive X-ray (STEM-EDX) detector, STEM-electron energy-loss spectroscopy (STEM-EELS), or electron diffraction, the description is made on one positive electrode active material particle unless otherwise specified. Meanwhile, when description relates to X-ray photoelectron spectroscopy (XPS), X-ray diffraction (XRD), various types of mass spectroscopy, or the like, the description is made on a plurality of positive electrode active material particles unless otherwise specified.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape. In addition, a simple term “particle” includes a primary particle and a secondary particle.

In the case where the features of positive electrode active material particles are described, not all the particles necessarily have the features. When 50% or more, preferably 70% or more, further preferably 90% or more of three or more randomly selected particles of a positive electrode active material have the later-described preferable features, for example, it can be said that an effect of improving the characteristics of the positive electrode active material and a secondary battery including the positive electrode active material is sufficiently obtained.

The distribution of an element indicates the region where the element is successively detected by a successive analysis method to the extent that the detection value is no longer on the noise level. The region where the element is successively detected to the extent that the detection value is no longer on the noise level can be rephrased as, for example, the region where the element is detected every time the analysis is performed.

In this specification and the like, an added element can be rephrased as part of a raw material or a mixture.

The theoretical capacity of a positive electrode active material refers to the amount of electricity obtained when all lithium that can be inserted into and extracted from the positive electrode active material is extracted. For example, the theoretical capacity of LiCoO₂ is 274 mAh/g, the theoretical capacity of LiNiO₂ is 275 mAh/g, and the theoretical capacity of LiMn₂O₄ is 148 mAh/g.

The remaining amount of lithium that can be inserted into and extracted from a positive electrode active material is represented by x in a compositional formula, e.g., LiₓMO₂ (here, M is one or more selected from cobalt, nickel, and manganese). In the case of a positive electrode active material in a secondary battery, x can be represented by (theoretical capacity−charge capacity)/theoretical capacity. For example, when a secondary battery that includes LiMO₂ as a positive electrode active material is charged to 219.2 mAh/g, the positive electrode active material can be represented by Li_{0.2}MO₂, i.e., x=0.2. Note that “x in LiₓMO₂ is small” means, for example, 0.1<x≤0.24. In addition, the amount of lithium extracted from the positive electrode active material with respect to the theoretical capacity is sometimes represented by a charge depth. In this specification and the like, the charge depth=1−x.

For example, lithium cobalt oxide to be used for a positive electrode, which has been appropriately synthesized and almost satisfies the stoichiometric proportion, is LiCoO₂ with x of 1. Also in a secondary battery after its discharging ends, it can be said that lithium cobalt oxide therein is LiCoO₂ with x of 1. Here, “discharging ends” means that the voltage becomes 3.0 V or 2.5 V or lower at a current of 100 mA/g or lower, for example.

Charge capacity and/or discharge capacity used for calculation of x in LiₓMO₂ are/is preferably measured under the conditions where there is no influence or small influence of a short circuit and/or decomposition of an electrolyte solution or the like. For example, data of a secondary battery containing a sudden capacity change that seems to result from a short circuit should not be used for calculation of x.

The space group of a crystal structure is identified by XRD, electron diffraction, neutron diffraction, or the like. Thus, in this specification and the like, belonging to a space group or being a space group can be rephrased as being identified as a space group.

Furthermore, when the arrangement of anions is close to a cubic close-packed structure, the arrangement can be regarded as the cubic close-packed structure. The arrangement of anions forming the cubic close-packed structure refers to a state where anions in the second layer are positioned right above voids between anions packed in the first layer, and anions in the third layer are placed at the positions that are positioned right above voids between the anions in the second layer and are not positioned right above the anions in the first layer. Accordingly, anions do not necessarily form a cubic lattice structure. Actual crystals always have a defect and thus, analysis results are not necessarily consistent with the theory. For example, in an electron diffraction pattern or a fast Fourier transform (FFT) pattern of a TEM image or the like, a spot may appear in a position different from a theoretical position. For example, anions may be regarded as forming a cubic close-packed structure when a difference in orientation from a theoretical position is 5° or less or 2.5° or less.

A positive electrode active material to which an added element increasing conductivity and/or an added element stabilizing a crystal structure are/is added is sometimes referred to as a composite oxide, a positive electrode member, a positive electrode material, a secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a complex.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can inhibit a decrease in charge/discharge capacities due to repeated charging and discharging.

Note that the description is made on the assumption that materials (such as a positive electrode active material, a negative electrode active material, an electrolyte, and a separator) of a secondary battery have not been degraded unless otherwise specified. A decrease in discharge capacity due to aging treatment and burn-in treatment during the manufacturing process of a secondary battery is not regarded as degradation. For example, a state where discharge capacity is higher than or equal to 97% of the rated capacity of a lithium-ion secondary battery cell and an assembled lithium-ion secondary battery (hereinafter, referred to as a lithium-ion secondary battery) can be regarded as a non-deteriorated state. The rated capacity conforms to Japanese Industrial Standards (JIS C 8711:2019) in the case of a lithium-ion secondary battery for a portable device. The rated capacities of other lithium-ion secondary batteries conform to JIS described above, JIS for electric vehicle propulsion, industrial use, and the like, standards defined by the International Electrotechnical Commission (IEC), and the like.

In this specification and the like, in some cases, materials that are included in a secondary battery and that have not been degraded are referred to as initial products or materials in an initial state, and materials that have been degraded (have discharge capacity lower than 97% of the rated capacity of the secondary battery) are referred to as products in use, materials in a used state, products that are already used, or materials in an already-used state.

### Embodiment 1

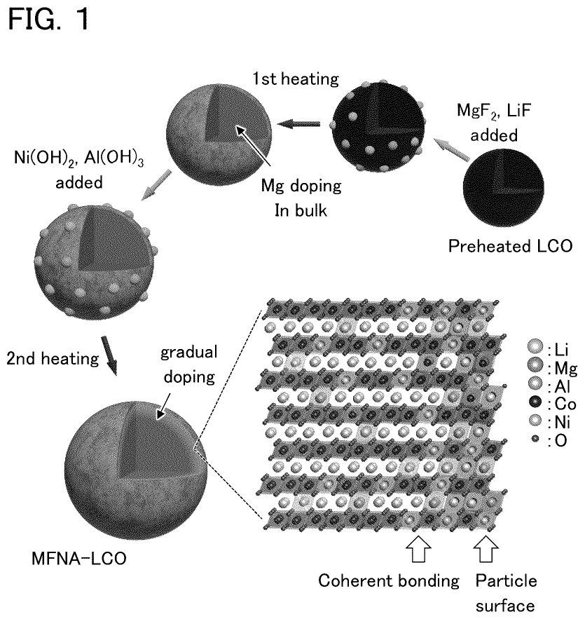

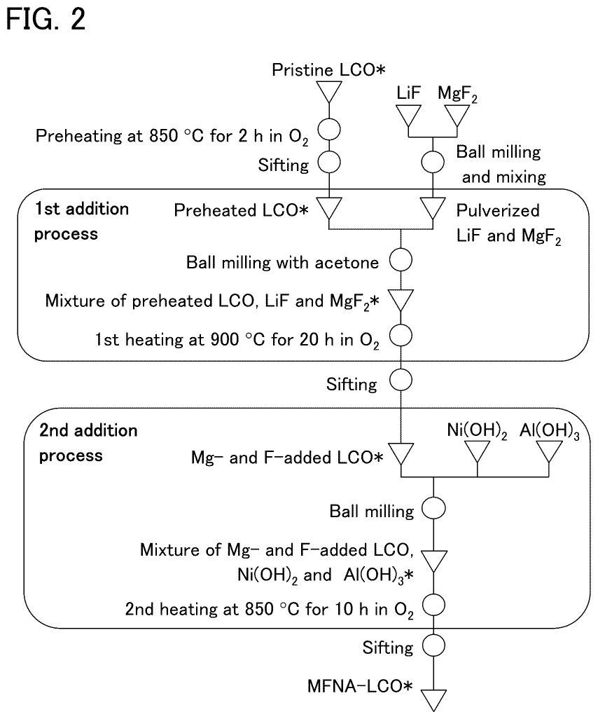

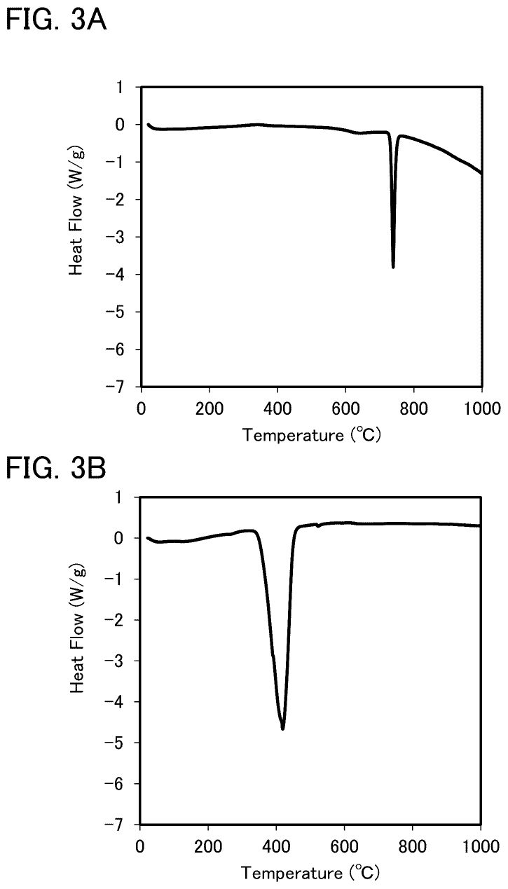

This embodiment will describe features of a fabrication method of a positive electrode active material of one embodiment of the present invention and the positive electrode active material with reference to FIG. 1, FIG. 2, FIGS. 3A and 3B, FIGS. 4A to 4C, FIGS. 5A and 5B, FIG. 6, FIGS. 7A and 7B, FIGS. 8A to 8E, FIGS. 9A to 9E, FIG. 10, FIGS. 11A to 11C, and FIG. 12. Note that the positive electrode active material of one embodiment of the present invention is sometimes referred to as MFNA-LCO, which includes the initials of the names of the added elements, for simple denotation in the drawings.

The positive electrode active material of one embodiment of the present invention includes lithium cobalt oxide to which magnesium, fluorine, nickel, and aluminum are added. Note that the composition of the lithium cobalt oxide (LCO or LiCoO₂) is not strictly limited to Li:Co:O=1:1:2.

The positive electrode active material of one embodiment of the present invention has, in a discharged state, a layered rock salt crystal structure belonging to the R-3m space group. This crystal structure has a c lattice parameter greater than 14.055 Å and less than 14.060 Å. Note that in the crystal structure analysis of the positive electrode active material in a discharged state, GOF is preferably less than or equal to 2.0, further preferably less than or equal to 1.4.

A positive electrode active material of a lithium-ion secondary battery needs to contain a transition metal which can take part in an oxidation-reduction reaction in order to maintain a neutrally charged state even when lithium ions are inserted and extracted. It is preferable that the positive electrode active material of one embodiment of the present invention mainly contain cobalt as a transition metal taking part in an oxidation-reduction reaction. Using cobalt at greater than or equal to 95 atomic %, preferably greater than or equal to 98 atomic %, further preferably greater than or equal to 99 atomic % as the transition metal contained in the positive electrode active material brings many advantages such as relatively easy synthesis, easy handling, and excellent cycling performance, which is preferable.

The positive electrode active material of one embodiment of the present invention includes a surface portion and a bulk. The positive electrode active material sometimes includes a crystal grain boundary.

In this specification and the like, the surface portion of the positive electrode active material refers to a region that extends less than or equal to 10 nm from the surface toward the bulk in a perpendicular direction or a substantially perpendicular direction. Thus, the surface portion includes the surface. Note that “substantially perpendicular” refers to a state where an angle is greater than or equal to 80° and less than or equal to 100°. A plane generated by a closed split and/or a crack can be considered as a surface. The surface portion can be rephrased as the vicinity of a surface, a region in the vicinity of a surface, or a shell and includes the outermost surface.

The bulk refers to a region that is at a larger depth than the surface portion of the positive electrode active material. The bulk can be rephrased as an inner portion or a core.

A crystal grain boundary refers to, for example, a portion where particles of a positive electrode active material adhere to each other, or a portion where a crystal orientation changes inside a positive electrode active material, i.e., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional transmission electron microscope (TEM) image, a cross-sectional STEM image, or the like, i.e., a structure including another atom between lattices, a cavity, or the like. A crystal grain boundary can be regarded as a plane defect. The vicinity of a crystal grain boundary refers to a region extending less than or equal to 10 nm from the crystal grain boundary.

The positive electrode active material of one embodiment of the present invention includes magnesium, fluorine, nickel, and aluminum, which are added elements, in the surface portion. Furthermore, the detection amounts of the added elements in the surface portion are preferably higher than those in the bulk.

In the case where the positive electrode active material of one embodiment of the present invention includes a crystal grain boundary, at least some of the added elements of magnesium, fluorine, nickel, and aluminum are preferably included in the vicinity of the crystal grain boundary. That is, the detection amount(s) of the added element(s) in the vicinity of the crystal grain boundary is/are preferably larger than that in the surface portion and a portion other than the vicinity of the crystal grain boundary.

In the bulk of the positive electrode active material of one embodiment of the present invention, the preferable amount is different between the added elements. Magnesium is preferably present in a slight amount in the bulk to inhibit a later-described phase transition. Nickel is also preferably present in a slight amount in the bulk. By contrast, in the center portion of the bulk, fluorine and aluminum are preferably absent or present in so small amounts that they cannot be detected. This is because the added elements, which are necessary for inhibiting a phase transition, have adverse effects such as lowering crystallinity and charge/discharge capacities when present in excessive amounts in the bulk.

Thus, when the bulk of a particle of the positive electrode active material of one embodiment of the present invention is subjected to cross-sectional analysis using an electron probe microanalyzer (EPMA), Mg/Co (atomic ratio) is preferably greater than or equal to 0.005 and less than or equal to 0.015. Furthermore, Ni/Co (atomic ratio) is preferably greater than or equal to 0.002 and less than or equal to 0.05, further preferably greater than or equal to 0.03 and less than or equal to 0.01.

In the bulk, F/Co (atomic ratio) is preferably less than or equal to 0.01, and fluorine is further preferably not detected. Al/Co (atomic ratio) is preferably less than or equal to 0.005, and aluminum is further preferably not detected.

Lithium cobalt oxide is susceptible to thermal decomposition in air above 950° C. However, magnesium oxide (MgO) is extraordinarily thermally stable, with a melting point of 2852° C. When lithium cobalt oxide and magnesium oxide powders are heated below the decomposition temperatures of lithium cobalt oxide, the solid-state reactions within the conventional mixing and baking processes tend to be inhomogeneous and slow. Therefore, the introduction of magnesium into lithium cobalt oxide has been difficult when using conventional doping and coating techniques.

In view of this, the present inventors have decided to use molten fluoride salts to facilitate the diffusion and doping of magnesium into the lithium cobalt oxide bulk. This method involves coating the lithium cobalt oxide particle surface portion with excess magnesium at the same time as the diffusion of magnesium into the bulk.

FIG. 1 is a schematic view showing a method for fabricating the positive electrode active material of one embodiment of the present invention using fluorides acting as a reaction accelerator, and the surface and bulk of the positive electrode active material. The surface portion includes a magnesium-rich rock salt structure region, and the rock salt structure region is coherently bonded to the bulk region. The schematic view of the coherent bonding structure was drawn by VESTA (Non-Patent Document 21). The use of the fluorides acting as a reaction accelerator enables effective diffusion and doping of the added element such as magnesium into the lithium cobalt oxide particle surface portion and the bulk.

The fluorides acting as a reaction accelerator are preferably fluorides of typical metal elements. For example, lithium fluoride (LiF), sodium fluoride (NaF), potassium fluoride (KF), and a mixture thereof are preferable because these materials have a melting point close to the decomposition temperature of lithium cobalt oxide and lower than the decomposition temperature of lithium cobalt oxide, and have a high level of safety. In view of the use for lithium-ion batteries, lithium fluoride is particularly preferably included as the fluoride acting as a reaction accelerator.

FIG. 2 is a flowchart illustrating an example of a method for fabricating the positive electrode active material of one embodiment of the present invention. The six samples with asterisks in the flowchart were analyzed by XPS and SEM-EDX in Example 1. Note that the present invention is not limited to the method in FIG. 2. For example, any temperature and any time are acceptable as long as they are sufficient to melt the fluorides used as the reaction accelerator and do not decompose lithium cobalt oxide. The optimal ranges of the heating temperature and the heating time may depend on the particle diameter of lithium cobalt oxide as a starting material (hereinafter also referred to as pristine LCO). The addition of the added elements may be performed at another timing or may be performed a plurality of times. The timing of the addition may be different between the elements.

### <<DSC>>

Here, the results of differential scanning calorimetry (DSC) measurements are shown in FIGS. 3A and 3B, FIGS. 4A to 4C, and FIGS. 5A and 5B. The DSC measurements were conducted using Thermo Plus (EVO2 DSC8271, Rigaku) at a heating rate of 20° C./min from room temperature to 1000° C. An alumina pan ($5 mm×2.5 mm), and Al₂O₃ powder as a reference were used.

FIG. 3A shows the DSC result of the sample where MgF₂ and LiF powders were mixed in a molar ratio of 3:1. The initial melting temperature is 731.4° C., while the peak melting temperature is 739.3° C. This result indicates the eutectic point of MgF₂ and LiF. Consequently, when subjected to the proposed temperature (e.g., 900° C.) in this specification and the like, these compounds undergo a transition from solid to liquid phase and convert into molten salt.

FIG. 3B shows the DSC result of Mg(OH)₂ powder. The initial and maximum decomposition temperatures are 357.6° C. and 418.8° C., respectively.

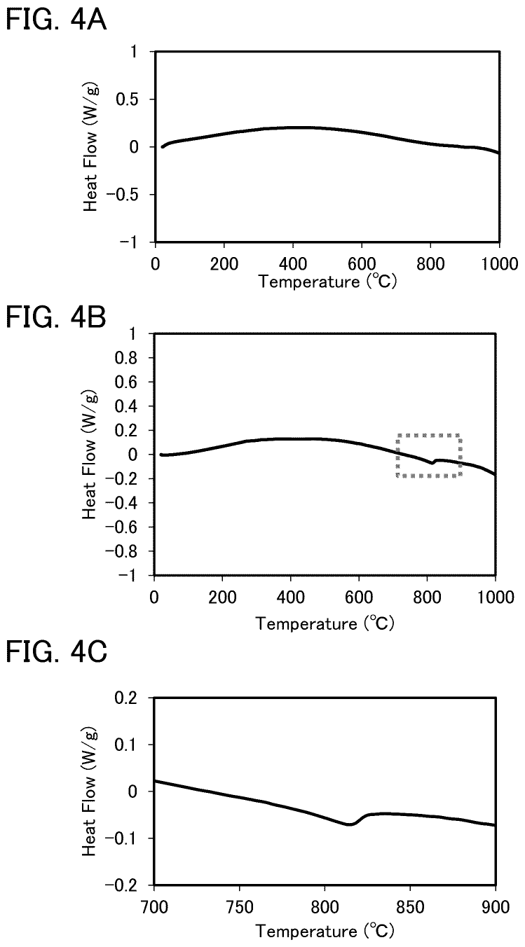

FIG. 4A shows the DSC measurement result of pristine LCO powder. FIG. 4B shows the DSC measurement result of the sample where pristine LCO, LiF, and MgF₂ powders were mixed 1:0.003:0.01 in molar ratio. FIG. 4C is an enlarged view of the region enclosed by the dotted rectangle in FIG. 4B. The initial reaction temperature is 778.6° C. and the peak reaction temperature is 814.5° C. These temperatures are slightly lower than the decomposition temperature of lithium cobalt oxide and higher than the eutectic point of MgF₂ and LiF (731.4° C.) shown in FIG. 3A. This suggests that the lithium cobalt oxide particle surface reacts with the magnesium-containing fluoride liquid.

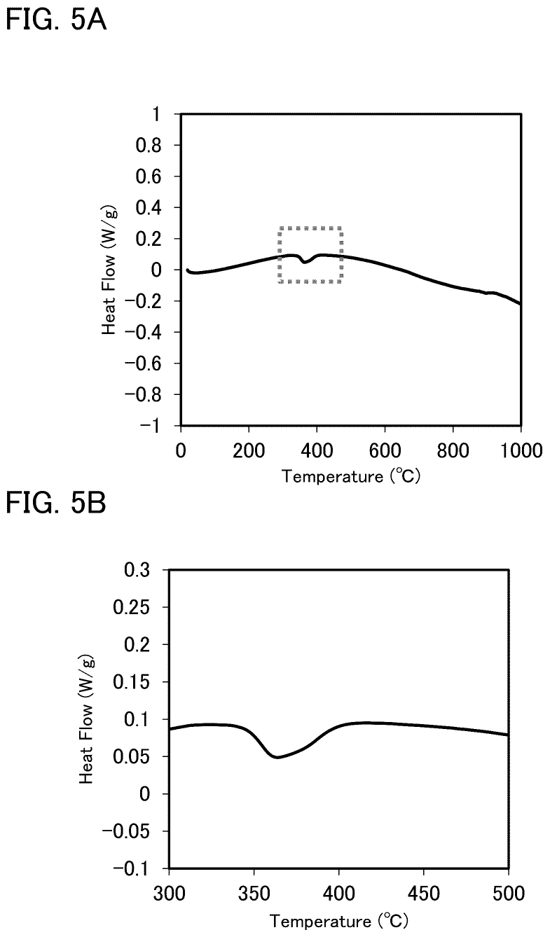

FIG. 5A shows the DSC result of the sample where pristine LCO and Mg(OH)₂ powders were mixed in a molar ratio of 1:0.01. FIG. 5B is an enlarged view of the region enclosed by the dotted rectangle in FIG. 5A. The initial reaction temperature is 345.0° C., while the peak reaction temperature is 363.9° C.

As shown in FIGS. 5A and 5B, in the DSC result of the mixture of pristine LCO and Mg(OH)₂, an endothermic peak was observed at 363.9° C. This temperature was almost the same as the decomposition temperature of only Mg(OH)₂ (357.6° C.) observed in FIG. 3B and no peaks were observed suggesting eutectic points of pristine LCO and Mg(OH)₂.

During the heating process in the fabrication process as shown in FIG. 2, partial melting of the lithium cobalt oxide particle surface portion and the molten fluoride salt occurs, enabling effective diffusion and doping of the added element such as magnesium. As a result, a phase change accompanied by gliding of the CoO₂ slabs is inhibited, allowing the positive electrode active material of one embodiment of the present invention in a highly delithiated state to have a structure different from that of the pristine LCO in a highly delithiated state.

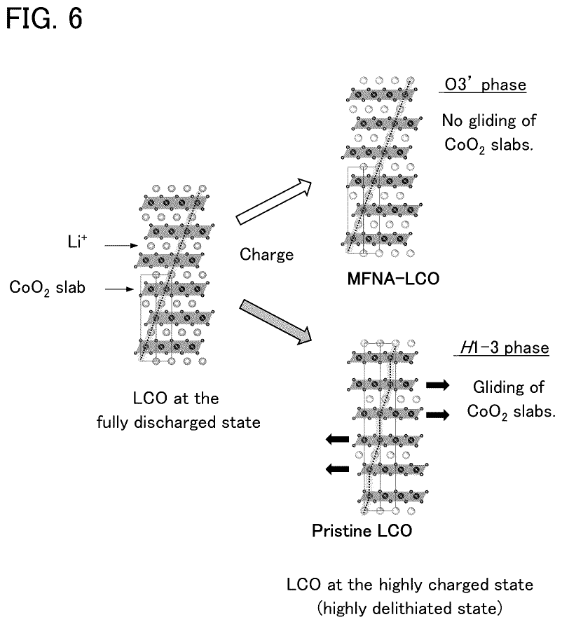

FIG. 6 is a diagram illustrating phase changes in the pristine LCO and the positive electrode active material of one embodiment of the present invention. It is known that LCO undergoes a phase transition from the O3 phase to the H1-3 phase upon charging up to 4.55 V (x<0.3 in LiCoO₂). This phase transition involves a structural change, which is equivalent to gliding of the CoO₂ slabs. A difference in volume between the two crystal structures is also large. When the H1-3 phase in a charged state and lithium cobalt oxide (O3 phase) in a discharged state contain the same number of cobalt atoms, these structures have a difference in volume of greater than 3.5%, typically greater than or equal to 3.9%.

By contrast, in the positive electrode active material of one embodiment of the present invention in a highly delithiated state, the presence of magnesium substituted in the lithium layer provides structural support, preventing the gliding of the CoO₂ slabs and inhibiting the phase transition from the O3 phase to the H1-3 phase. Furthermore, gliding is probably initiated at the surface of LCO and hence could be suppressed by the presence of the magnesium-rich rock salt region in the surface portion of the positive electrode active material of one embodiment of the present invention.

The positive electrode active material of one embodiment of the present invention experiences a phase transition to a phase that is referred to as an O3′ phase in this specification and the like at 4.7 V (versus Li⁺/Li) without undergoing a transformation to the H1-3 phase.

The crystal structure of the O3′ phase belongs to the R-3m space group, and in the unit cell of the crystal structure of the O3′ phase, the coordinates of cobalt and oxygen can be represented by Co (0, 0, 0.5) and O (0, 0, x) within the range of 0.20≤x≤0.22. In the unit cell, the a lattice parameter is preferably 2.798≤a≤2.838 (A), further preferably 2.808≤a≤2.828 (Å), typically a=2.818 (Å). The c lattice parameter is preferably 13.566≤c≤13.766 (Å), further preferably 13.636≤c≤13.696 (Å), typically, c=13.666 (Å).

In the O3′ phase, an ion of cobalt, nickel, magnesium, or the like occupies a site coordinated to six oxygen atoms. Note that a light element such as lithium or magnesium sometimes occupies a site coordinated to four oxygen atoms.

The O3 phase in a discharged state and the O3′ phase that contain the same number of cobalt atoms have a difference in volume of 2.5% or less, specifically 2.2% or less, typically 1.8%.

Since the positive electrode active material of one embodiment of the present invention is fabricated using fluorides as the reaction accelerator, fluorine is preferably detected in surface analysis of the positive electrode active material. For example, fluorine is preferably detected by X-ray photoelectron spectroscopy (XPS). Furthermore, one factor indicating that the fluorides have passed through the stage of molten salts is preferably the binding energy of the positive electrode active material of one embodiment of the present invention different from that of the compound used as a material.

For example, a narrow-scan spectrum of Mg 1s of the positive electrode active material of one embodiment of the present invention obtained by XPS preferably exhibits a maximum value at a binding energy different from the binding energies at which the spectra of magnesium oxide and magnesium fluoride exhibit the maximum values. Specifically, the narrow-scan spectrum of Mg 1s of the positive electrode active material of one embodiment of the present invention preferably exhibits the maximum value at a binding energy between the binding energy at which the spectrum of the magnesium oxide exhibits the maximum value and the binding energy at which the spectrum of the magnesium fluoride exhibits the maximum value.

In the positive electrode active material of one embodiment of the present invention, since harmful phase transition accompanied by gliding of the CoO₂ slabs is inhibited, deterioration of the crystal structure is extremely limited even after a charge/discharge cycling test at a high cut-off voltage of 4.7 V (versus Li⁺/Li).

Specifically, when the charge/discharge cycling test under a 25° C.-environment is conducted on a cell in which the positive electrode active material of one embodiment of the present invention is used for the positive electrode, lithium metal is used for the negative electrode, and a mixture of lithium hexafluorophosphate, ethylene carbonate, and diethyl carbonate with 2 wt % vinylene carbonate is used as the electrolyte solution, and then, the positive electrode in a discharged state is analyzed by powder X-ray diffraction using Cu Kα₁ radiation, a peak with a half width less than or equal to 0.10°, preferably less than or equal to 0.08°, appears within the 20 range of 18.7° to 19.0°, and a peak with a half width less than or equal to 0.12°, preferably less than or equal to 0.09°, appears within the 2θ range of 45.0° to 45.3°. In the charge/discharge cycling test here, a charge/discharge cycle in which constant current charging at a current value of 0.5 C (where 1 C=200 mA/g) is performed up to a voltage of 4.7 V, constant voltage charging is performed until the current value reaches 0.05 C, a rest period of 10 minutes is allowed, constant current discharging at a current value of 0.5 C is performed up to a voltage of 2.5 V, and then, a rest period of 10 minutes is allowed is repeated 100 times.

The positive electrode active material of one embodiment of the present invention stands a charge/discharge cycling test at a high cut-off voltage and thus, using the positive electrode active material enables a positive electrode and a secondary battery having high energy density. For example, the volumetric energy density calculated using the true density of the positive electrode active material can be higher than or equal to 4250 Wh/L, and the gravimetric energy density calculated using the true density of the positive electrode active material can be higher than or equal to 865 Wh/kg.

### <<Calculation>>

First-principles calculation was performed to obtain proof of the mechanism for blocking the change to the H1-3 phase.

Two models in which all lithium atoms in one lithium layer were removed were created: in one model, the oxygen stacking is that of the O3 phase, and in the other model, the oxygen stacking is that of the H1-3 phase. An O3 phase stacking model and an H1-3 phase stacking model in each of which one magnesium atom was added to the layer from which lithium was all removed were also created. For these models, optimization of the structure, including the cell size, was performed and the energies were compared.

The calculation was performed using a density functional theory software package “VASP” with a PAW method. In the calculation, optimization of the structure, including the cell size, was performed. As the exchange-correlation interaction, GGA-PBE was used. The degree of freedom of spin was not taken into consideration. For the correction of the distributed interaction, a DFT-D3 (BJ) method using the Becke-Johnson damping function was employed. A cut-off energy of 1000 eV and a k-point sampling of 3×3×3 were adopted. In electron state calculation, when the energy change falls short of 10⁻⁸ eV, it was considered that convergence occurred. Structural relaxation was stopped when all the force falls short of 0.001 eV/A in the structure optimization.

A model in which the CoO₂ layer in LiCoO₂ has the O3 phase stacking (O3 phase stacking model) and a model in which the CoO₂ layer in LiCoO₂ has the H1-3 phase stacking (H1-3 phase stacking model) were used as basic models. The two basic models each include a stack of a Li layer, a CoO₂ layer, a Li layer, and a CoO₂ layer in the cell used for the calculation. In the cell, the number of Li atoms is 24, the number of Co atoms is 24, and the number of O atoms is 48. These two models in each of which all Li atoms present in one Li layer were eliminated and only four of the 12 Li atoms in the other Li layer were left were created. These two models are models without Mg. The models without Mg in which one Mg atom was added to the layer from which all Li atoms were eliminated are models with Mg. Eventually, the following four models were created: an “O3 phase stacking model without Mg”, an “H1-3 phase stacking model without Mg”, an “O3 phase stacking model with Mg”, and an “H1-3 phase stacking model with Mg”.

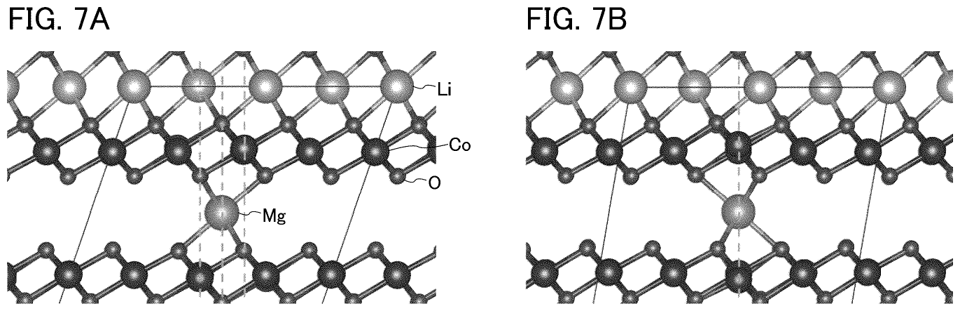

For these four models, optimization of the structure, including the cell size, was performed and the energies were compared. FIGS. 7A and 7B show the “O3 phase stacking model with Mg” and the “H1-3 phase stacking model with Mg” after the optimization of the structure, including the cell size. Table 1 shows the energies of the four models. Here, E(H1-3) and E(O3) represent the energies of the H1-3 phase stacking model and the O3 phase stacking model, respectively.

TABLE 1

| | Without Mg | With Mg |
|---|---|---|
| E (H 1-3) [eV] | −507.77 | −515.43 |
| E (O3) [eV] | −507.49 | −515.50 |
| E (H 1-3) − E (O3) [eV] | −0.28 | 0.07 |

Without magnesium, the H1-3 phase stacking model has lower energy; meanwhile, with magnesium, the O3 phase stacking model has lower energy. These results suggest that the presence of magnesium makes it difficult to form the H1-3 stacking. While there is no cobalt above and below magnesium in the O3 phase stacking model with magnesium, there is cobalt above and below magnesium in the H1-3 phase stacking model. The energy of the H1-3 phase stacking model with magnesium is higher energy presumably because of the electrostatic repulsion between magnesium and the upper and lower cobalt. Moreover, magnesium is considered to increase the energy barrier during gliding of the CoO₂ slabs.

This calculation suggests that transition to the H1-3 phase is prevented by the function of Mg as a pillar.

### <<Li Ordering>>

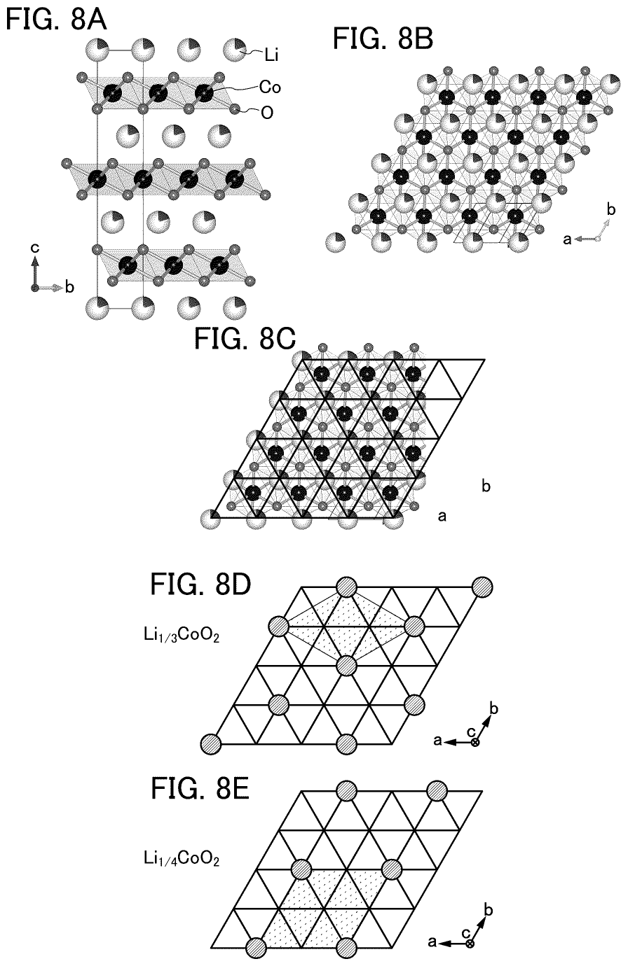

For example, ex situ XRD measurement enables determining the coordinates of cobalt and oxygen in the O3′ phase as described above. By contrast, since lithium has low X-ray scattering power, whether lithium contained in the O3′ phase is ordered or is irregular cannot be analyzed by XRD. For example, FIG. 8A, which is a diagram of the O3′ phase crystal structure model seen from the a-axis direction, and FIG. 8B, which is a diagram of the O3′ phase crystal structure model seen from the c-axis direction, assume that lithium is present with the same probability in all the lithium sites.

However, lithium may be ordered in the O3′ phase actually, and lithium arrangement can be potentially determined by structural analysis combined with another method such as neutron diffraction. Examples of the x value in LiₓCoO₂ and lithium arrangement that are conceivable when lithium contained in the O3′ phase is ordered are described with reference to FIGS. 8D and 8E, FIGS. 9A to 9E, FIG. 10, FIGS. 11A to 11C, and FIG. 12. These are diagrams of the O3′ phase crystal structure model seen from the c-axis direction. For clarity, lithium sites are denoted by vertices of regular triangles and lithium is denoted by hatched circles in FIGS. 8D and 8E, FIGS. 9A to 9E, FIG. 10, and FIG. 12. For reference, FIG. 8C shows the superimposition of the same diagram as FIG. 8B on a diagram with lithium sites denoted by vertices of regular triangles.

FIG. 8D illustrates an example of lithium arrangement in one lithium layer that is conceivable when the O3′ phase is Li_{1/3}CoO₂. In the diagrams referred to below, a hatched parallelogram represents the minimum repeating unit.

FIG. 8E illustrates an example of lithium arrangement in one lithium layer that is conceivable when the O3′ phase is Li_{1/4}CoO₂.

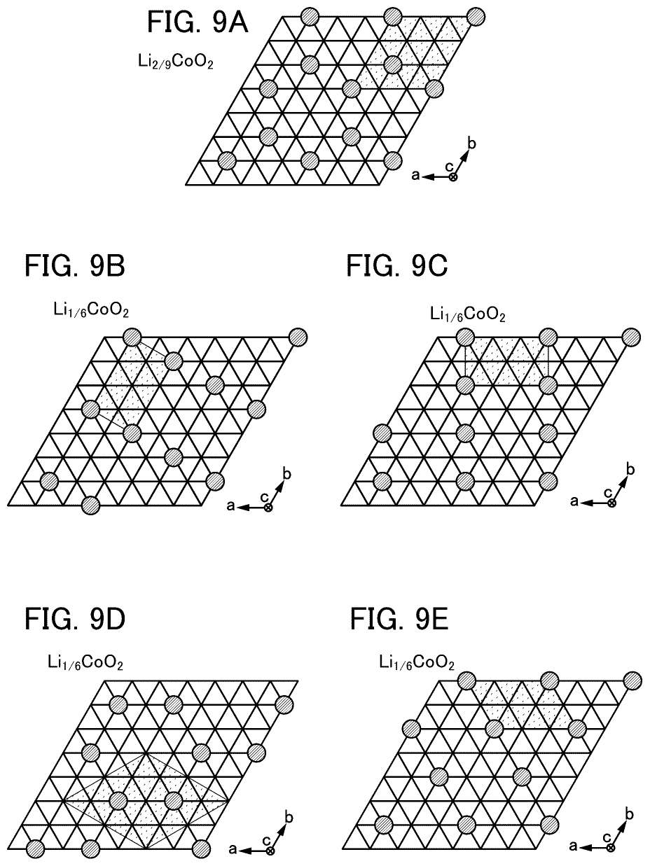

FIG. 9A illustrates an example of lithium arrangement in one lithium layer that is conceivable when the O3′ phase is Li_{2/9}CoO₂.

FIGS. 9B to 9E illustrate examples of lithium arrangement in one lithium layer that is conceivable when the O3′ phase is Li_{1/6}CoO₂.

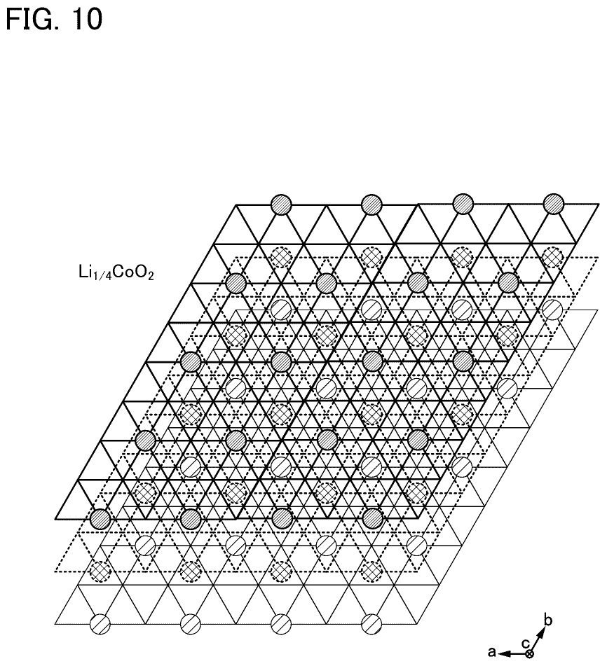

FIG. 10 illustrates an example of lithium arrangement in three successive lithium layers that is conceivable when the O3′ phase is Li_{1/4}CoO₂. For clarity of the drawing, regular triangles whose vertices denote lithium sites are drawn with a solid line in the first layer, a dotted line in the second layer, and a thin solid line in the third layer; lithium atoms present in the same lithium layer are denoted with the same hatching pattern. FIG. 10 can also be regarded as a diagram in which three of the layers shown in FIG. 8E are superimposed and seen from the c-axis direction.

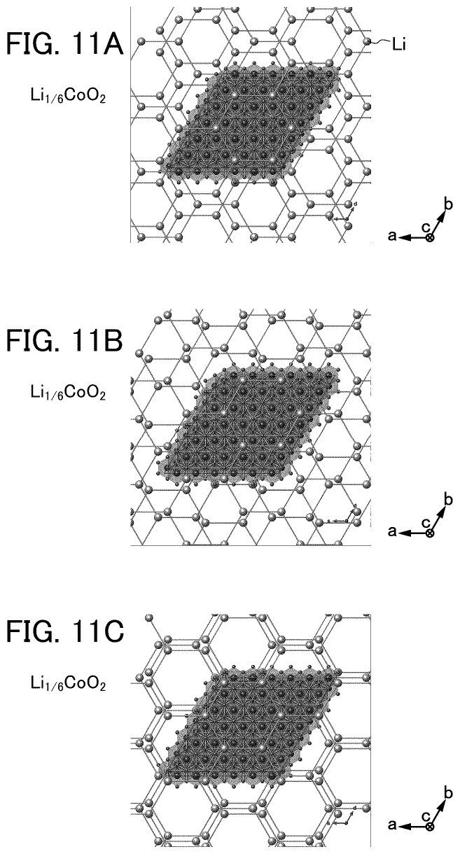

FIGS. 11A to 11C illustrate examples of lithium arrangement in three successive lithium layers that is conceivable then the O3′ phase is Li_{1/6}CoO₂. To distinguish lithium atoms in one layer from those in another layer, lithium atoms present in the same lithium layer are connected to each other by a line. FIGS. 11A to 11C show three examples of the case where three of the layers in FIG. 9D are superimposed.

Although FIG. 10 and FIGS. 11A to 11C illustrate examples where lithium is present in all the lithium layers of the O3′ phase, possible lithium arrangement is not limited thereto. It is also conceivable that a layer with lithium and a layer without lithium alternately appear between the repeated CoO₂ layers.

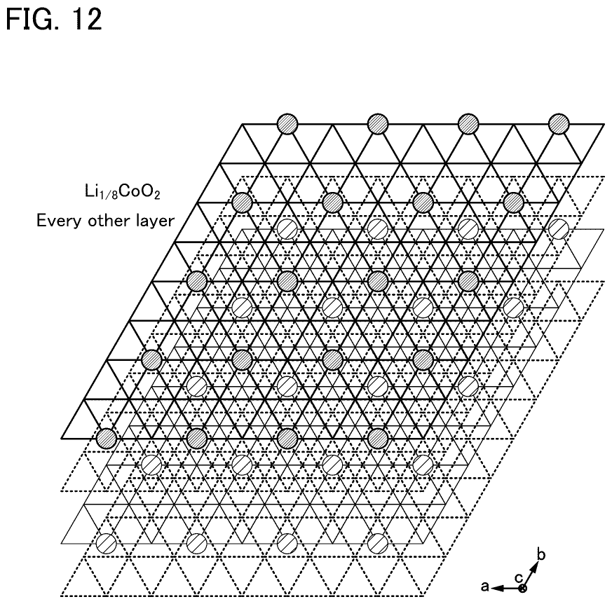

FIG. 12 illustrates an example of lithium arrangement in four successive lithium layers that is conceivable when the O3′ phase is Li_{1/8}CoO₂. The first layer is drawn with a solid line, the second layer is drawn with a dotted line, the third layer is drawn with a thin solid line, and the fourth layer is drawn with a dotted line. FIG. 12 illustrates an example in which the first layer and the third layer each have the same lithium arrangement as that in FIG. 8E and the second layer and the fourth layer include no lithium.

Note that lithium arrangement is not limited to the above either in a lithium layer plane or in the c-axis direction.

In this specification and the like, a surface of a positive electrode active material refers to a surface of lithium cobalt oxide doped with magnesium or the like. Thus, the positive electrode active material of one embodiment of the present invention does not contain a material to which a metal oxide that does not contain a lithium site contributing to charging and discharging, such as aluminum oxide (Al₂O₃), is attached, or a carbonate, a hydroxy group, or the like which is chemically adsorbed after fabrication of the positive electrode active material. The attached metal oxide refers to, for example, a metal oxide having a crystal structure different from that of lithium cobalt oxide.

Furthermore, an electrolyte, an organic solvent, a binder, a conductive material, and a compound originating from any of these that are attached to the positive electrode active material are not contained either.

Since the positive electrode active material of one embodiment of the present invention is a compound containing oxygen and a transition metal into and from which lithium can be inserted and extracted, an interface between a region where oxygen and cobalt that is oxidized or reduced due to insertion and extraction of lithium are present and a region where oxygen and cobalt are absent is considered as the surface of the positive electrode active material. A plane generated by slipping, a closed split, and/or a crack also can be considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

Therefore, the position of the surface of the positive electrode active material in, for example, STEM-EDX line analysis refers to a point where the detection amount of the characteristic X-ray of cobalt is equal to 50% of the sum of the average value Co_{AVE} of the detection amounts of the characteristic X-ray of cobalt in the inner portion and the average value Co_{BG} of the detection amounts of the characteristic X-ray of cobalt of the background or a point where the detection amount of the characteristic X-ray of oxygen is equal to 50% of the sum of the average value O_{AVE} of the detection amounts of the characteristic X-ray of oxygen in the inner portion and the average value O_{BG} of the detection amounts of the characteristic X-ray of oxygen of the background. Note that when the position of the point where the detection amount of the characteristic X-ray of cobalt is equal to 50% of the sum of the average value of the detection amounts of the characteristic X-ray of cobalt in the inner portion and the average value of the detection amounts of the characteristic X-ray of cobalt of the background is different from the position of the point where the detection amount of the characteristic X-ray of oxygen is equal to 50% of the sum of the average value of the detection amounts of the characteristic X-ray of oxygen in the inner portion and the average value of the detection amounts of the characteristic X-ray of oxygen of the background, the difference is probably due to the influence of a carbonate, a metal oxide containing oxygen, or the like, which is attached to the surface. Thus, in such a case, the point where the detection amount of the characteristic X-ray of cobalt is equal to 50% of the sum of the average value Co_{AVE} of the detection amounts of the characteristic X-ray of cobalt in the inner portion and the average value Co_{BG} of the detection amounts of the characteristic X-ray of cobalt of the background can be employed as the position of the surface of the positive electrode active material.

The average value Co_{BG} of the detection amounts of the characteristic X-ray of cobalt of the background can be calculated by averaging the detection amounts in the range from 2 nm, preferably from 3 nm, which is outside a portion in the vicinity of the portion at which the detection amount of the characteristic X-ray of cobalt begins to increase, for example. The average value Co_{AVE} of the detection amounts of the characteristic X-ray of cobalt in the inner portion can be calculated by averaging the detection amounts in the range from 2 nm, preferably from 3 nm at the depth at which the detection amounts of the characteristic X-ray of cobalt and oxygen are saturated and stabilized, e.g., at a depth larger than, by greater than or equal to 30 nm, preferably greater than 50 nm, the depth at which the detection amount of the characteristic X-ray of cobalt begins to increase. The average value O_{BG} of the detection amounts of the characteristic X-ray of oxygen of the background and the average value O_{AVE} of the detection amounts of the characteristic X-ray of oxygen in the inner portion can be calculated in a similar manner.

To increase the spatial resolution in STEM-EDX line analysis, the beam diameter of an electron beam (also referred to as a beam diameter or a probe diameter) is preferably small. The beam diameter in STEM-EDX line analysis is preferably less than or equal to 0.3 nm, further preferably less than or equal to 0.2 nm, still further preferably less than or equal to 0.1 nm.

The surface of the positive electrode active material in, for example, a cross-sectional scanning transmission electron microscope (STEM) image is a boundary between a region where an image derived from the crystal structure of the positive electrode active material is observed and a region where the image is not observed. The surface of the positive electrode active material is also determined as the outermost surface of a region where an atomic column derived from an atomic nucleus of, among metal elements which constitute the positive electrode active material, a metal element that has a larger atomic number than lithium is observed in the cross-sectional STEM image. Alternatively, the surface refers to an intersection of a tangent drawn at a luminance profile from the surface toward the bulk and an axis in the depth direction in a STEM image. The surface in a STEM image or the like may be determined by using additionally an analysis with higher spatial resolution.

The spatial resolution of STEM-EDX is approximately 1 nm. Thus, the maximum value of an added element profile may be shifted by approximately 1 nm. For example, even when the maximum value of the profile of an added element such as magnesium is outside the surface determined in the above-described manner, it can be said that a difference between the maximum value and the surface is within the margin of error as long as the difference is less than 1 nm.

A peak in STEM-EDX line analysis refers to the maximum value of the detection intensity in each element profile or the maximum value of the characteristic X-ray of each element. As a noise in STEM-EDX line analysis, a measured value having a half width smaller than or equal to spatial resolution (R), for example, smaller than or equal to R/2 can be given.

The adverse effect of a noise can be reduced by scanning the same portion a plurality of times under the same conditions. For example, an integrated value obtained by performing scanning six times can be used as the profile of each element. The number of scanning is not limited to six and an average of measured values obtained by performing scanning seven or more times can be used as the profile of each element.

STEM-EDX line analysis can be performed as follows, for example. First, a protective film is deposited by evaporation over the surface of a positive electrode active material. For example, carbon can be deposited by evaporation with an ion sputtering apparatus (MC1000, produced by Hitachi High-Tech Corporation).

Next, the positive electrode active material is thinned to fabricate a cross-section sample to be subjected to STEM analysis. For example, the positive electrode active material can be thinned with an FIB-SEM apparatus (XVision 200TBS, produced by Hitachi High-Tech Corporation). Here, picking up can be performed by a micro probing system (MPS), and the acceleration voltage at final processing can be, for example, 10 kV.

The STEM-EDX line analysis can be performed using, for example, HD-2700 produced by Hitachi High-Tech Corporation as a STEM apparatus and Octane T Ultra W (with two detectors) produced by EDAX Inc as an EDX detector. In the EDX line analysis, the emission current of the STEM apparatus is set to be within the range of 6 μA to 10 μA, and a portion of the thinned sample, which is not positioned at a deep level and has little unevenness, is measured. The magnification is approximately 150,000 times, for example. The EDX line analysis can be performed under conditions where drift correction is performed, the line width is 42 nm, the pitch is 0.2 nm, and the number of frames is 6 or more.

When the surface portion contains both magnesium and nickel, divalent nickel might be able to exist more stably in the vicinity of divalent magnesium. Thus, even in a highly delithiated state, dissolution of magnesium might be inhibited, which might contribute to stabilization of the surface portion.

For a similar reason, when the added element is added to lithium cobalt oxide in the fabrication process, magnesium is preferably added in a step before a step where nickel is added. Alternatively, magnesium and nickel are preferably added in the same step. The reason is as follows: magnesium has a large ion radius and thus is likely to remain in the surface portion of lithium cobalt oxide regardless of in which step magnesium is added, but nickel may be widely diffused to the inner portion of lithium cobalt oxide when magnesium does not exist. Thus, when nickel is added before magnesium is added, nickel might be diffused to the inner portion of lithium cobalt oxide and a preferable amount of nickel might not remain in the surface portion.

Added elements that are differently distributed in the depth direction are preferably contained at a time, in which case the crystal structure of a wider region can be stabilized. For example, in the surface portion of the positive electrode active material of one embodiment of the present invention, the maximum values of the detection amounts of magnesium and nickel are preferably different from the maximum value of the detection amount of aluminum in the depth direction. The maximum value of the detection amount of aluminum is preferably observed in a region of a particle that is located inward from a region of the particle in which the maximum values of the detection amounts of magnesium and nickel are observed.

With such distributions of the added elements, the crystal structure of a wider region can be stabilized. In the case where magnesium, nickel, and aluminum are contained as described above, the surface portion can be sufficiently stabilized by magnesium and nickel; thus, aluminum is not essential on the surface. It is preferable that aluminum be widely distributed in a deeper region. For example, it is preferable that aluminum be continuously detected in a region extending from a depth from the surface of 1 nm to a depth from the surface of 25 nm. Aluminum is preferably widely distributed in a region extending from a depth from the surface of 0 nm to a depth from the surface of 100 nm, further preferably a region extending from a depth from the surface of 0.5 nm to a depth from the surface of 50 nm, in which case the crystal structure of a wider region can be stabilized.

When a plurality of the added elements are contained as described above, the effects of the added elements contribute synergistically to further stabilization of the surface portion.

It is preferable that the added elements, i.e., magnesium, fluorine, nickel, and aluminum, form solid solutions with the positive electrode active material. Thus, in STEM-EDX line analysis, for example, a position where the detection amount of the added element increases is preferably at a deeper level than a position where the detection amount of cobalt increases, i.e., on the inner portion side of the positive electrode active material.

In this specification and the like, the depth at which the detection amount of an element increases in STEM-EDX line analysis refers to the depth at which a measured value, which can be determined not to be a noise in terms of intensity, spatial resolution, and the like, is successively obtained.

This embodiment can be combined with the contents in any of the other embodiments as appropriate.

### Embodiment 2

In this embodiment, structures of lithium-ion batteries are described.

### [Positive Electrode]

A positive electrode includes a positive electrode active material layer and a positive electrode current collector. The positive electrode active material layer includes a positive electrode active material and may further include at least one of a conductive additive and a binder. As the positive electrode active material, the positive electrode active material described in the above embodiment can be used.

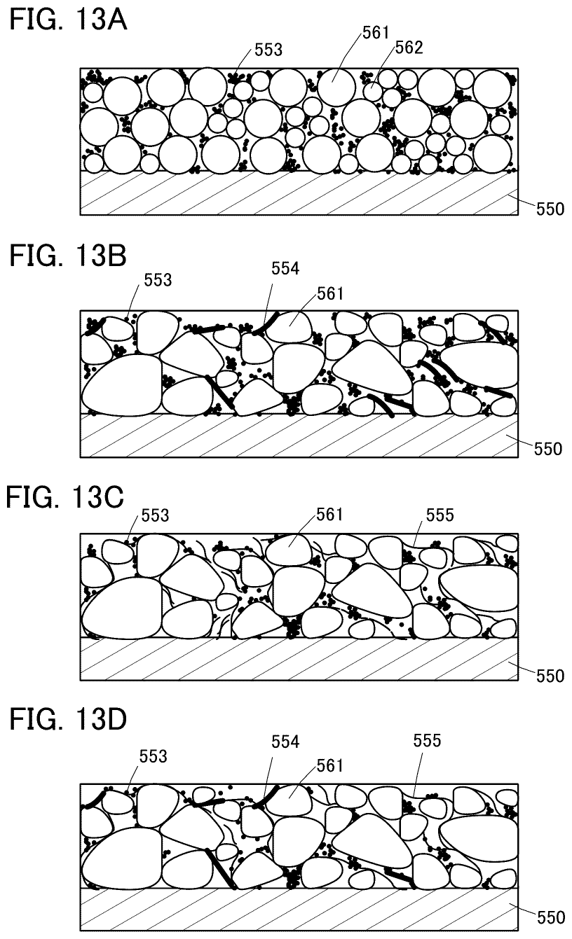

FIG. 13A illustrates an example of a schematic cross-sectional view of the positive electrode.

Metal foil can be used as a current collector 550, for example. The positive electrode can be formed by applying slurry onto the metal foil and drying the slurry. Note that pressing may be performed after drying. The positive electrode is obtained by forming an active material layer over the current collector 550.

Slurry refers to a material solution that is used to form an active material layer over the current collector 550 and includes an active material, a binder, and a solvent, preferably also a conductive additive mixed therewith. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

A positive electrode active material 561 has functions of taking in and/or releasing lithium ions in accordance with charging and discharging. For the positive electrode active material 561 used as one embodiment of the present invention, a material with little deterioration due to discharging and charging even at a high charge voltage can be used. In this specification and the like, unless otherwise specified, a charge voltage is shown with reference to the potential of lithium metal. In this specification and the like, high charge voltage is a charge voltage, for example, higher than or equal to 4.6 V, preferably higher than or equal to 4.65 V, further preferably higher than or equal to 4.7 V, still further preferably higher than or equal to 4.75 V, most preferably higher than or equal to 4.8 V.

For the positive electrode active material 561 used as one embodiment of the present invention, any material can be used as long as it shows little deterioration due to discharging and charging even at a high charge voltage, and the material described in Embodiment 1 can be used. Note that for the positive electrode active material 561, two or more kinds of materials having different particle diameters can be used as long as the materials show little deterioration due to discharging and charging even at a high charge voltage.

A conductive additive is also referred to as a conductivity-imparting agent or a conductive material, and a carbon material can be used as the conductive additive. A conductive additive is attached between a plurality of active materials, whereby the plurality of active materials are electrically connected to each other, and the conductivity increases. Note that in this specification and the like, the term “attach” refers not only to a state where an active material and a conductive additive are physically in close contact with each other, and includes, for example, the following concepts: the case where covalent bonding occurs, the case where bonding with the Van der Waals force occurs, the case where a conductive additive covers part of the surface of an active material, the case where a conductive additive is embedded in surface roughness of an active material, and the case where an active material and a conductive additive are electrically connected to each other without being in contact with each other.

Specific examples of carbon materials that can be used as the conductive additive include carbon black (e.g., furnace black, acetylene black, or graphite).

In FIG. 13A, carbon black 553 is illustrated as the conductive additive.

In the positive electrode of the lithium-ion battery, a binder (a resin) may be mixed in order to adhere the current collector 550 such as metal foil and the active material to each other. The binder is also referred to as a binding agent. Since the binder is a high molecular material, a large amount of the binder lowers the proportion of the active material in the positive electrode, thereby reducing the discharge capacity of the lithium-ion battery. Therefore, the amount of the binder mixed is preferably reduced to a minimum. In FIG. 13A, a region not filled with the positive electrode active material 561, a second active material 562, or the carbon black 553 indicates a space or the binder.

Although FIG. 13A illustrates an example in which the positive electrode active material 561 has a spherical shape, there is no particular limitation. The cross-sectional shape of the positive electrode active material 561 may be an ellipse, a rectangle, a trapezoid, a pyramid, a polygon with rounded corners, or an asymmetrical shape, for example. For example, FIG. 13B illustrates an example in which the positive electrode active material 561 has a polygon shape with rounded corners.

In the positive electrode in FIG. 13B, graphene 554 is used as a carbon material used as the conductive additive. In FIG. 13B, a positive electrode active material layer including the positive electrode active material 561, the graphene 554, and the carbon black 553 is formed over the current collector 550.

In the step of mixing the graphene 554 and the carbon black 553 to obtain an electrode slurry, the weight of mixed carbon black is preferably 1.5 times to 20 times, further preferably 2 times to 9.5 times the weight of graphene.

When the graphene 554 and the carbon black 553 are mixed in the above range, the carbon black 553 is excellent in dispersion stability and an aggregated portion is unlikely to be generated at the time of preparing a slurry. Furthermore, when the graphene 554 and the carbon black 553 are mixed in the above range, the electrode density can be higher than that of a positive electrode using only the carbon black 553 as a conductive additive. As the electrode density becomes higher, the capacity per unit weight can become higher. Specifically, the density of the positive electrode active material layer measured by gravimetry can be higher than or equal to 3.5 g/cc.

The electrode density is lower than that of a positive electrode containing only graphene as a conductive additive, but when a first carbon material (graphene) and a second carbon material (acetylene black) are mixed in the above range, fast charging can be achieved. Thus, use of such a mixed conductive additive for lithium-ion batteries for vehicles is particularly effective.

FIG. 13C illustrates an example of a positive electrode in which carbon fiber 555 is used instead of graphene. The example illustrated in FIG. 13C is different from that in FIG. 13B. With use of the carbon fiber 555, aggregation of the carbon black 553 can be prevented and the dispersibility can be increased.

In FIG. 13C, the region not filled with the positive electrode active material 561, the carbon fiber 555, or the carbon black 553 indicates a space or the binder.

FIG. 13D illustrates another example of a positive electrode. FIG. 13C illustrates an example in which the carbon fiber 555 is used in addition to the graphene 554. With use of both the graphene 554 and the carbon fiber 555, aggregation of carbon black such as the carbon black 553 can be prevented and the dispersibility can be further increased.

In FIG. 13D, the region not filled with the positive electrode active material 561, the carbon fiber 555, the graphene 554, or the carbon black 553 indicates a space or the binder.

A lithium-ion battery can be fabricated by using any one of the positive electrodes in FIGS. 13A to 13D; setting, in a container (e.g., an exterior body or a metal can) or the like, a stack in which a separator is provided over the positive electrode and a negative electrode is provided over the separator; and filling the container with a liquid electrolyte (also referred to as electrolyte solution).

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

### <Positive Electrode Current Collector>

For the current collector, a material that has high conductivity, such as a metal like stainless steel, gold, platinum, aluminum, or titanium, or an alloy thereof, can be used. It is preferable that a material used for the positive electrode current collector not be dissolved at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer includes a negative electrode active material and may further include a conductive additive and a binder.

### <Negative Electrode Active Material>

As the negative electrode active material, for example, an alloy-based material and/or a carbon material can be used.

As the carbon material used as the negative electrode active material, one or more selected from graphite, graphitizing carbon (soft carbon), non-graphitizing carbon (hard carbon), carbon fiber (carbon nanotube), graphene, carbon black, and the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of lithium metal (higher than or equal to 0.05 V and lower than or equal to 0.3 V versus Li+/Li) when lithium ions are inserted into graphite (while a lithium-graphite intercalation compound is formed). For this reason, a lithium-ion battery using graphite can have a high operating voltage. In addition, graphite is preferred because of its advantages such as a relatively high capacity per unit volume, relatively small volume expansion, low cost, and a higher level of safety than that of lithium metal.

As the negative electrode active material, an element that enables charge and discharge reactions by alloying and dealloying reactions with lithium can be used. For example, one or more materials selected from silicon, tin, gallium, aluminum, germanium, lead, antimony, bismuth, silver, zinc, cadmium, indium, and the like can be used. Such elements have higher capacity than carbon, and especially, silicon has a high theoretical capacity of 4200 mAh/g. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sns, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound containing the element, for example, are referred to as alloy-based materials in some cases.

In this specification and the like, “SiO” refers, for example, to silicon monoxide. SiO can alternatively be expressed as SiOₓ. Here, it is preferable that x be 1 or have an approximate value of 1. For example, x is preferably greater than or equal to 0.2 and less than or equal to 1.5, further preferably greater than or equal to 0.3 and less than or equal to 1.2.

As the negative electrode active material, one or more oxides selected from titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), and molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of its high discharge capacity (900 mAh/g and 1890 mAh/cm³).

A composite nitride of lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the composite nitride of lithium and a transition metal can be used as the negative electrode active material by extracting the lithium ions contained in the positive electrode active material in advance.

A material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

A combination of two or more of the above negative electrode active materials may be used; for example, a negative electrode active material in which graphite and silicon particles are mixed may be used. The silicon particles refer to silicon powders that are the negative electrode active material of the lithium-ion secondary battery, and the average diameter of the particle size distribution, i.e., the average particle diameter is around 100 nm; the silicon particles are referred to as nanosilicon particles in some cases. In order to obtain silicon particles to be used, it is preferable that a silicon source be ground and particle diameters be adjusted to be uniform. The silicon particles may contain at least one of silicon, silicon oxide, and silicon alloy. Although laser diffraction particle size distribution measurement can be typically used for measurement of a particle size, the measurement is not limited thereto. A major diameter of a particle cross section may be measured by analysis using a scanning electron microscope (SEM), a transmission electron microscope (TEM), or the like.

For the conductive additive and the binder that can be included in the negative electrode active material layer, materials similar to those for the conductive additive and the binder that can be included in the positive electrode active material layer can be used.

### <Negative Electrode Current Collector>

For the negative electrode current collector, copper or the like can be used in addition to a material similar to that of the positive electrode current collector. Note that a material that does not alloy with carrier ions of lithium or the like is preferably used for the negative electrode current collector.

### [Electrolyte Solution]

The electrolyte solution contains an organic solvent; the organic solvent is not necessarily a liquid at 25° C. but may be a solid at 25° C. or a semi-solid at normal temperature. Note that the organic solvent is preferably a liquid within a wide temperature range of sub-zero temperatures to high temperatures, although one embodiment of the present invention is not limited thereto. The organic solvent may be a liquid, a solid, or a semi-solid within a wide temperature range of sub-zero temperatures to high temperatures.

As the organic solvent, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), 1,3-propane sultone (PS), fluoroethylene carbonate (FEC), methyl 3,3,3-trifluoropropionate (MTFP), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

PS has a highest occupied molecular orbital (HOMO) level and a lowest unoccupied molecular orbital (LUMO) level equivalent to those of EC and DEC; thus, PS is less likely to be oxidized and reduced even at a high cut-off voltage, and is likely to be a high molecular compound when decomposed on the surface of the positive electrode active material. Accordingly, PS is advantageous in that it is unlikely to be gasified by becoming a decomposition product with a small molecular weight. Thus, the electrolyte solution preferably contains PS at higher than or equal to 0.1 wt % and lower than or equal to 10 wt %, further preferably higher than or equal to 0.25 wt % and lower than or equal to 7.5 wt %.

FEC, which is a cyclic carbonate, has a high dielectric constant and thus has an effect of promoting dissociation of a lithium salt when used in an organic solvent. Meanwhile, because FEC includes a substituent with an electron-withdrawing property, a lithium ion is desolvated with FEC more easily than with EC. Specifically, the solvation energy of a lithium ion is lower in FEC than in EC, which does not include a substituent with an electron-withdrawing property. Thus, lithium ions are likely to be extracted from surfaces of a positive electrode active material and a negative electrode active material, which can reduce an internal resistance of a secondary battery. In addition, FEC has a deep HOMO level and is thus not easily oxidized, meaning high oxidation resistance. On the other hand, FEC disadvantageously has high viscosity. In view of this, a mixed organic solvent containing not only FEC but also MTFP is preferably used for the electrolyte solution. MTFP, which is a linear carbonate, can have an effect of reducing the viscosity of an electrolyte solution or maintaining the viscosity at room temperature (typically, 25° C.) even at low temperatures (typically, 0° C.). Furthermore, while the solvation energy is lower in MTFP than in methyl propionate (abbreviation: MP), which does not include a substituent with an electron-withdrawing property, MTFP may solvate a lithium ion when used for the electrolyte solution. In the case of using a mixed organic solvent containing both FEC and MTFP, y in the volume ratio FEC:MTFP=1:y preferably satisfies 2≤y≤20, further preferably 4≤y≤9.

It is preferable that the above-described organic solvent be highly purified and contain a small amount of dust particles or molecules other than constituent molecules of the organic solvent (hereinafter also simply referred to as impurities and include oxygen (O₂), water (H₂O), and moisture). It is preferable that the organic solvent pass through appropriate purification and generation of a reaction by-product in synthesis be inhibited. Specifically, the impurity concentration in the electrolyte is less than or equal to 100 ppm, preferably less than or equal to 50 ppm, further preferably less than 10 ppm. The concentration of moisture among the impurities can be detected by Karl Fischer titration.

Furthermore, it is preferable that peaks attributed to impurities in the above organic solvent be hardly observed by NMR measurement or the like. The expression “hardly observed” includes the case where the ratio of the integral area of the peak attributed to impurities to the integral area of the peak attributed to the main component (such a ratio is simply referred to as an integral ratio) is less than or equal to 0.005, preferably less than or equal to 0.002. An apparatus used for the NMR measurement is not particularly limited, and for example, “AVANCE III 400” produced by Bruker AXS can be used. Among the five peaks of acetonitrile derived from acetonitrile-d3 used in a solvent in the 1H-NMR measurement, the center peak can be 1.94 ppm.

For example, in the case of MTFP, it is known that when 1H-NMR is measured using an acetonitrile-d3 solvent, four peaks appear within the 8 range of 3.29 ppm to 3.43 ppm. However, in the case where another peak appears in the vicinity of the above range, for example, another peak appears within the 8 range of 3.24 ppm to 3.29 ppm, the peak is probably derived from impurities. Accordingly, when the ratio of the peak area (an integral ratio) within the range of 3.24 ppm to 3.29 ppm to the peak area within the range of 3.29 ppm to 3.43 ppm is less than or equal to 0.005, preferably less than or equal to 0.002, peaks attributed to impurities are hardly observed.

Alternatively, the use of one or more kinds of ionic liquids (room temperature molten salts) that are unlikely to burn and volatize as the solvent of the electrolyte solution can prevent a power storage device from exploding and catching fire even when the power storage device internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), LiN(C₂FsSO₂)₂, and lithium bis(oxalate)borate (LiB(C₂O₄)₂, LiBOB) can be used, or two or more of these lithium salts can be used in an appropriate combination in an appropriate ratio.

The electrolyte solution used for the power storage device is preferably a highly-purified electrolyte solution with only a small amount of dust particles and elements other than the constituent elements of the electrolyte solution (hereinafter also simply referred to as impurities). Specifically, the weight ratio of impurities to the electrolyte solution is preferably less than or equal to 1%, further preferably less than or equal to 0.1%, still further preferably less than or equal to 0.01%.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. For example, a polymer having a polyalkylene oxide structure, such as polyethylene oxide (PEO), PVDF, polyacrylonitrile, or a copolymer containing any of them can be used. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, or a solid electrolyte including a polymer material such as a polyethylene oxide (PEO)-based polymer material may alternatively be used. When the solid electrolyte is used, a separator or a spacer is not necessary. Furthermore, the battery can be entirely solidified; therefore, there is no risk of liquid leakage and thus the safety of the battery is dramatically improved.

### [Separator]

When the electrolyte includes a liquid electrolyte, a separator is placed between the positive electrode and the negative electrode. As the separator, for example, a fiber containing cellulose such as paper; nonwoven fabric; a glass fiber; ceramics; a synthetic fiber using nylon (polyamide), vinylon (polyvinyl alcohol-based fiber), polypropylene (referred to as PP), polyimide (referred to as PI), polyester, acrylic, polyolefin, or polyurethane; or the like can be used. The separator can have a porosity in thickness higher than or equal to 35% and lower than or equal to 90%, preferably higher than or equal to 60% and lower than or equal to 85%. A separator using polypropylene can have a porosity higher than or equal to 35% and lower than or equal to 45%. A separator using polyimide can have a porosity higher than or equal to 75% and lower than or equal to 85%. The thickness of the separator is preferably greater than or equal to 10 μm and less than or equal to 80 μm, further preferably greater than or equal to 20 μm and less than or equal to 60 μm. The separator using polyimide is preferable because it can have a high porosity and can have a large thickness (typically, a thickness greater than or equal to 50 μm and less than or equal to 60 μm).

The separator is preferably processed into a bag-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

The use of a separator having a multilayer structure makes it possible to maintain the safety of the lithium-ion battery even when the total thickness of the separator is small, so that the discharge capacity per volume of the lithium-ion battery can be increased.

### [Exterior Body]

For an exterior body included in the lithium-ion battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

This embodiment can be implemented in combination with any of the other embodiments.

### Embodiment 3

In this embodiment, embodiment examples of lithium-ion batteries are described.

### [Laminated Lithium-Ion Battery]

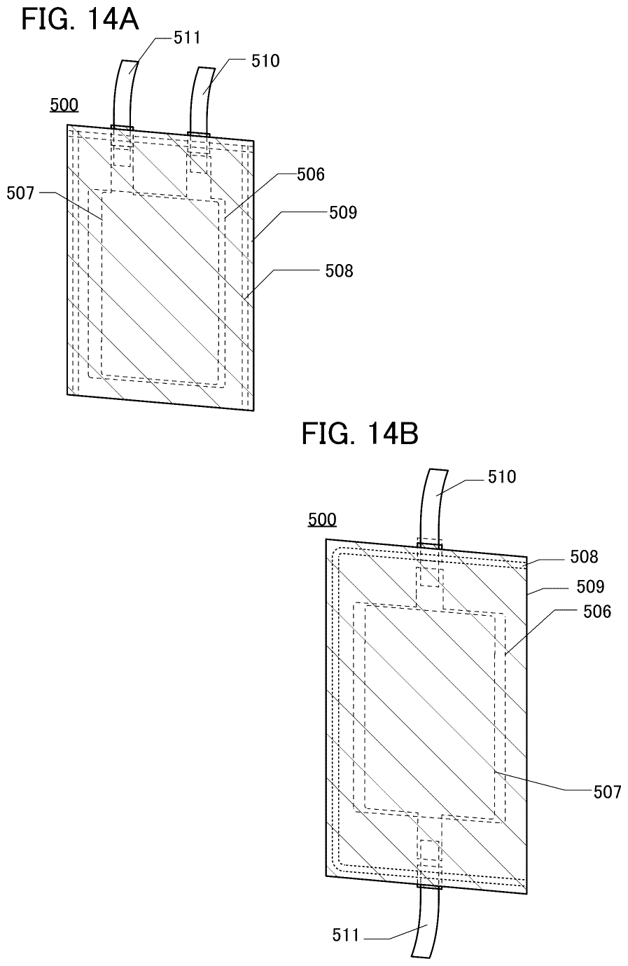

FIGS. 14A and 14B illustrate embodiment examples of a laminated lithium-ion battery 500. FIGS. 14A and 14B are external views, and the lithium-ion battery 500 includes the electrolyte and the separator described in the above embodiments (which are not illustrated in FIG. 14A or 14B), a negative electrode 506, and a positive electrode 507. In the lithium-ion battery 500, the negative electrode 506 preferably has a larger area than the positive electrode 507. Furthermore, the lithium-ion battery 500 includes a negative electrode lead electrode 510 electrically connected to the negative electrode 506 and a positive electrode lead electrode 511 electrically connected to the positive electrode 507. The electrolyte, the negative electrode 506, and the positive electrode 507 are held in an exterior body 509, and part of the negative electrode lead electrode 510 and part of the positive electrode lead electrode 511 protrude from the exterior body 509. A bonding region 508 is provided in part of the outer periphery of the exterior body 509. FIG. 14A illustrates an embodiment example in which the negative electrode lead electrode 510 and the positive electrode lead electrode 511 protrude from the same side of the exterior body 509, and the bonding region 508 is positioned at least on the side where the lead electrodes protrude and two sides adjacent to that side. FIG. 14B illustrates an embodiment example in which a side where the negative electrode lead electrode 510 protrudes from the exterior body 509 and a side where the positive electrode lead electrode 511 protrudes from the exterior body 509 face each other, and the bonding region 508 is positioned at least on the two sides where the lead electrodes protrude and a side sandwiched between the two sides. In FIGS. 14A and 14B, a side where the bonding region 508 is not positioned preferably corresponds to a side where the exterior body 509 is folded.

By including the positive electrode active material of one embodiment of the present invention, the laminated lithium-ion battery 500 can be a secondary battery with high capacity, high discharge capacity, and excellent cycling performance.

### [Coin-Type Lithium-Ion Battery]

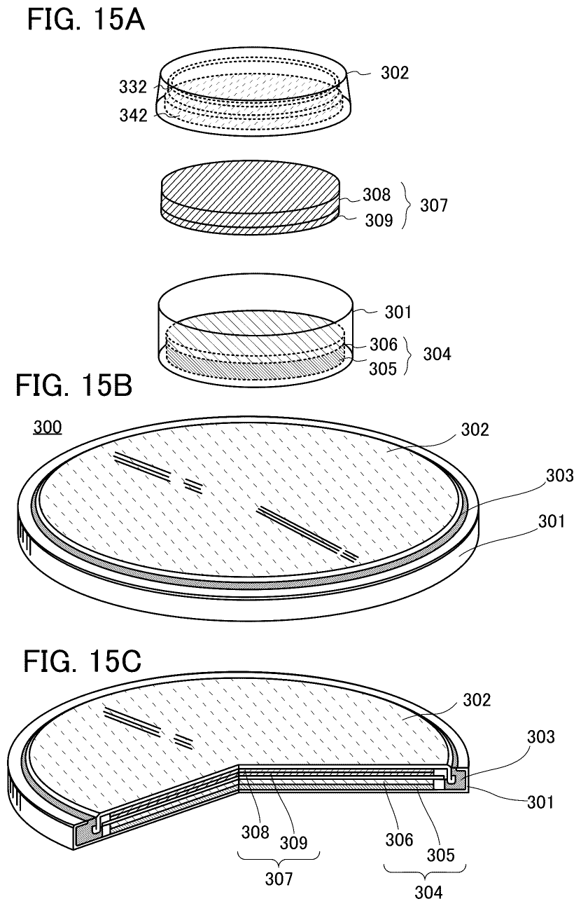

An example of a coin-type lithium-ion battery is described. FIG. 15A is an exploded perspective view of a coin-type (single-layer flat type) lithium-ion battery, FIG. 15B is an external view thereof, and FIG. 15C is a cross-sectional view thereof. Coin-type lithium-ion batteries are mainly used in small electronic devices. In this specification and the like, coin-type lithium-ion batteries include button-type lithium-ion batteries.

For easy understanding, FIG. 15A is a schematic view illustrating overlap (a vertical relation and a positional relation) between components. Thus, FIGS. 15A and 15B do not completely correspond with each other.

FIG. 15A illustrates a state where a positive electrode 304, a negative electrode 307, a spacer 342, and a washer 332 overlap with each other and are sealed with a negative electrode can 302 and a positive electrode can 301. Note that FIG. 15A does not illustrate the electrolyte or the separator described in the above embodiments. The spacer 342 and the washer 332 are used to protect the inside or fix the position inside the cans at the time when the positive electrode can 301 and the negative electrode can 302 are bonded with pressure. For the spacer 342 or the washer 332, stainless steel or an insulating material is used.

The positive electrode 304 has a stacked-layer structure in which a positive electrode active material layer 306 is formed over a positive electrode current collector 305.

FIG. 15B is a perspective view of a completed coin-type lithium-ion battery 300.

In the coin-type lithium-ion battery 300, the positive electrode can 301 doubling as a positive electrode terminal and the negative electrode can 302 doubling as a negative electrode terminal may be insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The positive electrode can 301 and the negative electrode can 302 are electrically connected to the positive electrode 304 and the negative electrode 307, respectively.

Note that only one surface of each of the positive electrode 304 and the negative electrode 307 used for the coin-type lithium-ion battery 300 is provided with an active material layer.

As illustrated in FIG. 15C, the positive electrode 304, the negative electrode 307, and the negative electrode can 302 are stacked in this order with the positive electrode can 301 positioned at the bottom, and then the positive electrode can 301 and the negative electrode can 302 are subjected to pressure bonding with the gasket 303 therebetween; as a result, the coin-type lithium-ion battery 300 is manufactured.

By including the positive electrode active material of one embodiment of the present invention, the coin-type lithium-ion battery 300 can be a secondary battery with high capacity, high discharge capacity, and excellent cycling performance.

### [Cylindrical Lithium-Ion Battery]

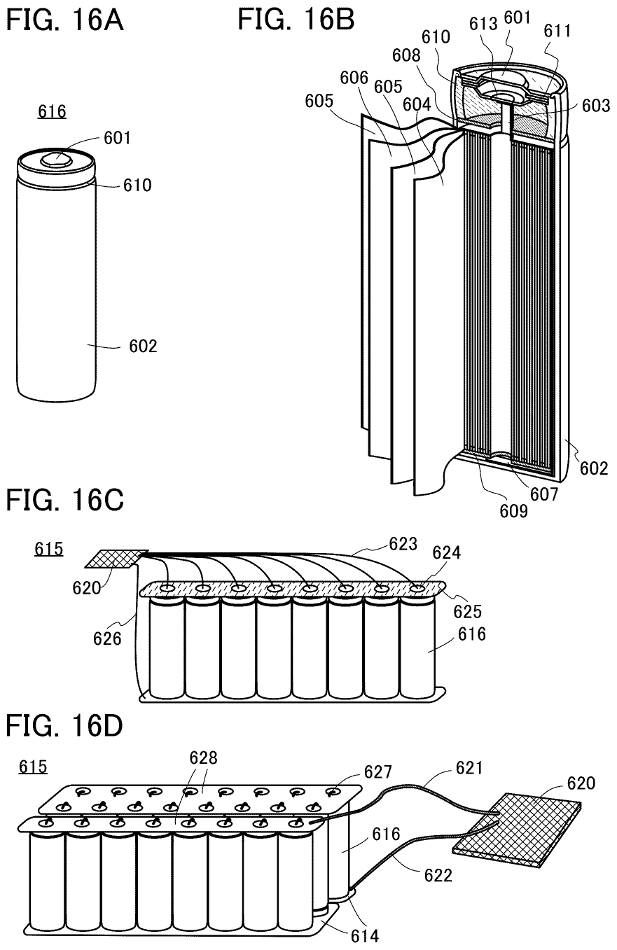

An example of a cylindrical lithium-ion battery is described with reference to FIG. 16A. As illustrated in FIG. 16A, a cylindrical lithium-ion battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 16B schematically illustrates a cross section of a cylindrical lithium-ion battery. The cylindrical lithium-ion battery illustrated in FIG. 16B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with an electrolyte layer 605 located therebetween is provided. Although not illustrated, the battery element is wound around a central axis. One end of the battery can 602 is closed and the other end thereof is opened. Inside the battery can 602, the battery element in which the positive electrode, the negative electrode, and the separator are wound is provided between a pair of insulating plates 608 and 609 that face each other. The inside of the battery can 602 provided with the battery element is filled with an electrolyte solution (not illustrated).

Since a positive electrode and a negative electrode that are used for a cylindrical storage battery are wound, active materials are preferably formed on both surfaces of a current collector. Note that although FIGS. 16A to 16D each illustrate the lithium-ion battery 616 in which the height of the cylinder is larger than the diameter of the cylinder, one embodiment of the present invention is not limited thereto. In a lithium-ion battery, the diameter of the cylinder may be larger than the height of the cylinder. Such a structure can reduce the size of a lithium-ion battery, for example.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a positive temperature coefficient (PTC) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. A barium titanate (BaTiO₃)-based ceramic material or the like can be used for the PTC element 611.

FIG. 16C illustrates an example of a power storage system 615. The power storage system 615 includes a plurality of the lithium-ion batteries 616 and is also referred to as a battery pack in some cases. The positive electrodes of the lithium-ion batteries are in contact with and electrically connected to conductors 624 isolated by an insulator 625. The conductors 624 are electrically connected to a control circuit 620 through wirings 623. The negative electrodes of the lithium-ion batteries are electrically connected to the control circuit 620 through a wiring 626. As the control circuit 620, a protection circuit for preventing overcharging or overdischarging can be used, for example.

FIG. 16D illustrates an example of the power storage system 615. The power storage system 615 includes the plurality of lithium-ion batteries 616, and the plurality of lithium-ion batteries 616 are sandwiched between a conductive plate 628 and a conductive plate 614. The plurality of lithium-ion batteries 616 are electrically connected to the conductive plate 628 and the conductive plate 614 through a wiring 627. The plurality of lithium-ion batteries 616 may be connected in parallel, connected in series, or connected in series after being connected in parallel. With the power storage system 615 including the plurality of lithium-ion batteries 616, large electric power can be extracted.

The plurality of lithium-ion batteries 616 may be connected in series after being connected in parallel.

A temperature control device may be provided between the plurality of lithium-ion batteries 616. The lithium-ion batteries 616 can be cooled with the temperature control device when overheated, whereas the lithium-ion batteries 616 can be heated with the temperature control device when cooled too much. Thus, the performance of the power storage system 615 is less likely to be influenced by the outside temperature.

In FIG. 16D, the power storage system 615 is electrically connected to the control circuit 620 through a wiring 621 and a wiring 622. The wiring 621 is electrically connected to the positive electrodes of the plurality of lithium-ion batteries 616 through the conductive plate 628, and the wiring 622 is electrically connected to the negative electrodes of the plurality of lithium-ion batteries 616 through the conductive plate 614.

By including the positive electrode active material of one embodiment of the present invention, the cylindrical lithium-ion battery 616 can be a secondary battery with high capacity, high discharge capacity, and excellent cycling performance.

### [Other Structure Examples of Lithium-Ion Battery]

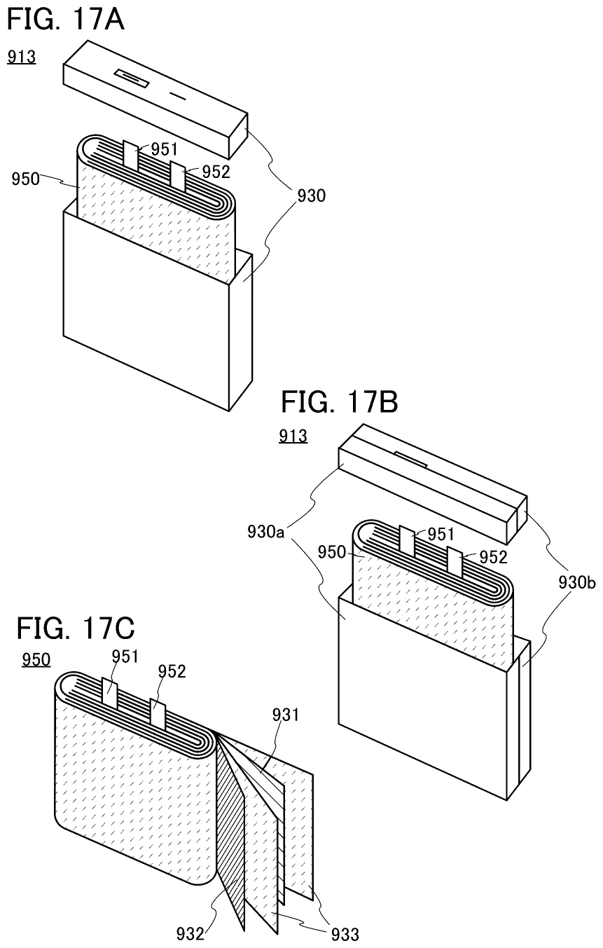

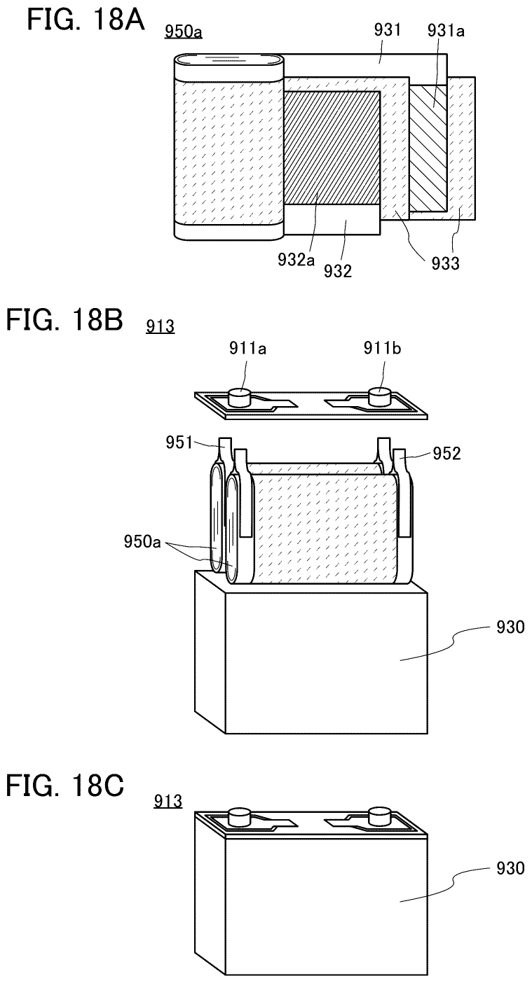

Structure examples of lithium-ion batteries are described with reference to FIGS. 17A to 17C and FIGS. 18A to 18C.

A lithium-ion battery 913 illustrated in FIG. 17A includes a wound body 950 provided with a terminal 951 and a terminal 952 inside a housing 930. The wound body 950 is immersed in an electrolyte solution inside the housing 930. The terminal 952 is in contact with the housing 930. The terminal 951 is not in contact with the housing 930 with use of an insulator or the like. Note that in FIG. 17A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 17B, the housing 930 illustrated in FIG. 17A may be formed using a plurality of materials. For example, in the lithium-ion battery 913 illustrated in FIG. 17B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the lithium-ion battery 913 can be inhibited. When an electric field is not significantly blocked by the housing 930a, an antenna may be provided inside the housing 930a. For the housing 930b, a metal material can be used, for example.

FIG. 17C illustrates the structure of the wound body 950. The wound body 950 includes a negative electrode 931, a positive electrode 932, and electrolyte layers 933. The wound body 950 is obtained by winding a sheet of a stack in which the negative electrode 931 and the positive electrode 932 overlap with each other with the electrolyte layer 933 therebetween. Note that a plurality of stacks each including the negative electrode 931, the positive electrode 932, and the electrolyte layers 933 may be further stacked.

As illustrated in FIGS. 18A to 18C, the lithium-ion battery 913 may include a wound body 950a. The wound body 950a illustrated in FIG. 18A includes the negative electrode 931, the positive electrode 932, and the electrolyte layers 933. The negative electrode 931 includes a negative electrode active material layer 931a. The positive electrode 932 includes a positive electrode active material layer 932a.

The electrolyte layers 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 18B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 18C, the wound body 950a is covered with the housing 930, whereby the lithium-ion battery 913 is completed. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 18B, the lithium-ion battery 913 may include a plurality of the wound bodies 950a. The use of the plurality of wound bodies 950a enables the lithium-ion battery 913 to have higher charge/discharge capacities. The description of the lithium-ion battery 913 illustrated in FIGS. 17A to 17C can be referred to for the other components of the lithium-ion battery 913 illustrated in FIGS. 18A and 18B.

By including the positive electrode active material of one embodiment of the present invention, the lithium-ion battery 913 with the wound body can be a secondary battery with high capacity, high discharge capacity, and excellent cycling performance.

The contents in this embodiment can be combined with the contents in any of the other embodiments as appropriate.

### Embodiment 4

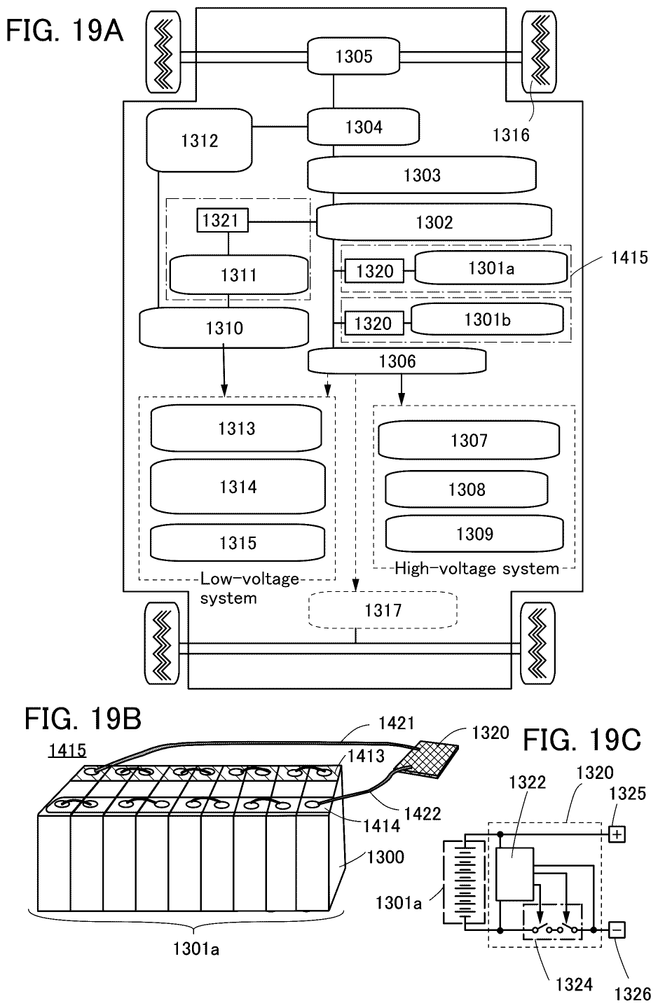

In this embodiment, an example of application to an electric vehicle (EV) will be described with reference to FIGS. 19A to 19C.

As illustrated in FIG. 19A, the electric vehicle is provided with first batteries 1301a and 1301b as main lithium-ion batteries for driving and a second battery 1311 that supplies electric power to an inverter 1312 for starting a motor 1304. By including the positive electrode active material of one embodiment of the present invention, the first batteries 1301a and 1301b can each be a secondary battery with high capacity, high discharge capacity, and excellent cycling performance.

The second battery 1311 is also referred to as a cranking battery (also referred to as a starter battery). The second battery 1311 only needs high output and does not necessarily have high capacity, and the capacity of the second battery 1311 is lower than that of the first batteries 1301a and 1301b.

The internal structure of the first battery 1301a may be a wound structure or a stacked-layer structure. Alternatively, the first battery 1301a may be the secondary battery in the above embodiment. The use of the secondary battery in the above embodiment as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of lithium-ion batteries, large electric power can be extracted. The plurality of lithium-ion batteries may be connected in parallel, connected in series, or connected in series after being connected in parallel. The plurality of lithium-ion batteries are also referred to as an assembled battery.

In order to cut off electric power from the plurality of lithium-ion batteries, the lithium-ion batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

The first battery 1301a will be described with reference to FIG. 19B.

FIG. 19B illustrates an example in which nine rectangular lithium-ion batteries 1300 form one battery pack 1415. The nine rectangular lithium-ion batteries 1300 are connected in series; one electrode of each battery is fixed by a fixing portion 1413 made of an insulator, and the other electrode thereof is fixed by a fixing portion 1414 made of an insulator. Although this embodiment describes an example in which the lithium-ion batteries are fixed by the fixing portions 1413 and 1414, they may be stored in a battery container box (also referred to as a housing). Since a vibration or a jolt is assumed to be given to the vehicle from the outside (e.g., a road surface), the plurality of lithium-ion batteries are preferably fixed by the fixing portions 1413 and 1414 and a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charging control circuit or a battery control system that includes a memory circuit including a transistor using an oxide semiconductor is referred to as a battery operating system or a battery oxide semiconductor (BTOS) in some cases.

A metal oxide functioning as an oxide semiconductor is preferably used. For example, as the oxide, a metal oxide such as an In-M-Zn oxide (an element M is one or more selected from aluminum, gallium, yttrium, copper, vanadium, beryllium, boron, titanium, iron, nickel, germanium, zirconium, molybdenum, lanthanum, cerium, neodymium, hafnium, tantalum, tungsten, and magnesium) or the like is preferably used. In particular, the In-M-Zn oxide that can be used as the oxide is preferably a c-axis aligned crystal oxide semiconductor (CAAC-OS) or a cloud-aligned composite oxide semiconductor (CAC-OS). Alternatively, In—Ga oxide or In—Zn oxide may be used as the oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction.

The control circuit portion 1320 preferably includes a transistor using an oxide semiconductor because it can be used in a low-temperature environment. For the process simplicity, the control circuit portion 1320 may be formed using transistors of the same conductivity type. A transistor using an oxide semiconductor in its semiconductor layer has an operating ambient temperature range of −40° C. to 150° C., inclusive, which is wider than that of a single crystal Si transistor, and thus shows a smaller change in characteristics than the single crystal Si transistor when the lithium-ion battery is heated. The off-state current of the transistor using an oxide semiconductor is lower than the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety.

The control circuit portion 1320 that includes a memory circuit including a transistor using an oxide semiconductor can also function as an automatic control device for the lithium-ion battery to resolve ten items of causes of instability, such as a micro-short circuit. Examples of functions of resolving the ten items of causes of instability include prevention of overcharging, prevention of overcurrent, control of overheating during charging, cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the lithium-ion battery can be extremely small in size.

A micro-short circuit refers to a minute short circuit caused in a lithium-ion battery. One of the supposed causes of a micro-short circuit is as follows. Uneven distribution of a positive electrode active material due to charging and discharging performed a plurality of times causes local current concentration at part of the positive electrode and part of the negative electrode. Another supposed cause is generation of a by-product due to a side reaction.

It can be said that the control circuit portion 1320 not only detects a micro-short circuit but also senses a terminal voltage of the lithium-ion battery and controls the charge and discharge state of the lithium-ion battery. For example, to prevent overcharging, an output transistor of a charge circuit and an interruption switch can be turned off substantially at the same time.

FIG. 19C illustrates an example of a block diagram of the battery pack 1415 illustrated in FIG. 19B.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the lithium-ion battery to be used, and imposes the upper limit of current from the outside, the upper limit of output current to the outside, and the like. The range from the lower limit voltage to the upper limit voltage of the lithium-ion battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon; the switch portion 1324 may be formed using, for example, a power transistor containing germanium (Ge), silicon germanium (SiGe), gallium arsenide (GaAs), gallium aluminum arsenide (GaAlAs), indium phosphide (InP), silicon carbide (SiC), zinc selenide (ZnSe), gallium nitride (GaN), gallium oxide (GaOₓ, where x is a real number greater than 0), or the like. A memory element using an OS transistor can be freely placed by being stacked over a circuit using a Si transistor, for example; hence, integration can be easy. The control circuit portion 1320 using an OS transistor can be stacked over the switch portion 1324 so that they can be integrated into one chip and can be reduced in size.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead storage batteries are usually used for the second battery 1311 due to cost advantage. There is an advantage that the second battery 1311 can be maintenance-free when a lithium-ion battery is used; however, in the case of long-term use, for example three years or more, anomaly that cannot be determined at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

Although this embodiment describes an example in which lithium-ion batteries are used as both the first battery 1301a and the second battery 1311, a lead storage battery, an all-solid-state battery, or an electric double layer capacitor may be used as the second battery 1311. By including the positive electrode active material of one embodiment of the present invention, the above-described lithium-ion batteries can each be a secondary battery with high capacity, high discharge capacity, and excellent cycling performance.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge performance of a lithium-ion battery used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or the connection cable of the charger is sometimes provided with a control circuit. The control circuit portion 1320 is also referred to as an electronic control unit (ECU). The ECU is connected to a controller area network (CAN) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100-V outlet, a 200-V outlet, and a three-phase 200-V outlet (50 KW), for example. Furthermore, charging can be performed with electric power supplied from external charging equipment by a contactless power feeding method or the like.

Next, examples in which the lithium-ion battery of one embodiment of the present invention is mounted on a vehicle, typically a transport vehicle, will be described.

Mounting the lithium-ion battery on vehicles can achieve next-generation clean energy vehicles such as hybrid vehicles (HVs), electric vehicles (EVs), and plug-in hybrid vehicles (PHVs). The lithium-ion battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft.

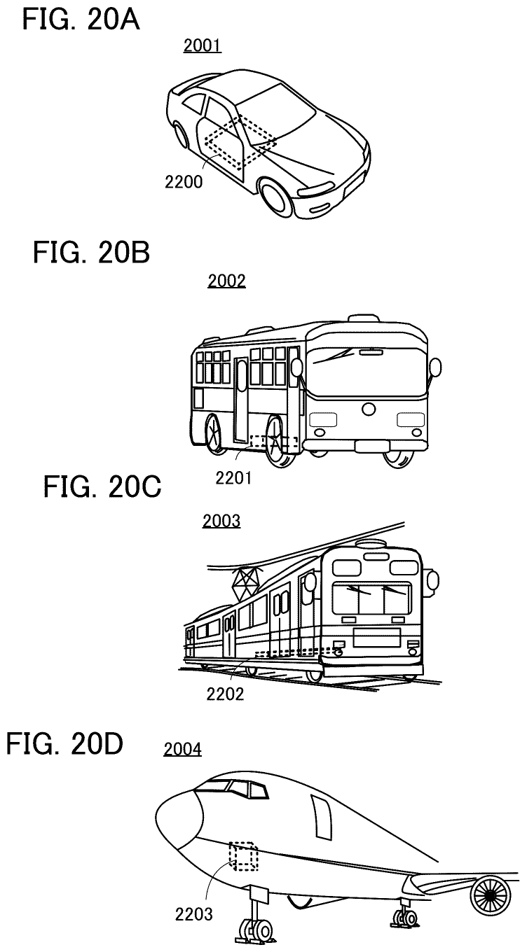

FIGS. 20A to 20D illustrate examples of transport vehicles using one embodiment of the present invention. An automobile 2001 illustrated in FIG. 20A is an electric vehicle that runs using an electric motor as a driving power source. Alternatively, the automobile 2001 is a hybrid vehicle that enables appropriate selection of an electric motor or an engine as a driving power source. In the case where the lithium-ion battery is mounted on the vehicle, an example of the lithium-ion battery described in the above embodiment is provided at one position or several positions. By including the positive electrode active material of one embodiment of the present invention, the lithium-ion battery mounted on the vehicle can be a secondary battery with high capacity, high discharge capacity, and excellent cycling performance.

The automobile 2001 illustrated in FIG. 20A includes a battery pack 2200, and the battery pack includes a battery module in which a plurality of lithium-ion batteries are connected to each other. The battery pack 2200 preferably further includes a charge control device that is electrically connected to the battery module.

The automobile 2001 can be charged when the lithium-ion battery included in the automobile 2001 is supplied with electric power from external charge equipment by a plug-in system, a contactless charge system, or the like. In charging, a given method such as CHAdeMO (registered trademark) or Combined Charging System may be employed as a charge method, the standard of a connector, and the like as appropriate. The lithium-ion battery may be a charge station provided in a commerce facility or a household power supply. For example, with the use of the plug-in technique, the power storage device mounted on the automobile 2001 can be charged by being supplied with electric power from the outside. Charging can be performed by converting AC power into DC power through a converter such as an ACDC converter.

Although not illustrated, the vehicle may be provided with a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when moving. In addition, the contactless power feeding system may be utilized to perform transmission and reception of electric power between two vehicles. Furthermore, a solar cell may be provided in the exterior of the vehicle to charge the lithium-ion battery while the vehicle is stopped or while the vehicle is moving. To supply power in such a contactless manner, an electromagnetic induction method or a magnetic resonance method can be used.

FIG. 20B illustrates a large transporter 2002 having a motor controlled by electricity, as an example of a transport vehicle. A battery module of the transporter 2002 includes, for example, a cell unit of four lithium-ion batteries with a nominal voltage higher than or equal to 3.0 V and lower than or equal to 5.0 V, and 48 cells that are connected in series to have a maximum voltage of 170 V. A battery pack 2201 has the same function as that in FIG. 19B except, for example, the number of lithium-ion batteries; thus, the description is omitted. By including the positive electrode active material of one embodiment of the present invention, the lithium-ion batteries in the battery pack 2201 can each be a secondary battery with high capacity, high discharge capacity, and excellent cycling performance.

FIG. 20C illustrates a large transport vehicle 2003 having a motor controlled by electricity as an example. A battery module of the transport vehicle 2003 includes, for example, 100 or more lithium-ion batteries with a nominal voltage higher than or equal to 3.0 V and lower than or equal to 5.0 V that are connected in series to have a maximum voltage of 600 V. A battery pack 2202 has the same function as that in FIG. 19B except, for example, the number of lithium-ion batteries configuring the battery module; thus, the description is omitted. By including the positive electrode active material of one embodiment of the present invention, the lithium-ion batteries of the battery module can each be a secondary battery with high capacity, high discharge capacity, and excellent cycling performance.

FIG. 20D illustrates an aircraft 2004 having a combustion engine as an example. The aircraft 2004 illustrated in FIG. 20D can also be regarded as a kind of transport vehicle because it has wheels for takeoff and landing, and includes a battery pack 2203 that includes a charge control device and a battery module configured by connecting a plurality of lithium-ion batteries. The battery module of the aircraft 2004 includes, for example, eight 4-V lithium-ion batteries that are connected in series to have a maximum voltage of 32 V. The battery pack 2203 has the same function as that in FIG. 19B except, for example, the number of lithium-ion batteries configuring the battery module; thus, the description is omitted.

The contents in this embodiment can be combined with the contents in any of the other embodiments as appropriate.

### Embodiment 5

In this embodiment, examples in which a vehicle such as a motorcycle or a bicycle is provided with the lithium-ion battery of one embodiment of the present invention will be described.

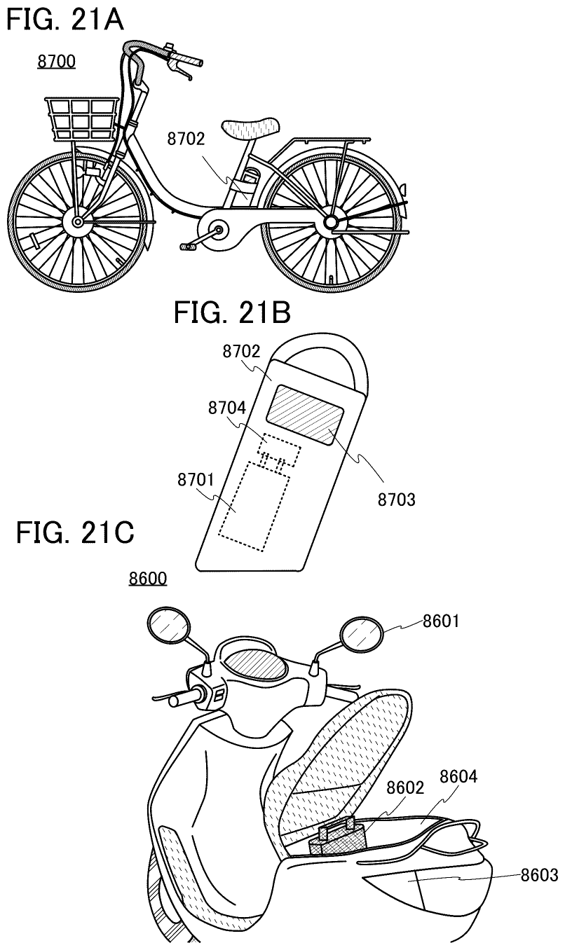

FIG. 21A illustrates an example of an electric bicycle using the lithium-ion battery of one embodiment of the present invention. The lithium-ion battery of one embodiment of the present invention can be used for an electric bicycle 8700 illustrated in FIG. 21A. The lithium-ion battery of one embodiment of the present invention may include a protection circuit.

The electric bicycle 8700 includes a power storage device 8702. The power storage device 8702 can supply electricity to a motor that assists a rider. The power storage device 8702 is portable, and FIG. 21B illustrates the state where the power storage device 8702 is detached from the bicycle. A plurality of lithium-ion batteries 8701 of one embodiment of the present invention are incorporated in the power storage device 8702, and the remaining battery capacity and the like can be displayed on a display portion 8703. By including the positive electrode active material of one embodiment of the present invention, the lithium-ion batteries 8701 can each be a secondary battery with high capacity, high discharge capacity, and excellent cycling performance.

The power storage device 8702 includes a control circuit 8704 capable of charge control or anomaly detection for the lithium-ion battery. The control circuit 8704 is electrically connected to a positive electrode and a negative electrode of the lithium-ion battery 8701. The control circuit 8704 can contribute greatly to elimination of accidents due to lithium-ion batteries, such as fires.

FIG. 21C illustrates an example of a motorcycle including the lithium-ion battery of one embodiment of the present invention. A motor scooter 8600 illustrated in FIG. 21C includes a power storage device 8602, side mirrors 8601, and indicator lights 8603. The power storage device 8602 can supply electricity to the indicator lights 8603. By including the positive electrode active material of one embodiment of the present invention, the lithium-ion battery can be a secondary battery with high capacity, high discharge capacity, and excellent cycling performance.

In the motor scooter 8600 illustrated in FIG. 21C, the power storage device 8602 can be stored in an under-seat storage unit 8604. The power storage device 8602 can be stored in the under-seat storage unit 8604 even when the under-seat storage unit 8604 is small.

The contents in this embodiment can be combined with the contents in any of the other embodiments as appropriate.

### Embodiment 6

In this embodiment, examples of electronic devices each including the lithium-ion battery of one embodiment of the present invention will be described. Examples of electronic devices including the lithium-ion battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a notebook personal computer, a tablet terminal, an e-book reader, and a mobile phone.

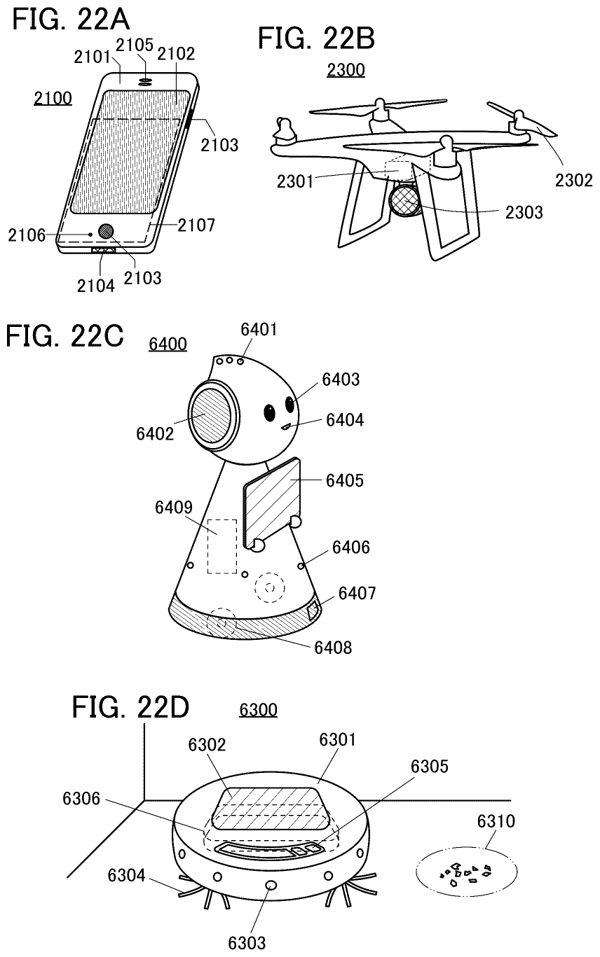

FIG. 22A illustrates an example of a mobile phone. A mobile phone 2100 includes a display portion 2102 set in a housing 2101, operation buttons 2103, an external connection port 2104, a speaker 2105, a microphone 2106, and the like. The mobile phone 2100 includes a lithium-ion battery 2107. By including the positive electrode active material of one embodiment of the present invention, the lithium-ion battery can be a secondary battery with high capacity, high discharge capacity, and excellent cycling performance.

The mobile phone 2100 is capable of executing a variety of applications such as mobile phone calls, e-mailing, text viewing and editing, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication between the mobile phone 2100 and a headset capable of wireless communication enables hands-free calling.

The mobile phone 2100 includes the external connection port 2104, and can perform direct data transmission and reception with another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 22B illustrates an unmanned aircraft 2300 including a plurality of rotors 2302. The unmanned aircraft 2300 is sometimes also referred to as a drone. The unmanned aircraft 2300 includes a lithium-ion battery 2301 of one embodiment of the present invention, a camera 2303, and an antenna (not illustrated). The unmanned aircraft 2300 can be remotely controlled through the antenna. By including the positive electrode active material of one embodiment of the present invention, the lithium-ion battery can be a secondary battery with high capacity, high discharge capacity, and excellent cycling performance.

FIG. 22C illustrates an example of a robot. A robot 6400 illustrated in FIG. 22C includes a lithium-ion battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400. The upper camera 6403 and the lower camera 6406 each have a function of taking an image of the surroundings of the robot 6400. The obstacle sensor 6407 can detect the presence of an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the lithium-ion battery 6409 of one embodiment of the present invention and a semiconductor device or an electronic component. By including the positive electrode active material of one embodiment of the present invention, the lithium-ion battery can be a secondary battery with high capacity, high discharge capacity, and excellent cycling performance.

FIG. 22D illustrates an example of a cleaning robot. A cleaning robot 6300 includes a display portion 6302 placed on a top surface of a housing 6301, a plurality of cameras 6303 placed on a side surface of the housing 6301, a brush 6304, operation buttons 6305, a lithium-ion battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on a bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the lithium-ion battery 6306 of one embodiment of the present invention and a semiconductor device or an electronic component. By including the positive electrode active material of one embodiment of the present invention, the lithium-ion battery can be a secondary battery with high capacity, high discharge capacity, and excellent cycling performance.

This embodiment can be implemented in combination with any of the other embodiments.

### Embodiment 7

In this embodiment, examples of devices for space each including the lithium-ion battery of one embodiment of the present invention will be described.

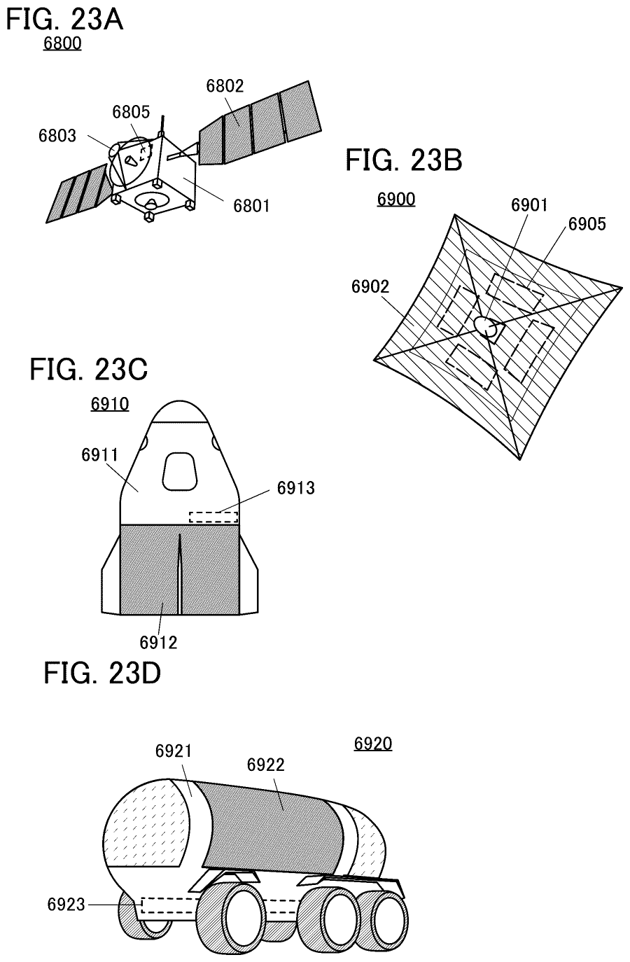

FIG. 23A illustrates an artificial satellite 6800 as an example of a device for space. The artificial satellite 6800 includes a body 6801, a solar panel 6802, an antenna 6803, and a lithium-ion battery 6805. A solar panel is referred to as a solar cell module in some cases.

When the solar panel 6802 is irradiated with sunlight, electric power required for the operation of the artificial satellite 6800 is generated. However, for example, in the situation where the solar panel is not irradiated with sunlight or the amount of sunlight with which the solar panel is irradiated is small, the amount of generated electric power is small. Accordingly, a sufficient amount of electric power required for the operation of the artificial satellite 6800 might not be generated. In order to operate the artificial satellite 6800 even with a small amount of generated electric power, the artificial satellite 6800 is preferably provided with the lithium-ion battery 6805. By including the positive electrode active material of one embodiment of the present invention, the lithium-ion battery can be a secondary battery with high capacity, high discharge capacity, and excellent cycling performance.

The artificial satellite 6800 can generate a signal. The signal is transmitted through the antenna 6803, and the signal can be received by a ground-based receiver or another artificial satellite, for example. When the signal transmitted by the artificial satellite 6800 is received, the position of a receiver that receives the signal can be measured, for example. Thus, the artificial satellite 6800 can construct a satellite positioning system, for example.

Alternatively, the artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of sensing thermal infrared rays emitted from the surface of the earth. Thus, the artificial satellite 6800 can function as an earth observing satellite, for example.

FIG. 23B illustrates a probe 6900 including a solar sail as an example of a device for space. The probe 6900 includes a body 6901, a solar sail 6902, and a lithium-ion battery 6905. By including the positive electrode active material of one embodiment of the present invention, the lithium-ion battery can be a secondary battery with high capacity, high discharge capacity, and excellent cycling performance. When photons from the sun are incident on the surface of the solar sail 6902, the momentum is transmitted to the solar sail 6902. Hence, the surface of the solar sail 6902 preferably has a thin film with high reflectance and further preferably faces in the direction of the sun.

The solar sail 6902 may be designed to fold compact before reaching the outer atmosphere and to be unfurled to have a large sheet-like shape as illustrated in FIG. 23B in the expanse beyond the earth's atmosphere (outer space).

FIG. 23C illustrates a spacecraft 6910 as an example of a device for space. The spacecraft 6910 includes a body 6911, a solar panel 6912, and a lithium-ion battery 6913. By including the positive electrode active material of one embodiment of the present invention, the lithium-ion battery can be a secondary battery with high capacity, high discharge capacity, and excellent cycling performance. The body 6911 can include a pressurized cabin and an unpressurized cabin, for example. The pressurized cabin may be designed such that the crew can get into the cabin. Electric power that is generated by irradiation of the solar panel 6912 with sunlight can be stored in the lithium-ion battery 6913.

FIG. 23D illustrates a rover 6920 as an example of a device for space. The rover 6920 includes a body 6921 and a lithium-ion battery 6923. By including the positive electrode active material of one embodiment of the present invention, the lithium-ion battery can be a secondary battery with high capacity, high discharge capacity, and excellent cycling performance. The rover 6920 may include a solar panel 6922.

The rover 6920 may be designed such that the crew can get into the rover. Electric power that is generated by irradiation of the solar panel 6912 with sunlight may be stored in the lithium-ion battery 6923, or electric power generated by another power source such as a fuel cell or a radioisotope thermoelectric generator, for example, may be stored in the lithium-ion battery 6923. The contents in this embodiment can be combined with the contents in any of the other embodiments as appropriate.

### Example 1

In this example, the positive electrode active material of one embodiment of the present invention was fabricated, its features were analyzed, and its electrochemical properties were evaluated.

### <Fabrication of Positive Electrode Active Material>

The positive electrode active material of one embodiment of the present invention was synthesized by following the flowchart presented in FIG. 2. As shown in FIG. 2, commercially available LCO powder was doped with magnesium, nickel, and aluminum.

For the synthesis, MgF₂ (purity: 99.9%), LiF (purity: 99%), Ni(OH)₂ (purity: 99.9%), Al(OH)₃ (purity: 99.99%), and LiCoO₂ (purity: 99%; C-10N produced by NIPPON CHEMICAL INDUSTRIAL CO., LTD.) were used. Besides, C-10N without any processing was used as reference pristine LCO.

The muffle furnace was used for all the heating processes, and the samples were placed inside an alumina crucible.

First, pristine LCO (D50 of 12.5 μm) was preheated at 850° C. for 2 hours in an oxygen atmosphere without the addition of any added elements. In the first addition process, the preheated LCO, MgF₂, and LiF were weighed such that the molar ratio therebetween was 1:0.01:0.003, and mixed. This mixture was subjected to heating at 900° C. in an oxygen atmosphere for 20 hours. In the second addition process, the LCO obtained in the first addition process, Ni(OH)₂, and Al(OH)₃ were mixed in a molar ratio of 1:0.005:0.005, respectively. The mixture was subjected to heating at 850° C. for 10 hours in an oxygen atmosphere.

For comparison, M-LCO, MF-LCO, FN-LCO, FA-LCO, FNA-LCO, F-LCO, NA-LCO, MFN-LCO, and MFA-LCO were synthesized using a similar procedure by adding only Mg(OH)₂, MgF₂—LiF, LiF—Ni(OH)₂, LiF—Al(OH)₃, LiF—Ni(OH)₂—Al(OH)₃, LiF, Ni(OH)₂—Al(OH)₃, MgF₂—LiF—Ni(OH)₂, and MgF₂—LiF—Al(OH)₃, respectively. Heated LCO with no added elements was also fabricated following the same first and second heating processes. The pristine LCO was not subject to the heating process.

To synthesize M-LCO, the preheated LCO was mixed with Mg(OH)₂ in a 1:0.01 molar ratio, and then subjected to heating, similar to the first addition process described earlier. To synthesize MF-LCO, the preheated LCO, MgF₂, and LiF were mixed in a molar ratio of 1:0.01:0.003, respectively, and then subjected to heating, similar to the first addition process. These products were finally subjected to heating, similar to the second addition process without any added elements, so that the final products were obtained.

For FN-LCO, FA-LCO, FNA-LCO, and F-LCO, the preheated LCO and LiF were mixed in a 1:0.023 molar ratio and then subjected to heating, similar to the first addition process. The obtained LCO was mixed with Ni(OH)₂ or Al(OH)₃ in the molar ratio of 1:0.005, or with Ni(OH)₂ and Al(OH)₃ in a molar ratio of 1:0.005:0.005 and then subjected to the heating process, similar to the second addition process.

To synthesize NA-LCO, no added element was added to the preheated LCO before the first heating. The LCO subjected to the first heating was mixed with Ni(OH)₂ and Al(OH)₃ in a molar ratio of 1:0.005:0.005 and then subjected to the second heating process. To synthesize MFN-LCO and MFA-LCO, the preheated LCO, MgF₂, and LiF were mixed in a molar ratio of 1:0.01:0.003 and then subjected to the first heating process. The obtained LCO was mixed with Ni(OH)₂ or Al(OH)₃ in a molar ratio of 1:0.005 and then subjected to the second heating process. The heated LCO without any added elements was also fabricated through the same first and second heating processes.

### <Morphological and Structural Analyses>

### <<XRD>>

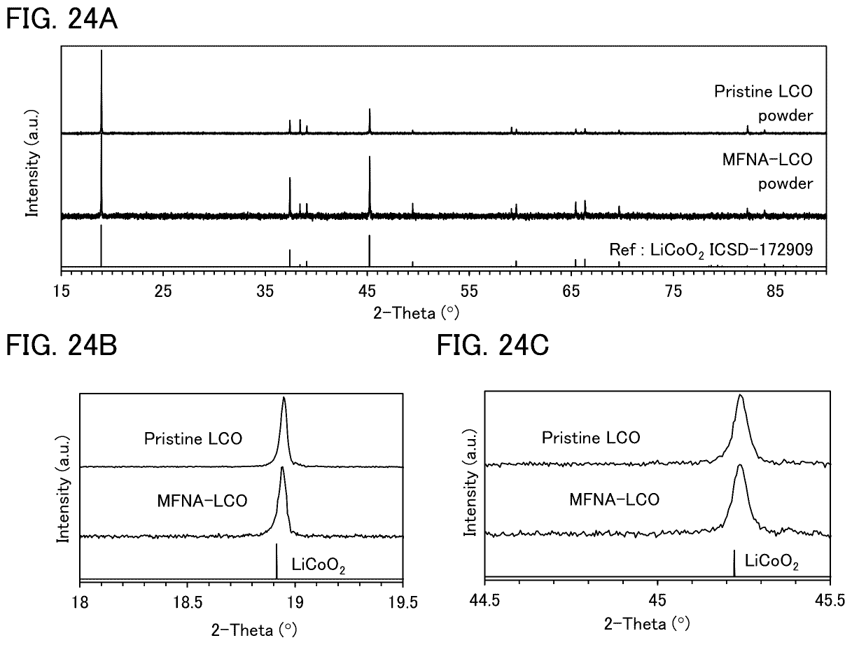

FIGS. 24A to 24C show powder XRD patterns of the positive electrode active material of one embodiment of the present invention and the pristine LCO, as well as a reference pattern. The powder XRD patterns of the positive electrode active material of one embodiment of the present invention and the pristine LCO indicated the presence of O3 phase and R-3m space group; no other phases were observed.

Table 2 shows the Rietveld refinement results of the powder XRD patterns for the samples. The Rietveld refinement was performed using DIFFRAC TOPAS ver. 6 software with a single phase of LiCoO₂ in the R-3m space group. The c-axis length of the positive electrode active material of one embodiment of the present invention slightly increased compared to that of the pristine LCO. One possible reason for the elongation could be doping of nickel and aluminum. A change in the a-axis length is extremely small, which suggests that a small amount of magnesium was substituted at the cobalt site.

TABLE 2

| | Parameters | | | | | | |
|---|---|---|---|---|---|---|---|
| | | | | Lvol-IB | | | |
| Sample | a (Å) | c (Å) | V (Å⁻³) | (nm) | Rₑₓₚ | R_{wp} | GOF |
| Pristine LCO | 2.816(3) | 14.052(0) | 96.522(8) | 317(4) | 6.92 | 11.09 | 1.6 |
| Positive electrode active material of one | 2.816(1) | 14.057(5) | 96.552(8) | 273(3) | 7.26 | 8.06 | 1.11 |
| embodiment of the present invention | | | | | | | |
| M-LCO | 2.816(7) | 14.055(8) | 96.578(6) | 265(4) | 9.08 | 9.91 | 1.09 |
| MF-LCO | 2.815(9) | 14.051(8) | 96.493(7) | 238(3) | 8.47 | 9.07 | 1.07 |
| FN-LCO | 2.816(1) | 14.053(1) | 96.514(5) | 260(3) | 7.01 | 7.54 | 1.08 |
| FA-LCO | 2.815(8) | 14.051(7) | 96.485(5) | 263(3) | 7.25 | 8.38 | 1.16 |
| FNA-LCO | 2.816(0) | 14.054(0) | 96.516(6) | 257(3) | 6.91 | 7.7 | 1.12 |

### <<SEM>>

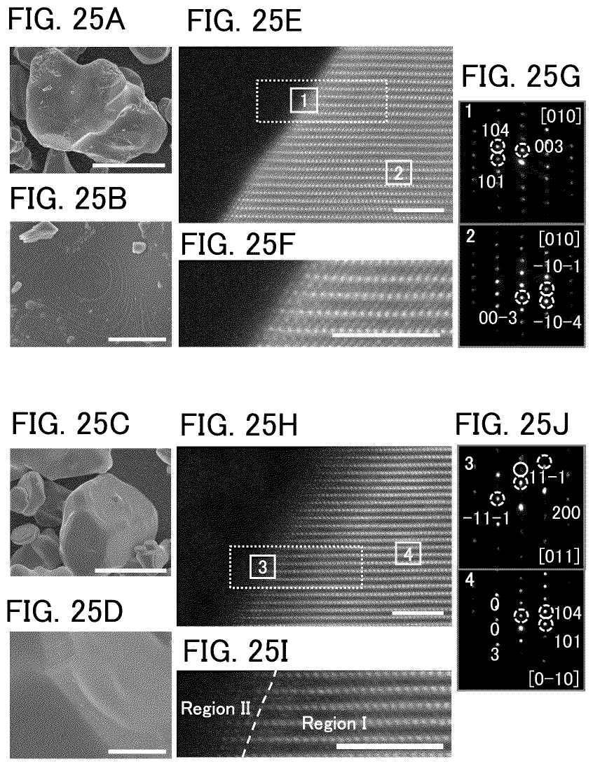

FIGS. 25A and 25B show scanning electron microscope (SEM) images of the pristine LCO. FIGS. 25C and 25D show SEM images of the positive electrode active material of one embodiment of the present invention. The bars in FIGS. 25A and 25C each represent 10 μm, and the bars in FIGS. 25B and 25D each represent 2 μm. The SEM images were acquired using a Hitachi SU4800 or SU8030 field-emission SEM (FE-SEM) with a 5 kV accelerating voltage.

The SEM images revealed that the surface of the positive electrode active material of one embodiment of the present invention was smoother than that of the pristine LCO. This could be attributed to the partial melting of the LCO particle surface and the molten fluoride salt during the heating process.

### <<SEM-EDX>>

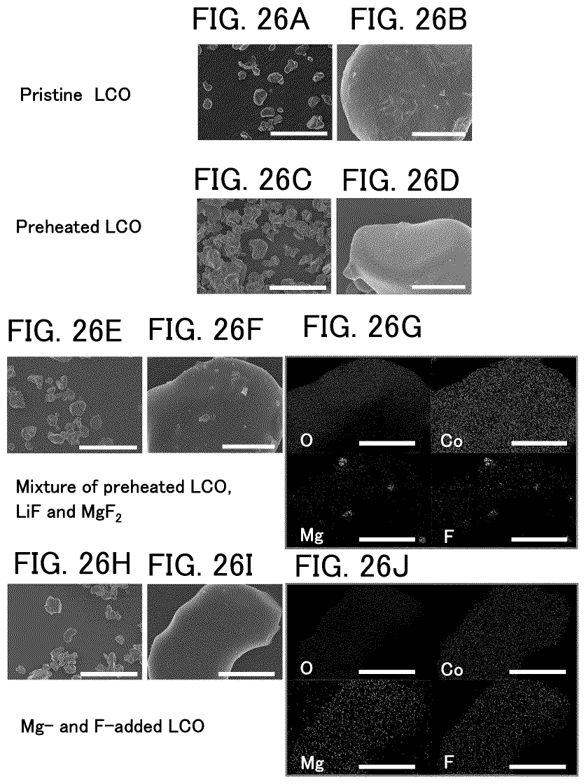

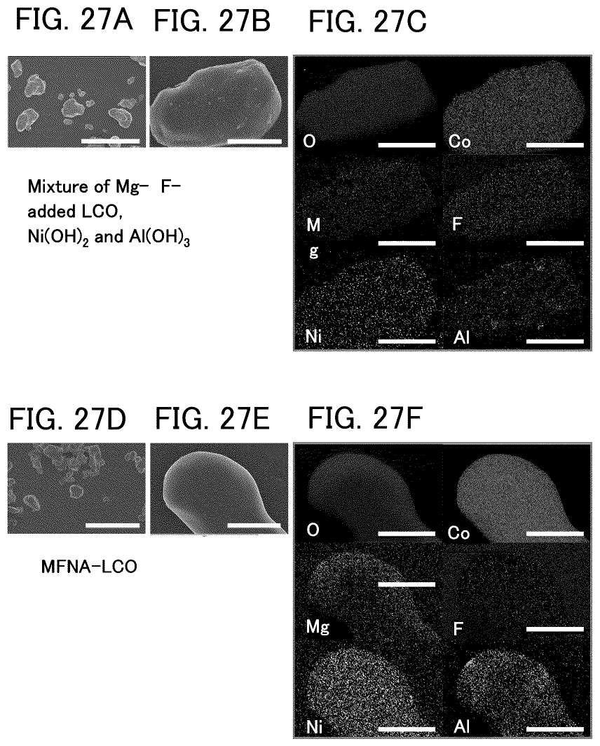

FIGS. 26A to 26J and FIGS. 27A to 27F show SEM-EDX mapping images of the positive electrode active material of one embodiment of the present invention in its synthesis steps. The SEM images were acquired using a Hitachi SU4800 or SU8030 field-emission SEM (FE-SEM) with a 5 kV accelerating voltage. SEM-EDX analysis was performed using the EMAX Evolution EX-370 (HORIBA Ltd.) with a 15 kV accelerating voltage. FIGS. 26A and 26B show SEM images of the pristine LCO, and FIGS. 26C and 26D show SEM images of the preheated LCO. FIGS. 26E and 26F show SEM images of the mixture of the preheated LCO, LiF, and MgF₂, and FIG. 26G shows SEM-EDX mapping images of each element in the same region as FIG. 26F. FIGS. 26H and 26I show SEM images of magnesium- and fluorine-added LCO, and FIG. 26J shows SEM-EDX mapping images of each element in the same region as FIG. 26I. FIGS. 27A and 27B show SEM images of the mixture of magnesium- and fluorine-added LCO, Ni(OH)₂, and Al(OH)₃, and FIG. 27C shows SEM-EDX mapping images of each element in the same region as FIG. 27B. FIGS. 27D and 27E show SEM images of the positive electrode active material of one embodiment of the present invention, and FIG. 27F shows SEM-EDX mapping images of each element in the same region as FIG. 27E. The bars in FIG. 26A, FIG. 26C, FIG. 26E, FIG. 26H, FIG. 27A, and FIG. 27D each represent 50 μm, and the bars in FIG. 26B, FIG. 26D, FIG. 26F, FIG. 26G, FIG. 26I, FIG. 26J, FIG. 27B, FIG. 27C, FIG. 27E, and FIG. 27F each represent 5 μm.

As shown in FIGS. 26E to 26J, SEM-EDX shows that heating melted the added MgF₂—LiF nanoparticles, which were spread wet on the surface of the lithium cobalt oxide particle. As shown in FIGS. 27D to 27F, EDX elemental mapping analysis of the particle of the positive electrode active material of one embodiment of the present invention shows that magnesium, nickel, and aluminum are uniformly distributed. However, nanoparticles composed mainly of these added elements were not observed.

### <<ICP-MS>>

In the synthesis of the positive electrode active material of one embodiment of the present invention, the elemental ratio is Co:Mg:F=1:0.01:0.023. Table 3 shows the results of the quantitative analysis of the added elements by using inductively coupled plasma mass spectrometry (ICP-MS). The ICP-MS analysis was performed using an agilent 8900. As shown in Table 3, the elemental ratio of Co:Mg in the particles of the positive electrode active material of one embodiment of the present invention was confirmed as 1:0.0093.

TABLE 3

| | Elemental ratio | | | |
|---|---|---|---|---|
| Sample | Li/Co | Mg/Co | Ni/Co | Al/Co |
| Pristine LCO | 1.06 | 0.0003 | 0.0004 | 0.0002 |
| Positive electrode active | 0.94 | 0.0093 | 0.0052 | 0.0055 |
| material of one embodiment | | | | |
| of the present invention | | | | |

### <<EPMA>>

As shown in Table 4, an electron probe microanalyzer (EPMA) also revealed that Co:Mg=1:0.009 in a cross-section of a particle of the positive electrode active material of one embodiment of the present invention. The EPMA analysis was performed using a JXA-iHP200F (JEOL Ltd.) with a 10 kV accelerating voltage. To analyze the elements of the bulk, the measurement was conducted on the vicinity of the center of the cross section of the particle.

TABLE 4

| | Elemental ratio | | | |
|---|---|---|---|---|
| Sample | F/Co | Mg/Co | Ni/Co | Al/Co |
| Pristine LCO | N.D. | N.D. | N.D. | N.D. |
| Positive electrode active | N.D. | 0.009 | 0.006 | N.D. |
| material of one embodiment | | | | |
| of the present invention | | | | |

### <<XPS>>

However, X-ray photoelectron spectroscopy (XPS) showed that the ratios of magnesium and fluorine to cobalt in the positive electrode active material of one embodiment of the present invention were significantly higher than those of magnesium and fluorine added during synthesis to cobalt included in pristine LCO. This indicates that magnesium and fluorine were abundantly distributed on the outermost surface of the particles of the positive electrode active material of one embodiment of the present invention. The elemental ratio obtained by XPS was Co:Mg:F=1:0.93:0.53.

Table 5 shows the chemical compositions of the particle surfaces of the pristine LCO, the positive electrode active material of one embodiment of the present invention, and the samples marked with asterisks in FIG. 2, which were measured by XPS analysis. The XPS measurements were recorded using a spectrometer with an Al X-ray source (1486.6 eV) (Quantera-SXM, ULVAC-PHI, Inc.). All binding energies were calibrated using the C Is peak at 284.8 eV.

TABLE 5

| | Elemental ratio | | | | |
|---|---|---|---|---|---|
| Sample | Li/Co | Mg/Co | F/Co | Ni/Co | Al/Co |
| Pristine LCO | 0.85 | N.D. | 0.08 | N.D. | N.D. |
| Preheated LCO | 0.71 | N.D. | 0.12 | N.D. | N.D. |
| Mixture of preheated LCO, | 0.49 | 0.33 | 0.83 | N.D. | N.D. |
| LiF, and MgF₂ | | | | | |
| Mg- and F- added LCO | 0.74 | 0.8 | 0.57 | N.D. | N.D. |
| Mixture of Mg- and F- added | 0.75 | 0.67 | 0.42 | 2.02 | 0.6 |
| LCO, Ni(OH)₂, and Al(OH)₃ | | | | | |
| Positive electrode active | 0.95 | 0.93 | 0.53 | 0.1 | 0.06 |
| material of one embodiment | | | | | |
| of the present invention | | | | | |

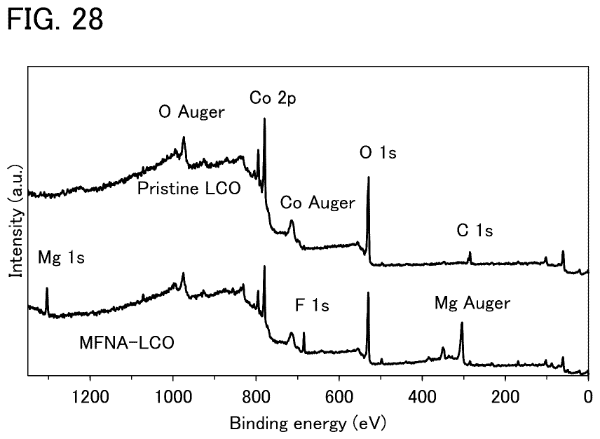

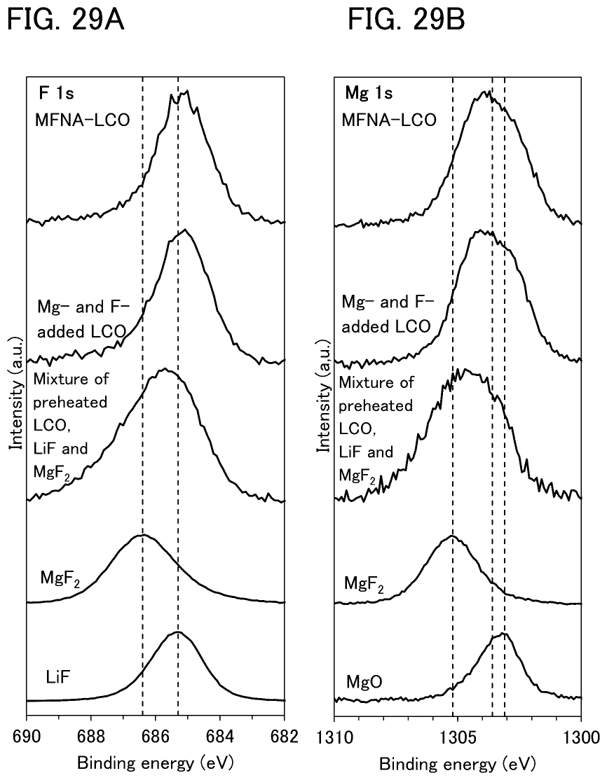

FIG. 28 and FIGS. 29A and 29B show XPS characterization of the positive electrode active material of one embodiment of the present invention. FIG. 28 shows XPS wide-scan spectra of the pristine LCO and the positive electrode active material of one embodiment of the present invention. FIG. 29A shows XPS narrow-scan spectra of F Is of the positive electrode active material of one embodiment of the present invention, magnesium- and fluorine-added LCO, the mixture of the preheated LCO, LiF, and MgF₂, MgF₂ (reference sample), and LiF (reference sample), and FIG. 29B shows XPS narrow-scan spectra of Mg 1s thereof.

As shown in FIG. 29A, the F 1s binding energy of the positive electrode active material of one embodiment of the present invention is different from that of MgF₂, which was used as an added element source. Furthermore, as shown in FIG. 29B, the Mg 1s binding energy of the positive electrode active material of one embodiment of the present invention implies the presence of oxyfluoride. The Mg 1s peak (the maximum value within the range of 1300 eV to 1308 eV; 1303.6 eV) of the positive electrode active material of one embodiment of the present invention is located between the peak of MgO (1303.3 eV) and the peak of MgF₂ (1306.3 eV).

### <<HAADF-STEM, NBED>>

FIG. 25E shows a high-angle annular dark field scanning transmission electron microscope (HAADF-STEM) image including the particle surface portion of the pristine LCO. FIG. 25F is an enlarged view of the region enclosed by the dotted rectangle in FIG. 25E. FIG. 25G shows nanobeam electron diffraction (NBED) patterns of the marked areas 1 and 2 in FIG. 25E. The cross-sectional HAADF-STEM observations and NBED measurements were performed using a JEM-ARM200F spherical aberration-corrected STEM produced by JEOL Ltd., at 200 kV accelerating voltage.

As shown in FIGS. 25E and 25F, the vicinity of the surface suffers cation mixing slightly. Each of the areas 1 and 2 exhibits a pattern indicating a layered rock salt crystal structure. This revealed a layered rock salt structure in the surface portion of the pristine LCO particles, which is similar to its interior structure.

FIG. 25H shows a HAADF-STEM image including the particle surface of the positive electrode active material of one embodiment of the present invention, and FIG. 25I shows an enlarged view of the region enclosed by the dotted rectangle in FIG. 25H. FIG. 25J shows NBED patterns of the marked areas 3 and 4 in FIG. 25H. The area 3 exhibits a pattern indicating a rock salt crystal structure, and the area 4 exhibits a pattern indicating a layered rock salt crystal structure.

Note that the scale bars in FIGS. 25E to 25I each represent 3 nm. In each of FIGS. 25G and 25J, the incident direction of the electron beam is shown, and indexes are added for some spots. FIG. 25J includes spots indicating a rock salt structure (dotted-line circles), as well as a spot indicating a layered rock salt structure (solid-line circle).

With the dashed line in FIG. 25I as a guide to the eye, the coherent bonding between the layered rock salt crystal structure (Region I) and the rock salt crystal structure (Region II) is suggested. As shown in FIGS. 25H and 25I, the inner part (also referred to as bulk region) of the positive electrode active material of one embodiment of the present invention has a layered rock salt structure with a visible contrast between the Co and Li layers in the HAADF-STEM image. Cation mixing is also observed. In the outermost surface region, a 1-nm-thick rock salt structure is observed (as indicated by the electron diffraction spots enclosed by the dotted-line circles), and a layered rock salt structure is also observed (as indicated by the electron diffraction spot enclosed by the solid-line circle.

Notably, the continuity of the alignment of atomic columns between Region I and Region II indicates that the rock salt shell (Region II) is coherently bonded to the layered rock salt core (Region I), as shown in FIG. 25I. Since this rock salt shell contains similar amounts of lithium as cobalt and magnesium as seen in the XPS results, lithium ions are expected to pass through the shell.

That is, lithium ions can pass through the shell via sites where lithium is present at the stage after synthesis in the rock salt crystal structure. Here, it is presumable that when the cation site occupancy of lithium, Li/(Li+Co+Mg+Ni+Al), is higher than or equal to 20%, for example, the cation site occupancy of lithium exceeds the critical percolation probability of the face-centered cubic lattice, enabling Li ion insertion and extraction. Since a cation vacancy can also serve as a Li diffusion path, it is presumable that Li ions can be inserted and extracted also when the above cation site occupancy of lithium considering a cation vacancy (Li+ cation vacancy)/(Li+Co+Mg+Ni+Al+ cation vacancy) is higher than or equal to 20%.

### <<STEM-EDX>>

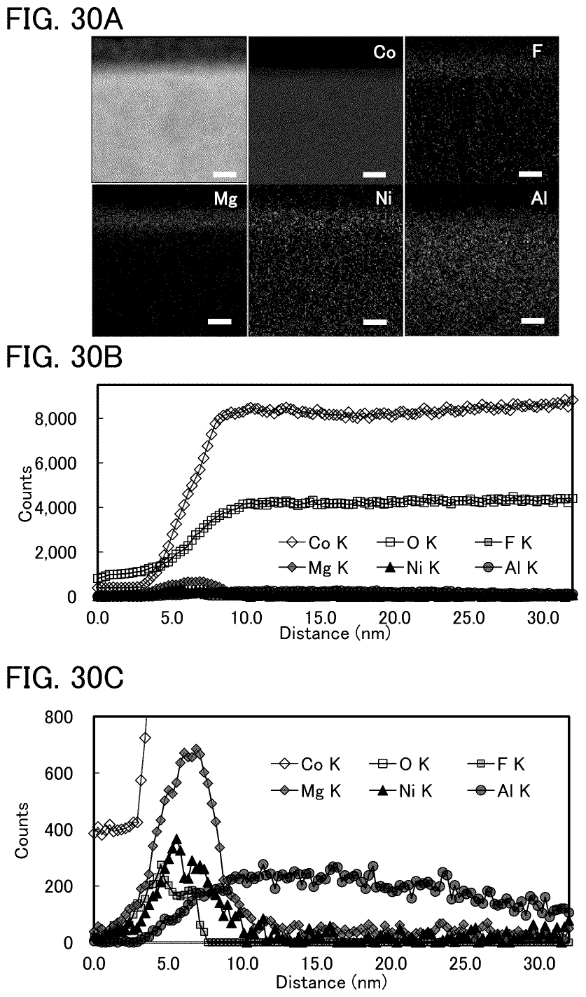

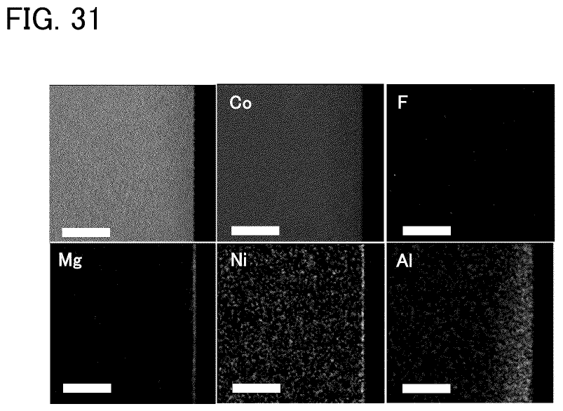

FIGS. 30A to 30C and FIG. 31 show energy dispersive X-ray (EDX) elemental analysis of the positive electrode active material of one embodiment of the present invention.

FIG. 30A shows a HAADF-STEM image and corresponding STEM/EDX elemental mapping analysis of Co, F, Mg, Ni, and Al. The bars each represent 5 nm. FIG. 30B shows a depth profile of elemental distribution. FIG. 30C is enlarged view of FIG. 30B. FIG. 31 shows a wide range HAADF-STEM image of the surface of a particle of the positive electrode active material of one embodiment of the present invention and corresponding wide range STEM-EDX elemental mapping analysis of Co, F, Mg, Ni, and Al. The bars each represent 50 nm. Cross-sectional STEM-EDX analysis was performed using the JED-2300T (JEOL Ltd.).

The above results revealed a uniform distribution of F, Mg, and Ni across the outermost surface, whereas their presence in the bulk was negligible in this measurement. Al is observed over a broad region from the particle surface. Near the surface of the positive electrode active material of one embodiment of the present invention, distinct gradients of added elements were visible. These observations suggest occurrence of a topotactic phase transition of the layered rock salt to the rock salt structure during synthesis, which is attributed to the migration of added elements into the structure of LCO.

The distribution of added elements in the particle surface portion of the positive electrode active material of one embodiment of the present invention could be explained as follows. First, the solubility of Mg²⁺ in lithium cobalt oxide is approximately 0.5%, while Al³⁺ can form a solid solution with lithium cobalt oxide, represented as LiAlₓCo₁₋ₓO₂. Second, MgO, CoO, and NiO form solid solutions with a rock salt structure. Hence, the Mg²⁺ and Ni²⁺ ions may supplant Co²⁺ ions of the CoO region in lithium cobalt oxide particle surface portion, which was formed by reducing the surface region during high-temperature heating. Therefore, the rock salt layer in the surface portion of lithium cobalt oxide contains significant quantities of Mg and Ni. On the other hand, the c-axis elongation observed by XRD and the EPMA analysis suggest that most of the added magnesium formed a solid solution in the LCO particles. The distribution of the added elements is achieved using molten salts of LiF and MgF₂, combined with the appropriate heating steps.

### <<Morphological and Structural Analyses at Each Step in Synthesis of Positive Electrode Active Material of One Embodiment of the Present Invention>>

The detailed features of the positive electrode active material of one embodiment of the present invention at each step in the synthesis process are described below.

For the evaluation of the structural characteristics, SEM-EDX, XPS, and XRD measurements were performed at each step of the synthesis process of the positive electrode active material of one embodiment of the present invention. The analyses were conducted at the following stages, which are marked with asterisks in the flowchart of the synthesis of the positive electrode active material of one embodiment of the present invention shown in FIG. 2.
pristine LCO
preheated LCO
mixture of preheated LCO, LiF, and MgF₂
magnesium- and fluorine-added LCO
mixture of magnesium- and fluorine-added LCO, Ni(OH)₂, and Al(OH)₃
positive electrode active material of one embodiment of the present invention

### <SEM-EDX Analysis>

The results of SEM-EDX (FIGS. 26A to 26J and FIGS. 27A to 27F) show that the state of the particle surface in each step was as follows. The pristine LCO had a lot of scratches and adhering materials on the particle surface. The surface of the preheated LCO particles was smoother than that of the pristine LCO. The particles of the mixture of preheated LCO, LiF, and MgF₂ were sparsely decorated with nanoparticles of MgF₂ and LiF. After the first heating step, the magnesium- and fluorine-added LCO had a smooth surface, and SEM-EDX no longer observed the nanoparticles that contain Mg and F on the LCO particle surface, revealing that MgF₂ and LiF melted on the LCO surface.

The particle surface of the mixture of magnesium- and fluorine-added LCO, Ni(OH)₂, and Al(OH)₃ was coated with nanoparticles of Ni(OH)₂ and Al(OH)₃. The particle surface in the positive electrode active material of one embodiment of the present invention was smooth unlike that in the mixture of magnesium- and fluorine-added LCO, Ni(OH)₂, and Al(OH)₃, and SEM-EDX observed a uniform coverage with Mg, F, Ni, and Al.

### <XPS Analysis>

FIG. 28, FIGS. 29A and 29B, and Table 5 present the XPS measurement results. From XPS, large amounts of magnesium and fluorine were detected in the mixture of preheated LCO, LiF, and MgF₂ because the nanoparticles of MgF₂ and LiF were attached to the LCO surface, as shown in SEM images. The amount of magnesium detected in the magnesium- and fluorine-added LCO after the first heating was larger than that before the first heating. This phenomenon was presumably caused by an increase in the amount of magnesium in the XPS probing region at a depth of about 5 nm from the surface. This increase resulted from the melting and spreading of magnesium on the lithium cobalt oxide particle surface caused by the effect of the molten fluoride salt. The detection amount of fluorine was smaller than that in the previous step, possibly because some of the LiF volatilized as it melted. Extremely large amounts of nickel and aluminum were detected from the mixture of magnesium- and fluorine-added LCO, Ni(OH)₂, and Al(OH)₃. This result is considered to be caused by Ni(OH)₂ and Al(OH)₃ nanoparticles covering the particle surface, as seen in SEM images. In the positive electrode active material of one embodiment of the present invention, the detection amounts of nickel and aluminum were smaller than those in the mixture of magnesium- and fluorine-added LCO, Ni(OH)₂, and Al(OH)₃. This suggests that nickel and aluminum form solid solutions in the lithium cobalt oxide particle surface portion. Moreover, since the detection amount of magnesium is larger than the detection amounts of nickel and aluminum, it is found that magnesium is located on the outermost surface of the LCO particle and that nickel and aluminum are located inward from the outermost surface.

FIGS. 29A and 29B show the binding energies of F and Mg. The binding energies of F Is and Mg 1s in the mixture of preheated LCO, LiF, and MgF₂ indicate the existence of MgF₂. However, the magnesium- and fluorine-added LCO exhibited different binding energies, suggesting the existence of an O—Mg—F bond. The O—Mg—F bond is maintained in the positive electrode active material of one embodiment of the present invention after the addition of Ni(OH)₂ and Al(OH)₃.

### <XRD Analysis>

Table 6 presents Rietveld refinement results of powder XRD patterns. The preheated LCO has a smaller lattice parameter than the pristine LCO, which should be due to reduced cation mixing and improved crystallinity. The c-axis length of the magnesium- and fluorine-added LCO increased compared to that of the mixture of preheated LCO, LiF, and MgF₂. One possible reason for the elongation of the c-axis length could be that Mg²⁺, which has a larger ionic radius than Co³⁺, was substituted at the Co site. Another reason could be that Mg²⁺, which has an ionic radius similar to that of Lit, was substituted at the Li site, changing the valence of the neighboring cobalt from trivalent to divalent for charge compensation. The positive electrode active material of one embodiment of the present invention also maintained an elongated c-axis length. This indicates that not only has the surface of the positive electrode active material of one embodiment of the present invention been coated with a large amount of magnesium as revealed by XPS but also magnesium has been doped in the bulk of the positive electrode active material of one embodiment of the present invention.

TABLE 6

| | Parameters | | | | | | |
|---|---|---|---|---|---|---|---|
| | | | | Lvol-IB | | | |
| Sample | a (Å) | c (Å) | V (Å⁻³) | (nm) | Rₑₓₚ | R_{wp} | GOF |
| Pristine LCO | 2.816(3) | 14.052(0) | 96.522(8) | 317(4) | 6.92 | 11.09 | 1.6 |
| Preheated LCO | 2.816(1) | 14.052(0) | 96.510(1) | 284(3) | 6.83 | 7.64 | 1.12 |
| Mixture of preheated LCO, LiF, and MgF₂ | 2.816(0) | 14.051(3) | 96.499(9) | 230(3) | 7.14 | 8.34 | 1.17 |
| Mg— and F— added LCO | 2.816(3) | 14.055(3) | 96.547(3) | 290(3) | 7.02 | 8.18 | 1.17 |
| Mixture of Mg— and F— added LCO, | 2.816(3) | 14.054(9) | 96.546(9) | 342(5) | 6.79 | 11.2 | 1.65 |
| Ni(OH)₂ and Al(OH)₃ | | | | | | | |
| Positive electrode active material of one | 2.816(1) | 14.057(5) | 96.552(8) | 273(3) | 7.26 | 8.06 | 1.11 |
| embodiment of the present invention | | | | | | | |

### <Electrochemical Properties>

### <<Half Cell>>

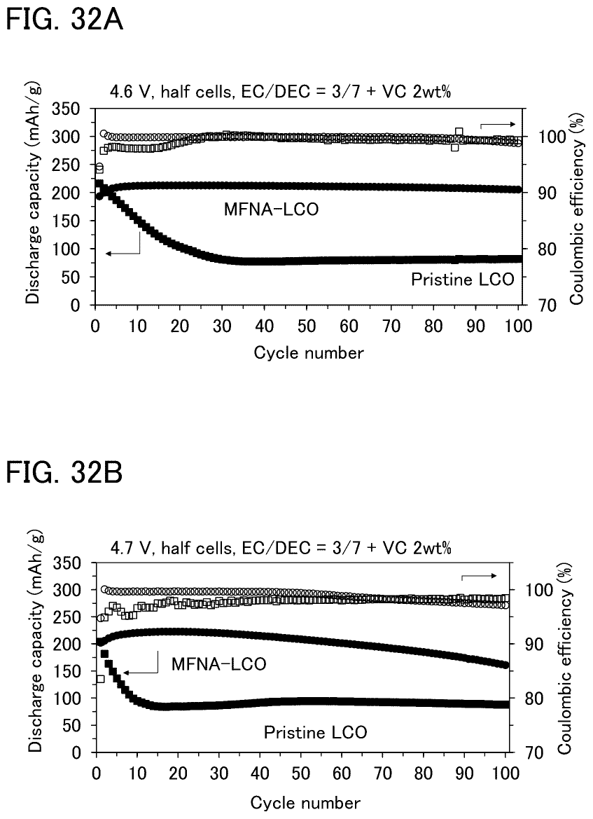

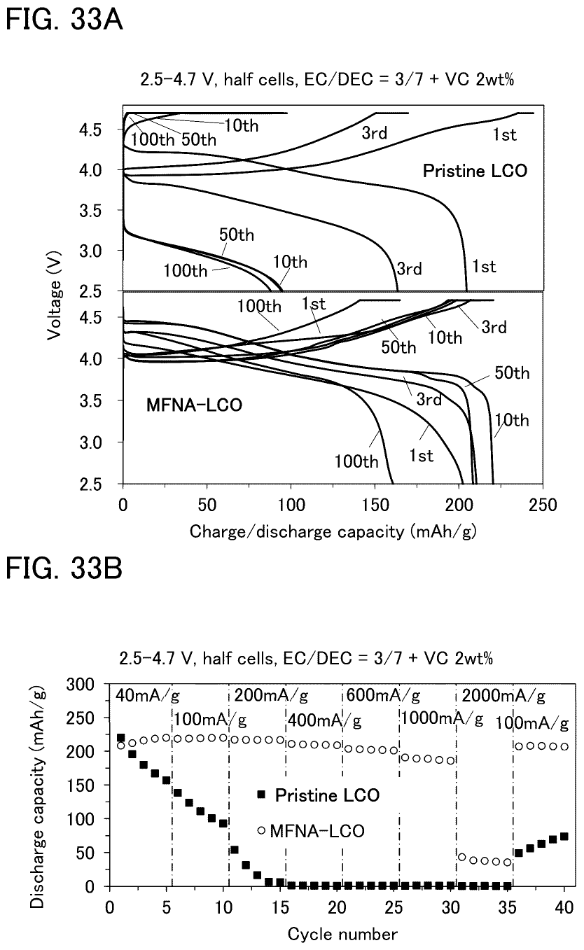

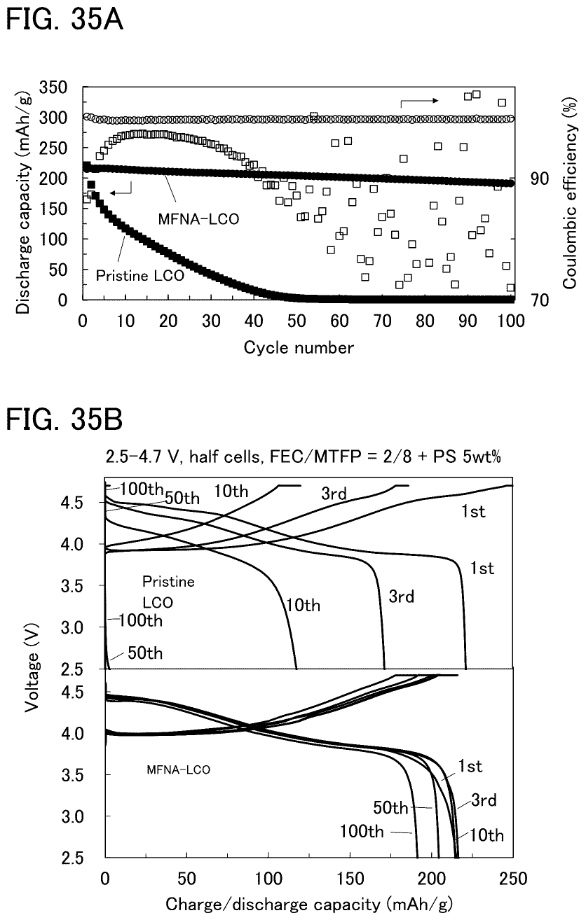

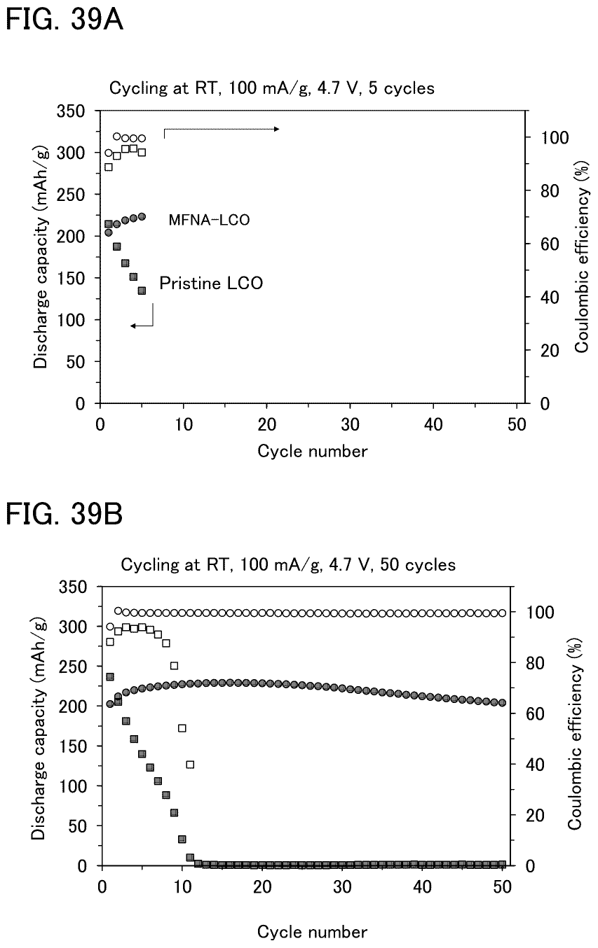

FIGS. 32A and 32B show the cycling performance of a positive electrode including the pristine LCO and a positive electrode including the positive electrode active material of one embodiment of the present invention in half cells. FIGS. 32A and 32B show the cycling performance of the electrode including the pristine LCO and the electrode including the positive electrode active material of one embodiment of the present invention in the coin-type half cells at 25° C. FIGS. 32A and 32B show charge/discharge cycling performance of the half cells with the positive electrode including the pristine LCO and the positive electrode including the positive electrode active material of one embodiment of the present invention; the voltage range is 2.5 V to 4.6 V (versus Li+/Li) in FIG. 32A and 2.5 V to 4.7 V (versus Li+/Li) in FIG. 32B. FIG. 33A shows charge/discharge curves of the pristine LCO and the positive electrode active material of one embodiment of the present invention at different cycles under the condition shown in FIG. 32A. FIG. 33B shows rate performance of half cells including the pristine LCO and the positive electrode active material of one embodiment of the present invention. In FIGS. 32A and 32B, the white circles indicate the Coulomb efficiency of the positive electrode active material of one embodiment of the present invention, and the black circles indicate the discharge capacity of the positive electrode active material of one embodiment of the present invention. The white squares indicate the Coulomb efficiency of the pristine LCO, and the black squares indicate the discharge capacity of the pristine LCO. The same applies to FIG. 35A and FIGS. 39A and 39B.

With the commonly used electrolyte solution, the positive electrode active material of one embodiment of the present invention demonstrated considerably higher capacity retentions than those of the pristine LCO. Specifically, the capacity retention of the positive electrode active material of one embodiment of the present invention was 96.4% (205.2 mAh/g) at 2.5 V to 4.6 V (versus Li+/Li) and 72.7% (160.9 mAh/g) at 2.5 V to 4.7 V (versus Li+/Li) after 100 cycles, which are much higher compared with those of the pristine LCO. The high Coulombic efficiency observed during cycling with the positive electrode active material of one embodiment of the present invention implies that the oxydative electrolyte decomposition was effectively suppressed by the surface coating layer.

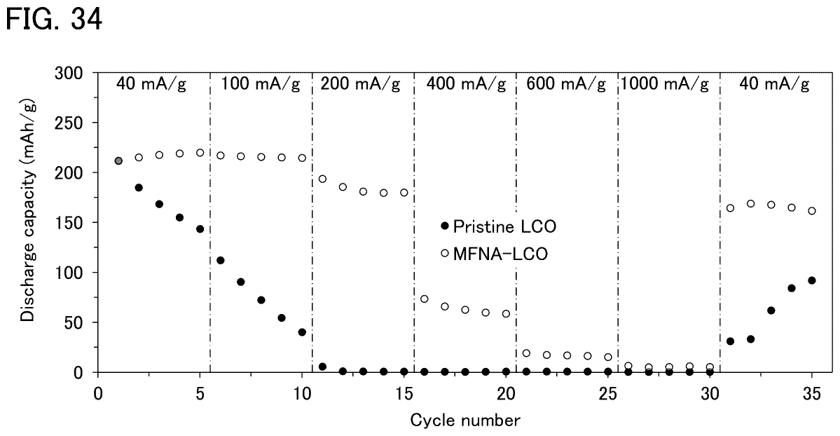

The charge/discharge curves in FIG. 33A show that the average discharge voltage of the positive electrode active material of one embodiment of the present invention remained high even after 100 cycles. Conversely, the average discharge voltage of the pristine LCO decreased with an increase in the voltage polarization. In addition, at each discharge rate, the positive electrode active material of one embodiment of the present invention demonstrated a superior rate performance relative to that of the pristine LCO. The positive electrode active material of one embodiment of the present invention underwent charging/discharging even with a high mass loading at a practical level (20 mg/cm²) as shown in FIG. 34. In FIG. 33B, the white circles indicate the discharge capacity of the positive electrode active material of one embodiment of the present invention, and the black squares indicate the discharge capacity of the pristine LCO.

The first charge/discharge cycles of the positive electrode active material of one embodiment of the present invention demonstrated a decrease in cell resistance and an increase in the discharge capacity. This phenomenon is attributed to the formation of a solid electrolyte interphase (SEI) on the surface of lithium cobalt oxide and the diffusion of magnesium into the lithium cobalt oxide structure.

A modified fluorinated electrolyte solution was applied instead of a commonly used electrolyte solution to fabricate half cells, with possible decomposition of the commonly used electrolyte solution at a high cut-off voltage of 4.7 V (versus Li+/Li) taken into account. To mitigate the impact of electrolyte solution decomposition, the cycling performance was evaluated with a high charge/discharge rate and a low mass-loading electrode.

FIG. 35A shows cycling performance of the half cells with the positive electrode including the positive electrode active material of one embodiment of the present invention and the positive electrode including the pristine LCO in the voltage range of 2.5 V to 4.7 V (versus Li+/Li); each half cell includes the fluorinated electrolyte solution. FIG. 35B shows charge/discharge curves of the pristine LCO and the positive electrode active material of one embodiment of the present invention at different cycles under the condition shown in FIG. 35A. The electrolyte solution contains 1 M LiPF₆ dissolved in FEC/MTFP (2:8 in volume ratio) with 5 wt % PS. The cycling performance tests were conducted with CCCV charging at 200 mA/g with a final current of 40 mA/g and CC discharging at 200 mA/g in the voltage range of 2.5 V to 4.7 V (versus Li+/Li). A rest period of 1 minute was allowed after each charging and discharging step. Each measurement was performed at 25° C.

This approach led to high-capacity retention of 88.5% (191.5 mAh/g) at 200 mA/g and a voltage range of 2.5 V to 4.7 V (versus Li+/Li) after 100 cycles as shown in FIGS. 35A and 35B.

The half cells were fabricated as follows. The LCO positive electrode was fabricated by mixing 95 wt % active material, 3 wt % carbon black (DENKA BLACK (registered trademark), Denka Co., Ltd.) as a conductive additive, and 2 wt % polyvinylidene fluoride as a binder. The weighed powders were mixed in N-methyl-1,2-pyrrolidone (NMP, 99.9%, Tokyo Chemical Industry Co., Ltd.) to produce a homogeneous slurry. The slurry was coated onto an aluminum foil current collector by using a doctor blade. The NMP solvent was dried at 80° C. for 0.5 hours in a forced convection drying oven. The mass loading of the active material was controlled to approximately 7 mg/cm², while the mass loading for FIGS. 33A and 33B and FIGS. 35A and 35B was controlled to approximately 20 mg/cm² and approximately 3 mg/cm², respectively. The coin-type half cells (CR2032) were assembled in an argon-filled glove box using the prepared positive electrode, the lithium metal foil (thickness of 0.6 mm, purity of 99.9%, Honjo Metal Co., Ltd.) as a counter electrode, polypropylene (PP) as a separator, and an electrolyte solution.

Two types of electrolyte solutions were used for the half cells: a commonly used electrolyte solution containing 1 M LiPF₆ dissolved in ethylene carbonate/diethyl carbonate (EC/DEC=3:7 in volume ratio) with 2 wt % vinylene carbonate (VC) as an additive, and a fluorinated electrolyte solution containing 1 M LiPF₆ dissolved in fluoroethylene carbonate/methyl 3,3,3-trifluoropropionate (FEC/MTFP, 2:8 in volume ratio) with 5 wt % 1,3-propanesultone (PS) as an additive. The commonly used electrolyte solution was employed unless otherwise noted.

The charge and discharge measurements were performed using a TOSCAT-3100 (TOYO SYSTEM Co., Ltd.) battery testing system and a temperature-controlled chamber at 25° C. The cycling performance tests for the half cells were conducted with constant current-constant voltage (CCCV) charging at 100 mA/g with a final current of 10 mA/g and constant current (CC) discharging at 100 mA/g in the voltage range of 2.5 V to 4.6 V or 2.5 V to 4.7 V (versus Li+/Li). The capacity retention after 100 cycles was calculated using the maximum discharge capacity obtained during the cycling test.

The discharge rate performance tests presented in FIG. 33B were conducted with constant current-constant voltage (CCCV) charging at 100 mA/g, using a final current of 10 mA/g and followed by CC discharging in the voltage range of 2.5 V to 4.7 V (versus Li+/Li). The CC discharge current varied every five cycles as follows: 40 mA/g, 100 mA/g, 200 mA/g, 400 mA/g, 600 mA/g, 1000 mA/g, 2000 mA/g, and 100 mA/g. A rest period of 10 minutes was allowed after each charging and discharging step.

For the experiment presented in FIG. 34, discharge rate performance tests were conducted with constant current-constant voltage (CCCV) charging at 40 mA/g, using a final current of 4 mA/g and followed by CC discharging in the voltage range of 2.5 V to 4.7 V (versus Li+/Li). The CC discharge current varied every five cycles as follows: 40 mA/g, 100 mA/g, 200 mA/g, 400 mA/g, 600 mA/g, 1000 mA/g, and 40 mA/g. A rest period of 10 minutes was allowed after each charging and discharging step.

### <<Full Cell>>

To evaluate electrochemical properties under more practical conditions, pouch-type full cells with the same configuration as a commercial product were fabricated using a positive electrode including the positive electrode active material of one embodiment of the present invention and a commercial graphite negative electrode.

The preparation of the positive electrode was identical to the preparation of the half cells. The negative electrode was formed using 96 wt % synthetic graphite (meso carbon micro beads (MCMB) graphite G10, Linyi Gelon Lib Co., Ltd.) as an active material, 1 wt % vapor-grown carbon nanofiber (VGCF (registered trademark)-H, Showa Denko Co., Ltd.) as a conductive additive, 1 wt % sodium carboxymethyl cellulose (CMC, Kishida Chemical Co., Ltd.) as a thickener, and 2 wt % styrene-butadiene rubber (SBR, TRD2001, JSR Corporation) as a binder.

The weighed powders of the negative electrode active material, the conductive additive, the thickener, and the binder were mixed with distilled water to produce a slurry, which was then coated onto a cupper-foil current collector. The positive electrode and negative electrode mass loading were 10.6 mg/cm² and 7.6 mg/cm², while their dimensions were 41 mm×50 mm and 45 mm×53 mm, respectively. The design of the cell was aimed at achieving a positive electrode-to-negative electrode capacity ratio of approximately 80% and a total cell capacity of 40 mAh with positive electrode and negative electrode capacities of 200 mAh/g and 300 mAh/g, respectively.

The assembly of the pouch-type full cells was conducted in an argon-filled glove box by using a stacking process. Single-side coated negative electrode and positive electrode sheets, a polypropylene separator (PP), and an electrolyte solution comprising 1 M LiPF₆ in FEC/MTFP (2:8 in volume ratio) were used in this process.

The cycling performance tests of the full cells fabricated as described above were conducted with CCCV charging (40 mA/g, a final current of 4 mA/g) and CC discharging (40 mA/g) in the voltage range of 3.0 V to 4.5 V or 3.0 V to 4.6 V (versus graphite). A rest period of 1 minute was allowed after each charging and discharging step.

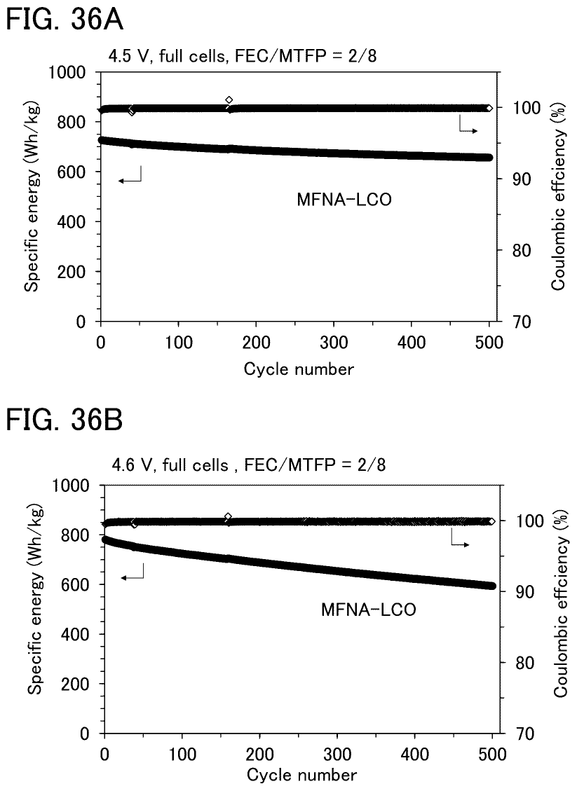

FIGS. 36A and 36B show electrochemical performance of the pouch-type full cells at 25° C. FIGS. 36A and 36B show cycling performance of the pouch-type full cells with the positive electrodes including the positive electrode active material of one embodiment of the present invention; the voltage range is 3.0 V to 4.5 V (versus graphite) in FIG. 36A and 3.0 V to 4.6 V (versus graphite) in FIG. 36B.

Each full cell's energy density retention after 500 cycles at 25° C. was 90.3% (656.8 Wh/kg) and 75.8% (593.4 Wh/kg) in the voltage range of 3.0 V to 4.5 V and 3.0 V to 4.6 V (versus graphite), respectively. The full cells using the positive electrode active material of one embodiment of the present invention show significantly more stable cycling performance in consideration of the previous studies (e.g., Non-Patent Documents 7, 12, and 17) on doping and coating for LCO at high voltage.

<Analysis of Positive Electrode Active Material of One Embodiment of the Present Invention and Pristine LCO after Cycling Tests>

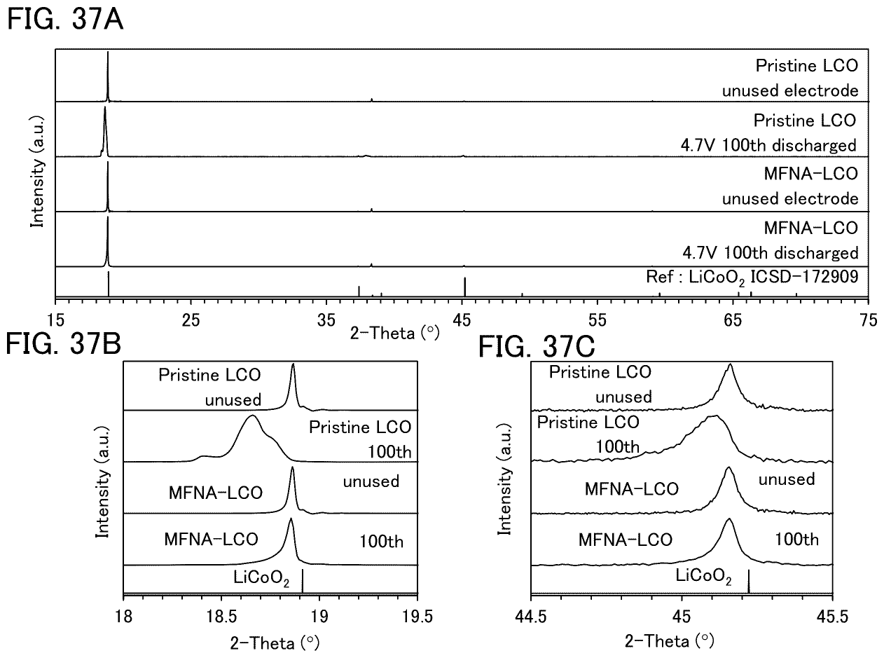

FIG. 37A shows ex situ XRD patterns of the positive electrodes with the pristine LCO and the positive electrode active material of one embodiment of the present invention in a discharged state after 100 cycles. FIG. 37B shows an enlarged view in the 2θ range of 18° to 19.5°, and FIG. 37C shows an enlarged view in the 2θ range of 44.5° to 45.5°.

For the measurements of the pristine LCO and the positive electrode active material of one embodiment of the present invention in FIGS. 37A to 37C, the coin-type half cells with commonly used electrolyte solutions were employed. For the ex situ XRD of the positive electrodes with the pristine LCO and the positive electrode active material of one embodiment of the present invention in a discharged state after 100 cycles, the cells were cycled using CCCV charging (40 mA/g, a final current of 10 mA/g) and CC discharging (40 mA/g) in the voltage range of 2.5 V to 4.7 V (versus Li+/Li).

The XRD measurements were conducted using a Bruker D8 ADVANCE diffractometer with Cu Kα (2=1.5406 Å). Powder samples were analyzed within the 15°-90° scan range (2θ) with a 0.005° step width and a scan speed of 0.1 sec/step. Rietveld refinement was performed using DIFFRAC TOPAS V6 software (Bruker). The later described ex situ XRD measurements were also performed under similar conditions.

As shown in FIGS. 37A to 37C, the ex situ XRD patterns of the pristine LCO in a discharged state after 100 cycles showed broad XRD peaks, indicating low crystallinity.

The XRD patterns shown in FIGS. 37A to 37C are patterns from which the background and a peak derived from Cu Kα₂ were eliminated using DIFFRAC. EVA. The background was eliminated under conditions with a curvature of 25 and a threshold of 1e⁻⁵.

It is known that 003 of lithium cobalt oxide exhibits a peak at 2θ of around 19° (within the range of 18° to 19.5°). The half width of the 003 peak of the pristine LCO (a half width refers to a full width at half maximum unless otherwise specified in this specification and the like) was 0.0325° before the charge/discharge cycling test, but was greatly broadened to 0.1836° after the charge/discharge cycling test for 100 cycles and shifted to the lower-angle side. It is also known that 104 of lithium cobalt oxide exhibits a peak at 2θ of around 45° (within the range of 44.5° to) 45.5°. The half width of the 104 peak of the pristine LCO was 0.0644° before the charge/discharge cycling test, but was also broadened to 0.1594° after a similar test.

By contrast, the positive electrode active material of one embodiment of the present invention displayed sharp peaks, indicating that its high crystallinity was maintained after 100 cycles. The half width of the 003 peak of the positive electrode active material of one embodiment of the present invention was 0.0333° before the charge/discharge cycling test, and was less than or equal to 0.10° or specifically, 0.0515°, which means that the peak is sufficiently sharp even after the charge/discharge cycling test for 100 cycles. The half width of the 104 peak was 0.0636° before the charge/discharge cycling test, and was less than or equal to 0.11° or specifically, 0.0646°, which means that the peak is sufficiently sharp even after a similar test.

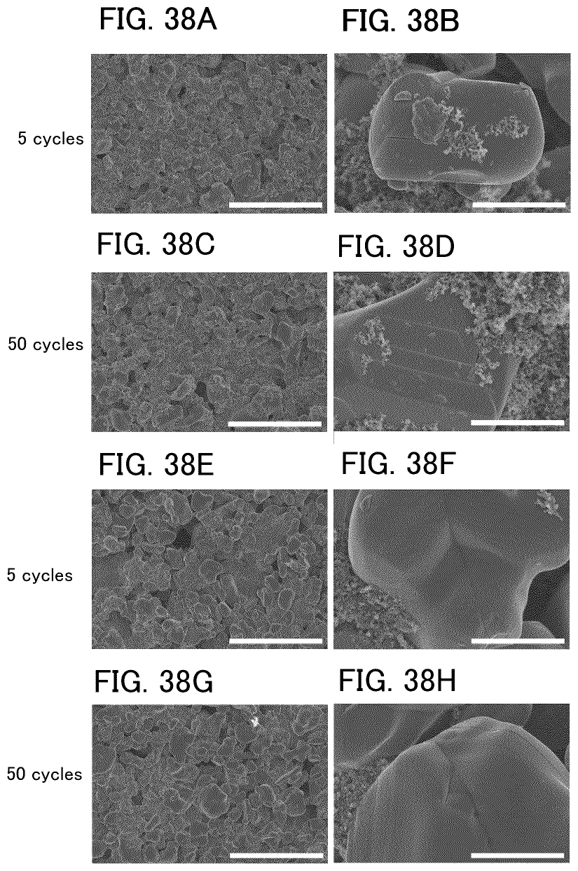

FIGS. 38A to 38H show SEM images of the pristine LCO and the positive electrode active material of one embodiment of the present invention in a discharge state after cycling. FIGS. 38A and 38B show the SEM images of the pristine LCO after 5 cycles, and FIGS. 38C and 38D show the SEM images of the pristine LCO after 50 cycles. FIGS. 38E and 38F show the SEM images of the positive electrode active material of one embodiment of the present invention after 5 cycles, and FIGS. 38G and 38H show the SEM images of the positive electrode active material of one embodiment of the present invention after 50 cycles. FIG. 39A shows cycling performance of the pristine LCO and the positive electrode active material of one embodiment of the present invention at a voltage range of 2.5 V to 4.7 V (versus Li+/Li) at 25° C. for the SEM images after 5 cycles. FIG. 39B shows cycling performance of the pristine LCO and the positive electrode active material of one embodiment of the present invention at a voltage range of 2.5 V to 4.7 V (versus Li⁺/Li) at 25° C. for the SEM images after 50 cycles. The scale bars in FIG. 38A, FIG. 38C, FIG. 38E, and FIG. 38G each represent 50 μm, and those in FIG. 38B, FIG. 38D, FIG. 38F, and FIG. 38H each represent 5 μm. In FIGS. 39A and 39B, Coulomb efficiencies for measurement points with a discharge capacity less than 10 mAh/g are not plotted.

As shown in FIGS. 38A to 38D, in the SEM observation of the pristine LCO in a discharged state after 5 cycles of the cycling test, the pristine LCO exhibited a small number of cracks, which were clearly observed particularly around grain boundaries. In the pristine LCO in a discharged state after 50 cycles, cracks increased and became larger. In the positive electrode active material of one embodiment of the present invention, no crack was observed in the discharged state after 5 cycles, and a very few small cracks were observed in the discharged state after 50 cycles.

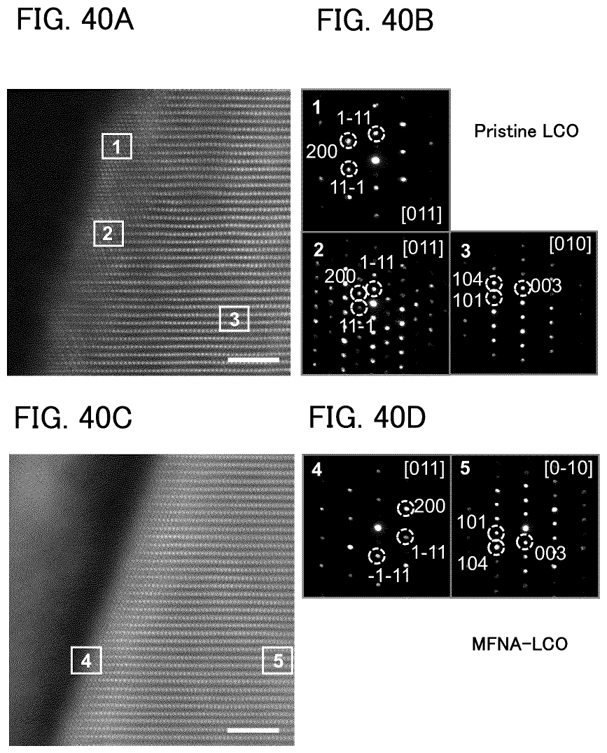

In addition, HAADF-STEM images and NBED patterns of the pristine LCO and the positive electrode active material of one embodiment of the present invention after 50 cycles in the voltage range of 2.5 V to 4.7 V were obtained. FIG. 40A shows the HAADF-STEM image of the pristine LCO particle surface portion, and FIG. 40B shows the NBED patterns of the marked areas 1 to 3 in FIG. 40A. The area 1 exhibits a pattern indicating a rock salt crystal structure, the area 2 exhibits a pattern indicating a spinel crystal structure, and the area 3 exhibits a pattern indicating a layered rock salt crystal structure.

FIG. 40C shows the HAADF-STEM image of the surface portion of a particle of the positive electrode active material of one embodiment of the present invention, and FIG. 40D shows the NBED patterns of the marked areas 4 and 5 in FIG. 40C. The area 4 exhibits a pattern indicating a rock salt crystal structure, and the area 5 exhibits a pattern indicating a layered rock salt crystal structure. The scale bars in FIGS. 40A and 40C each represent 3 nm.

FIG. 40B demonstrates the formation of an approximately 3-nm-thick spinel and rock salt phases in the surface portion of the pristine LCO. Importantly, even after 50 cycles, the outermost surface of the positive electrode active material of one embodiment of the present invention maintained its approximately 1-nm-thick, rock salt structure, as shown in FIGS. 40C and 40D.

The formation of spinel and then rock salt phases in the degraded surface portion of the pristine LCO is attributed to the release of oxygen from the LCO surface. However, due to the high concentrations of magnesium, nickel, and aluminum on the surface layer of the positive electrode active material of one embodiment of the present invention, the release of oxygen from the LCO surface was inhibited under highly delithiated conditions; thus, the formation of the spinel region was impeded.

### <Analysis of Crystal Structure of Positive Electrode Active Material of One Embodiment of the Present Invention in Highly Delithiated State>

### <<Ex-Situ XRD>>

To unveil the mechanism of performance improvement, structural analysis during the high-voltage cycles was conducted.

It is known that typically, LCO undergoes a phase transition from the O3 phase to the H1-3 phase upon charging up to 4.55 V (x<0.3 in LiₓCoO₂). This structural change reduces the capacity retention of LCO at high voltages. Considering that the excellent electrochemical performances of the positive electrode active material of one embodiment of the present invention at high voltage could be strongly correlated to the inhibition of this phase transition, ex situ XRD measurements were performed on the charged positive electrodes extracted from half cells.

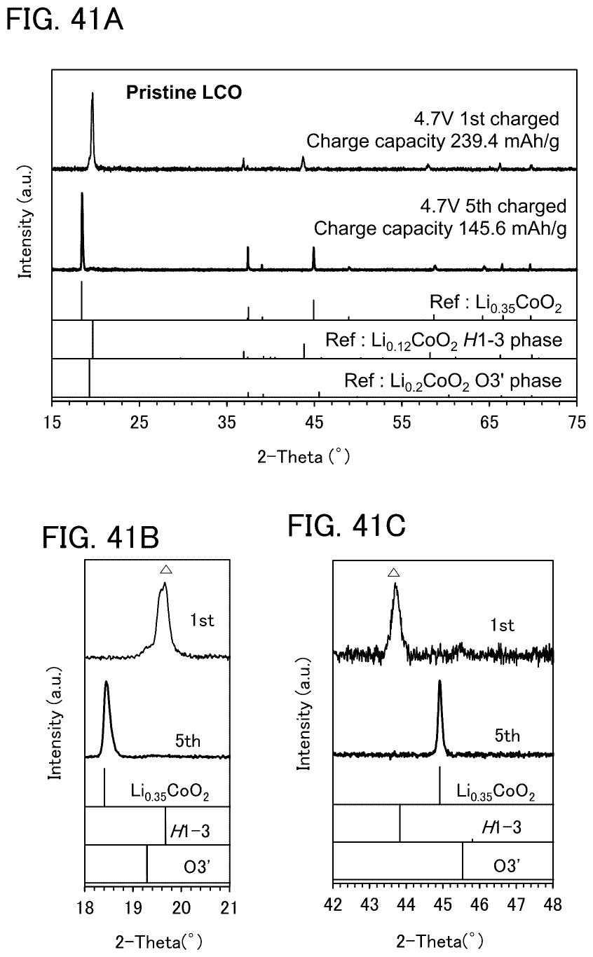

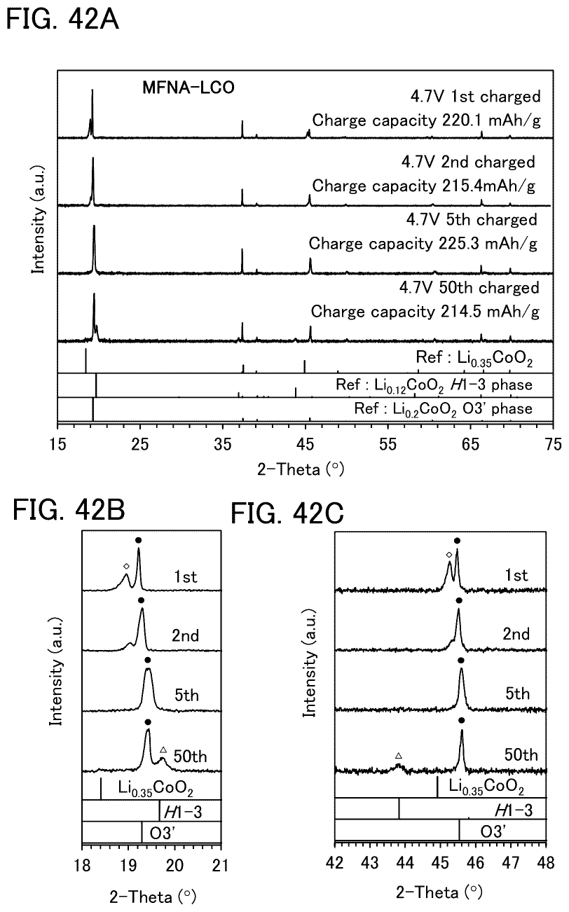

FIGS. 41A to 41C and FIGS. 42A to 42C show ex situ XRD patterns of positive electrodes with the pristine LCO and the positive electrode active material of one embodiment of the present invention at different cycles. FIG. 41A shows ex situ XRD patterns of the pristine LCO in the first and fifth charged states up to 4.7 V, FIG. 41B shows an enlarged view within the 2θ range of 18° to 21°, and FIG. 41C shows an enlarged view within the 2θ range of 42° to 48°. FIG. 42A shows ex situ XRD patterns of the positive electrode active material of one embodiment of the present invention in the first, second, fifth, and fiftieth charged states up to 4.7 V, FIG. 42B shows an enlarged view within the 2θ range of 18° to 21°, and FIG. 42C shows an enlarged view within the 2θ range of 42° to 48°. The reference XRD patterns of Li_{0.35}CoO₂ O3 phase (Non-Patent Document 18 and ICSD collection code 172912), Li_{0.12}CoO₂ H1-3 phase (Non-Patent Document 19), and the O3′ phase described in this specification and the like are also shown. In FIGS. 41A to 41C, FIGS. 42A to 42C, FIGS. 43A to 43C, and FIGS. 44A to 44C, rhombi (⋄) indicate peaks derived from the conventional delithiated O3 phase, triangles (Δ) indicate peaks derived from the H1-3 phase, and dots (•) indicate peaks derived from the O3′ phase.

To perform the ex situ XRD measurements in FIGS. 41A to 41C, FIGS. 42A to 42C, FIGS. 43A to 43C, and FIGS. 44A to 44C, the coin-type half cells with commonly used electrolyte solutions were employed. For the positive electrodes with the pristine LCO and the positive electrode active material of one embodiment of the present invention in FIGS. 41A to 41C and FIGS. 42A to 42C, in the first, second, fifth, or fiftieth charging, the cells were charged with CC (10 mA/g) up to 4.7 V before the ex situ XRD measurements. Before the second, fifth, or fiftieth charging, the cells were cycled 1, 4, or 49 times using CCCV charging (100 mA/g, a final current of 10 mA/g), and CC discharging (100 mA/g) in the voltage range of 2.5 V to 4.7 V (versus Li⁺/Li).

In an argon-filled glove box, the positive electrode sheets of the charged or discharged cells were extracted and prepared for ex situ XRD measurements. The positive electrode sheets were washed with dimethyl carbonate to remove the electrolyte solution, dried, and then fixed on a flat glass substrate with a double-sided tape. These samples were enclosed in an airtight specimen holder (Part No: A100B33) in the argon glove box. XRD measurements were performed in an argon atmosphere within the scan range of 15° to 75° (2θ) with a 0.01° step width and a scan speed of 1.0 sec/step.

As shown in FIGS. 41A to 41C, when the first charging of the pristine LCO at 4.7 V resulted in a charge capacity of 239.4 mAh/g and Li concentration (LiₓCoO₂) of x=0.13, the H1-3 phase formation was confirmed through ex situ XRD.

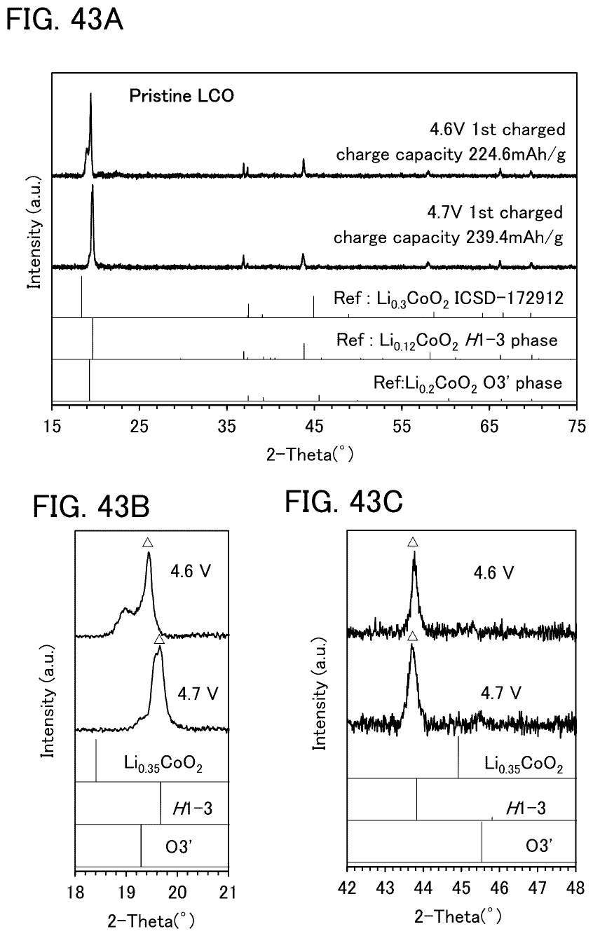

FIGS. 43A to 43C show ex situ XRD patterns of the positive electrodes with the pristine LCO in the charged states up to 4.6 V and 4.7 V. FIG. 43A shows ex situ XRD patterns of the positive electrodes with the pristine LCO in the first charging up to 4.6 V and 4.7 V, at 10 mA/g. FIG. 43B shows an enlarged view within the 2θ range of 18° to 21°. FIG. 43C shows an enlarged view within the 2θ range of 42° to 48°.

As shown in FIGS. 43A to 43C, even when the first charging was up to 4.6 V, resulting in a lower charge capacity of 224.6 mAh/g (x=0.18 in LiₓCoO₂), the H1-3 phase was formed.

As shown in FIGS. 41A to 41C, in the fifth charged sample at 4.7 V, the surface portion of the pristine LCO was likely to be damaged by exposing to the high voltage, and the damaged surface made lithium diffusion difficult, resulting in the charge capacity of 145.6 mAh/g (x=0.47). Because the pristine LCO severely suffers from degradation of reversibility, the phase transitions from the O3 phase to the H1-3 phase at x<0.3 in LiₓCoO₂ were not observed.

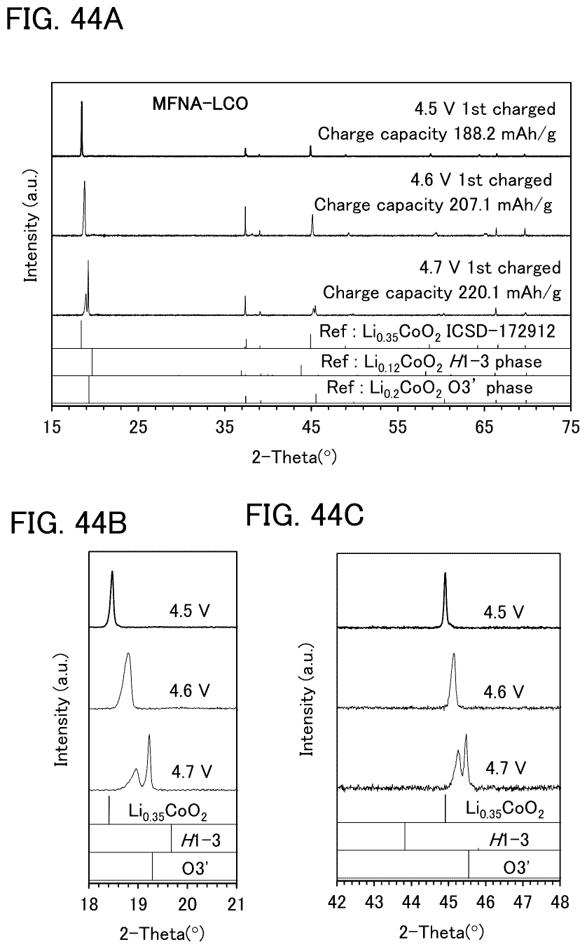

FIGS. 42A to 42C show ex situ XRD patterns of the positive electrodes with the positive electrode active material of one embodiment of the present invention. FIG. 42A shows ex situ XRD patterns of the positive electrode active material of one embodiment of the present invention in the first, second, fifth, and fiftieth charged states up to 4.7 V, FIG. 42B shows an enlarged view within the 2θ range of 18° to 21°, and FIG. 42C shows an enlarged view within the 2θ range of 42° to 48°. FIGS. 44A to 44C show ex situ XRD patterns of the positive electrodes including the positive electrode active material of one embodiment of the present invention in the charged states up to 4.5 V, 4.6 V, and 4.7 V.

FIGS. 42A to 42C show the ex situ XRD patterns of the positive electrodes including the positive electrode active material of one embodiment of the present invention during the first charging up to 4.7 V, which corresponds to a charge capacity of 220.1 mAh/g (x=0.20 in LiₓCoO₂). Surprisingly, the ex situ XRD patterns of the positive electrode active material of one embodiment of the present invention, charged to 4.7 V, show a superposition of diffraction patterns from two O3 phases, while the diffraction pattern corresponding to the H1-3 phase is absent.

The diffraction pattern of the first O3 phase exhibits peaks at 20=19.0° and 45.3° on the lower-angle side, while the diffraction pattern of the second O3 phase shows peaks at 20=19.2° and 45.5° on the higher-angle side. The first O3 phase corresponds to the conventional delithiated O3 phase. This classification is based on the continuous shift of diffraction peaks from 4.5 V to 4.7 V in the charged state as shown in FIGS. 44A to 44C. FIG. 44A shows ex situ XRD patterns of the positive electrodes with the positive electrode active material of one embodiment of the present invention charged up to 4.5 V, 4.6 V, and 4.7 V, at 10 mA/g. FIG. 44B shows an enlarged view within the 2θ range of 18° to 21°. FIG. 44C shows an enlarged view within the 2θ range of 42° to 48°.

The second O3 phase is considered a different phase with a smaller unit cell volume and identical symmetry to the O3 phase. In this specification and the like, this phase is referred to as “O3′ phase”.

The charge capacity of the second charging was 215.4 mAh/g (x=0.21 in LiₓCoO₂), which was slightly smaller than that of the first charging. In the second charging, the area intensity ratio of the diffraction peaks associated with the O3′ phase increased and peak positions shifted to the higher-angle side. The shift of peaks to the higher-angle side indicates a reduction in the unit cell volume, suggesting a decrease in the lithium concentration in lithium cobalt oxide. This is inconsistent with the lithium concentrations in the first and second charging estimated from the electrochemically observed capacities (first: x=0.20, second: x=0.21). Notably, during the first charging, the charge may be consumed not only by lithium extraction but also by electrolyte solution decomposition accompanied with SEI formation which can be confirmed from Coulombic efficiency.

Therefore, in the first charging, the actual lithium concentration is considered to be higher than the lithium concentration estimated from the capacity (x=0.20), and probably higher than the actual lithium concentration of the second charging. After conducting the fifth charging with a capacity of 225.3 mAh/g (x=0.18), the O3′ phase emerged as the single phase, and the diffraction peaks shifted to higher angles, as the charge capacity increased from the second charging.

The O3′ phase remained after the fiftieth charging with a capacity of 214.5 mAh/g (x=0.22), although weak diffraction peaks, associated with the H1-3 phase, were detected.

<<dQ/dV Curve>>

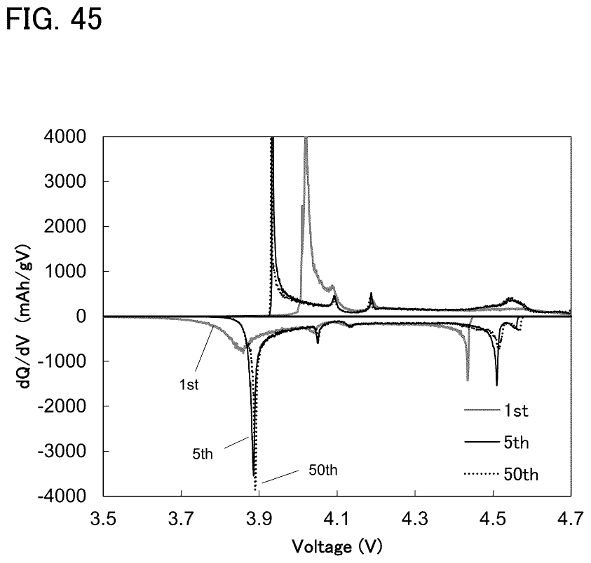

FIG. 45 shows dQ/dV curves of the positive electrode active material of one embodiment of the present invention at the first, fifth, and fiftieth cycles. Half cells were used to measure dQ/dV in a voltage range of 2.5 V to 4.7 V with a current of 10 mA/g at 25° C. Before the fifth or fiftieth dQ/dV measurement, the cells were cycled 4 or 49 times using CCCV charging (100 mA/g, a final current of 10 mA/g) and CC discharging (at 100 mA/g), respectively, in the voltage range of 2.5 V to 4.7 V (versus Li⁺/Li) at 25° C. A rest period of 10 minutes was allowed after each charging and discharging step. Large voltage polarization was observed in the first cycle, which is consistent with the first-cycle low capacity in the cycling performance tests. The voltage polarization became smaller at the fifth cycle and remained small at the fiftieth cycle. The dQ/dV curves of the positive electrode active material of one embodiment of the present invention display reversible peaks at voltages above 4.5 V during the fifth and fiftieth charging/discharging at 25° C.

As shown in FIG. 45, the dQ/dV curves of the positive electrode active material of one embodiment of the present invention display reversible peaks at voltages above 4.5 V during the charging/discharging, indicating the sustained reversibility of the phase transition from the 03 phase to the O3′ phase.

### <<Rietveld Refinement>

The lattice parameters of the O3′ phase were determined using the Rietveld refinement of the XRD pattern from the first and fifth charging cycles, as detailed in Tables 7 and 8. Compared to the reported values in previous studies for highly delithiated O3 phases (Non-Patent Document 18 and the like), the c lattice parameter of the positive electrode active material of one embodiment of the present invention is significantly smaller.

TABLE 7
Positive electrode active material of one embodiment of the present invention 4.7 V 1st charging
charge capacity 220.1 mAh/g LiₓCoO₂ (x = 0.20)

| | 1st phase (O3) 58.6% | | | | | 2nd phase (O3′) 41.4% | | | | | |
|---|---|---|---|---|---|---|---|---|---|---|---|
| | Space group R3̅m | | | | | Space group R3̅m | | | | | |
| | | x | y | z | Occ. | | | x | y | z | Occ. |
| Li | 3a | 0 | 0 | 0 | 0.20 | Li | 3a | 0 | 0 | 0 | 0.20 |
| Co | 3b | 0 | 0 | 0.5 | 1 | Co | 3b | 0 | 0 | 0.5 | 1 |
| O | 6c | 0 | 0 | 0.223(6) | 1 | O | 6c | 0 | 0 | 0.210(8) | 1 |
| | a-axis/Å | | | 2.813(9) | | | a-axis/Å | | | 2.814(7) | |
| | c-axis/Å | | | 13.994(7) | | | c-axis/Å | | | 13.791(5) | |
| | Volume/Å³ | | | 95.967(1) | | | Volume/Å³ | | | 94.627(1) | |
| | | | | R_{wp} | | | 1.44 | | | | |
| | | | | Rₚ | | | 1.01 | | | | |
| | | | | GOF | | | 1.58 | | | | |

TABLE 8
Positive electrode active material of one embodiment
of the present invention 4.7 V 5th charging
charge capacity 225.3 mAh/g LiₓCoO₂ (x = 0.18)

R3̅m

| | | | | |
|---|---|---|---|---|
| Space group | x | y | z | Occ. |

| | | | | | |
|---|---|---|---|---|---|
| Li | 3a | 0 | 0 | 0 | 0.18 |
| Co | 3b | 0 | 0 | 0.5 | 1 |
| O | 6c | 0 | 0 | 0.217(7) | 1 |

| | |
|---|---|
| a -axis/A | 2.818(6) |
| c-axis/Å | 13.666(3) |
| Volume/Å³ | 94.028(1) |
| R_{wp} | 1.63 |
| Rₚ | 1.08 |
| GOF | 1.86 |

The equivalent isotropic temperature factors (B_{eq}) used for the Rietveld refinement were constant values: Li=1.105; Co=0.371; and O=0.552. The charge capacity before the ex situ XRD measurement was used to calculate the site occupancy of Li ions. The site occupancy factors for O and Co ions were set to 1.

### <<Splitting Added Element Conditions>>

The hypothesis in this specification and the like postulates that the pillar effect of magnesium in the positive electrode active material of one embodiment of the present invention inhibits the gliding of CoO₂ slabs. To validate this hypothesis, the cycling performance of the positive electrodes including M-LCO, MF-LCO, FA-LCO, FN-LCO, FNA-LCO, and the positive electrode active material of one embodiment of the present invention was evaluated in combination with the ex situ XRD measurements for highly charged states.

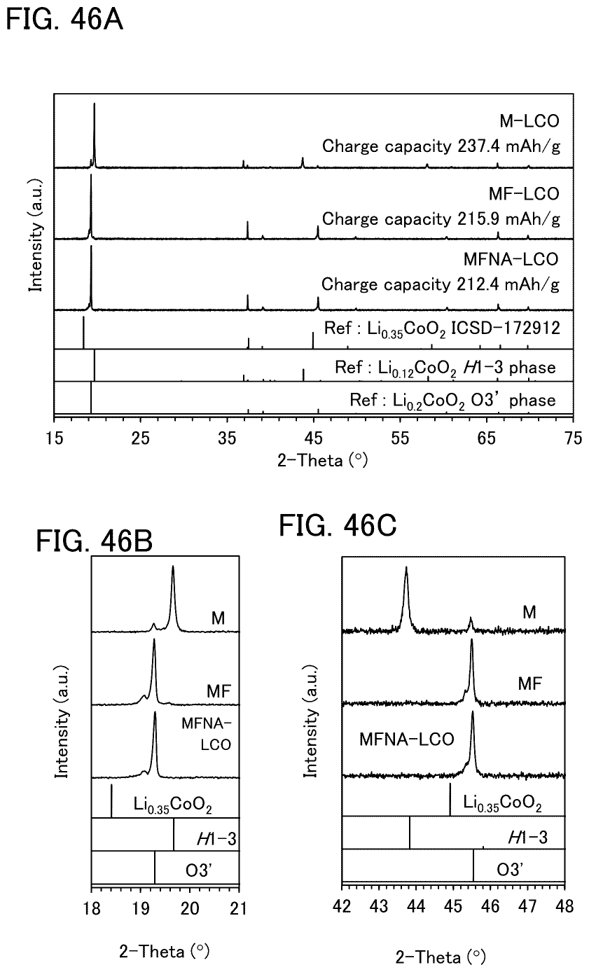

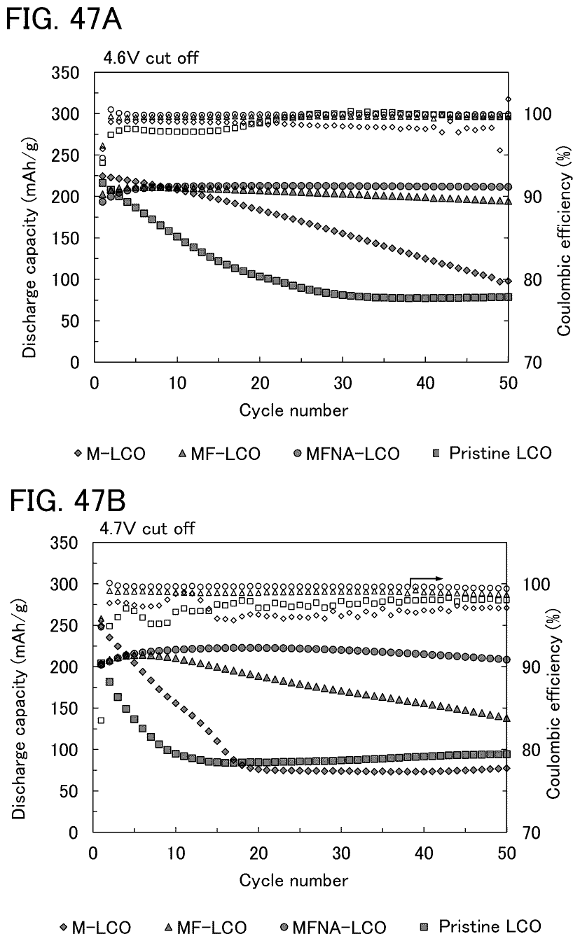

FIGS. 46A to 46C and FIGS. 47A and 47B show ex situ XRD patterns and cycling performance of M-LCO, MF-LCO, and the positive electrode active material of one embodiment of the present invention. FIG. 46A shows the ex situ XRD patterns of the positive electrodes with M-LCO, MF-LCO, and the positive electrode active material of one embodiment of the present invention charged up to 4.6 V at 4 mA/g. FIG. 46B shows an enlarged view in the 2θ range of 18° to 21°, and FIG. 46C shows an enlarged view in the 2θ range of 42° to 48°. FIG. 47A shows the cycling performance at a voltage range of 2.5 V to 4.6 V (versus Li⁺/Li) at 25° C., and FIG. 47B shows the cycling performance at a voltage range of 2.5 V to 4.7 V (versus Li⁺/Li) at 25° C.

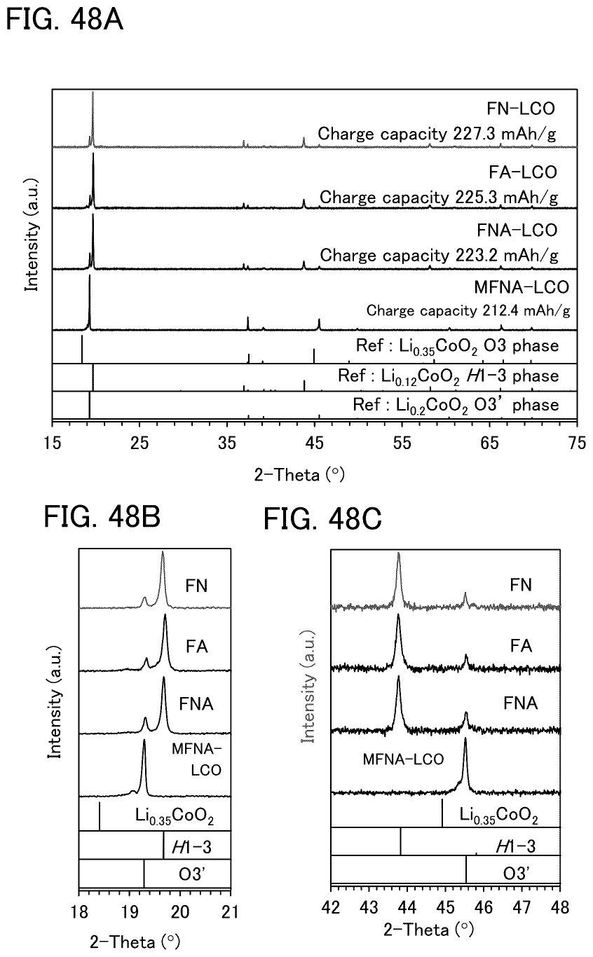

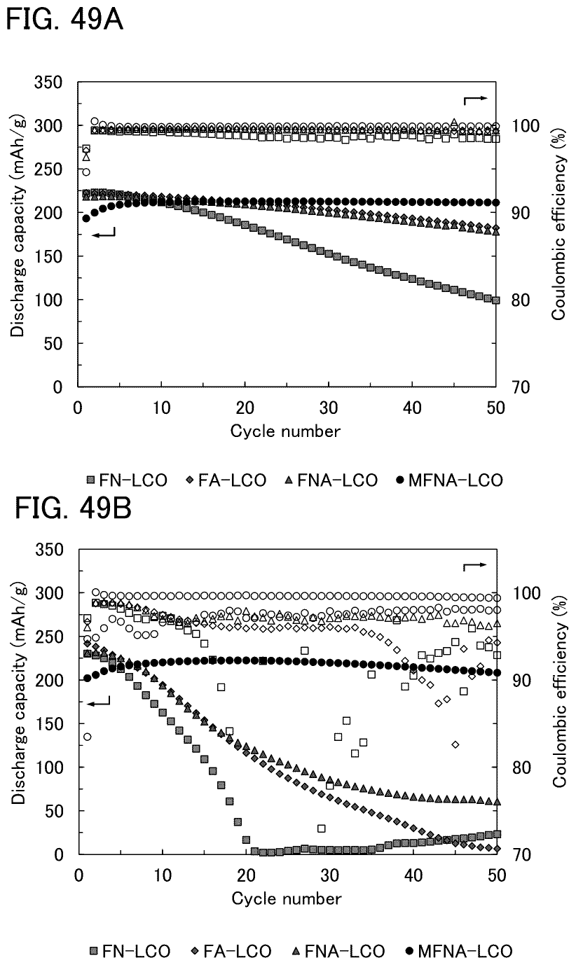

FIGS. 48A to 48C and FIGS. 49A and 49B show ex situ XRD patterns and cycling performance of FN-LCO, FA-LCO, FNA-LCO, and the positive electrode active material of one embodiment of the present invention. FIG. 48A shows the ex situ XRD patterns of the positive electrodes with FN-LCO, FA-LCO, FNA-LCO, and the positive electrode active material of one embodiment of the present invention charged up to 4.6 V at 4 mA/g. FIG. 48B shows an enlarged view in the 2θ range of 18° to 21°, and FIG. 48C shows an enlarged view in the 2θ range of 42° to 48°. FIG. 49A shows the cycling performance in the voltage range of 2.5 V to 4.6 V (versus Li⁺/Li) at 25° C., and FIG. 49B shows the cycling performance in the voltage range of 2.5 V to 4.7 V (versus Li⁺/Li) at 25° C. In FIGS. 47A and 47B, FIGS. 49A and 49B, FIGS. 50A and 50B, FIGS. 51A and 51B, and FIGS. 52A and 52B, the filled markers indicate discharge capacity, and the outline markers indicate Coulomb efficiency. Coulomb efficiencies for measurement points with a discharge capacity less than 25 mAh/g are not plotted.

For ex situ XRD measurements of the positive electrodes including M-LCO, MF-LCO, FN-LCO, FA-LCO, FNA-LCO, and the positive electrode active material of one embodiment of the present invention, the cells were cycled once using CCCV charging (40 mA/g, a final current of 10 mA/g) and CC discharging (40 mA/g) in the voltage range of 2.5 V to 4.5 V (versus Li⁺/Li). The cells were charged with CC (4 mA/g) up to 4.6 V before the ex situ XRD measurements.

Only MF-LCO and the positive electrode active material of one embodiment of the present invention exhibited high cycling performance and did not show the H1-3 phase. The formation of the O3′ phase hence results from the introduction of magnesium through treatment with molten fluoride salts.

The cycling performances of heated LCO, F-LCO, FNA-LCO, and NA-LCO were measured to examine the effect of LiF only.

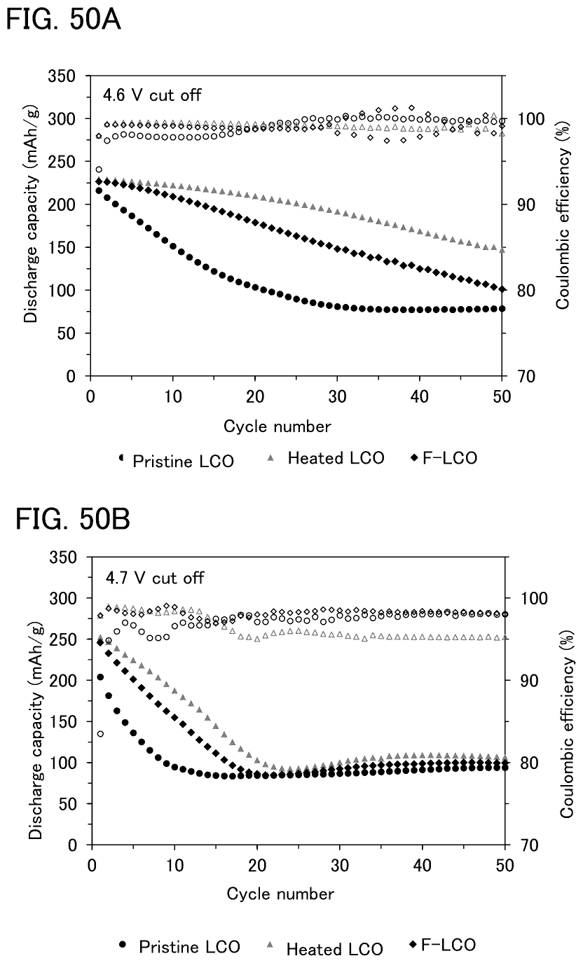

FIG. 50A shows the cycling performance of the pristine LCO, heated LCO, and F-LCO in the voltage range of 2.5 V to 4.6 V (versus Li⁺/Li) at 25° C., and FIG. 50B shows the cycling performance thereof in the voltage range of 2.5 V to 4.7 V (versus Li⁺/Li) at 25° C.

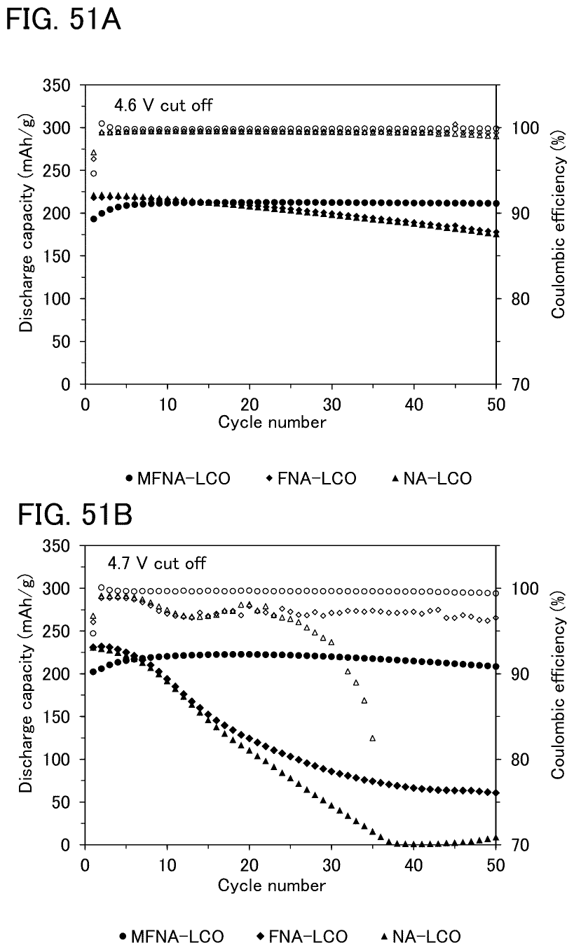

FIG. 51A shows the cycling performance of NA-LCO, FNA-LCO, and the positive electrode active material of one embodiment of the present invention in the voltage range of 2.5 V to 4.6 V (versus Li⁺/Li) at 25° C., and FIG. 51B shows the cycling performance thereof in the voltage range of 2.5 V to 4.7 V (versus Li⁺/Li) at 25° C. Coulomb efficiencies for measurement points with a discharge capacity less than 25 mAh/g are not plotted.

As shown in FIGS. 50A and 50B and FIGS. 51A and 51B, the addition of LiF, without MgF₂, did not lead to drastic improvement in charge/discharge cycling performances.

As shown in FIG. 6, in a highly delithiated state, the presence of magnesium substituted in the lithium layer provides structural support, preventing the gliding of the CoO₂ slabs and the phase transition from the O3 phase to the H1-3 phase. Furthermore, gliding is probably initiated at the surface of LCO and hence could be suppressed by the presence of the magnesium-rich rock salt region in the surface portion of the positive electrode active material of one embodiment of the present invention. Due to inhibited gliding, the surface portion of the positive electrode active material of one embodiment of the present invention was less likely to deteriorate after cycling, as shown in the SEM images (FIGS. 38E to 38H) and STEM image (FIG. 40C). Consequently, lithium diffusion was not inhibited in the positive electrode active material of one embodiment of the present invention, allowing it to potentially exhibit excellent rate and cycling performances.

MFN-LCO and MFA-LCO were synthesized using a procedure similar to that of the positive electrode active material of one embodiment of the present invention by adding MgF₂—LiF—Ni(OH)₂ and MgF₂—LiF—Al(OH)₃, respectively.

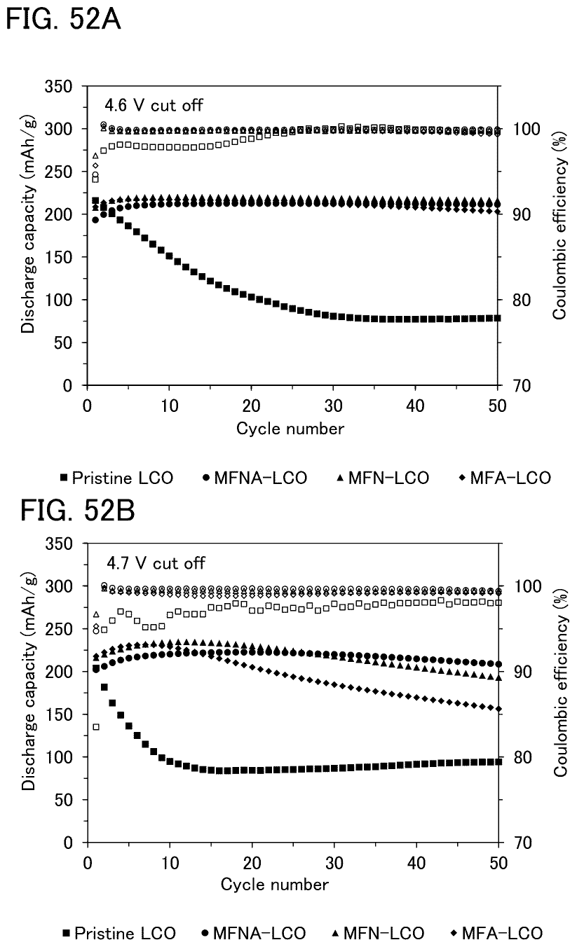

FIG. 52A shows the cycling performance of pristine LCO, MFN-LCO, MFA-LCO, and the positive electrode active material of one embodiment of the present invention in the voltage range of 2.5 V to 4.6 V (versus Li⁺/Li) at 25° C., and FIG. 52B shows the cycling performance thereof in the voltage range of 2.5 V to 4.7 V (versus Li⁺/Li) at 25° C.

As shown in FIGS. 52A and 52B, the sample that includes both nickel and aluminum together with magnesium and fluorine exhibited the highest capacity retention. This is attributed to the fact that the positive electrode active material of one embodiment of the present invention exhibits very high Coulomb efficiencies (e.g., 99.79%, 99.48%, and 99.34% for the positive electrode active material of one embodiment of the present invention, MFN-LCO, and MFA-LCO, respectively, when compared in the third cycle with a cut-off voltage of 4.7 V).

As described above, in this specification and the like, the diffusion and doping of magnesium from the surface of LCO particles into the bulk were achieved using molten fluoride salt as a reaction accelerator. In addition, the excess magnesium covered the surface portion of particles of the positive electrode active material of one embodiment of the present invention. This innovative invention effectively prevented the harmful phase transition to the H1-3 phase, particularly at a charge voltage of 4.7 V.

Additionally, the ex situ XRD analysis of the positive electrode active material of one embodiment of the present invention at 4.7 V revealed the formation of a different O3 phase (O3′ phase). The inhibition of phase transition to the H1-3 phase by this surface treatment and magnesium doping suppressed crystallinity degradation and cracking after cycling with a cut-off voltage of 4.7 V.

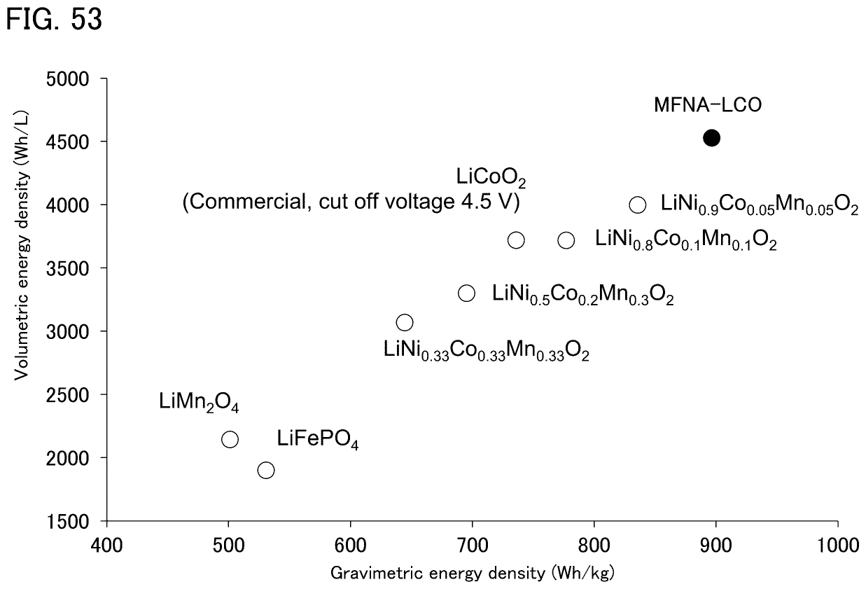

The Ragone plot presented in FIG. 53 demonstrates that the positive electrode active material of one embodiment of the present invention has the highest energy density among practical positive electrode materials. Therefore, the positive electrode active material of one embodiment of the present invention has the potential to significantly impact the field of high-energy density batteries, thereby contributing to the advancement of mobile electronics.

In this specification and the like, valuable insight into the basic mechanism of phase transition by cation insertion/extraction is also provided. These findings could be also applied to other positive electrode materials whose degradation is caused by phase transition.

### Example 2

In this example, half cells were manufactured under conditions partly different from those in Example 1, using the positive electrode active material of one embodiment of the present invention fabricated in a manner similar to that in Example 1. The half cells underwent charge/discharge tests under conditions partly different from those in Example 1. The crystal structure was analyzed by ex situ XRD.

### <<Half Cell>>

The LCO positive electrode was fabricated by mixing 96 wt % active material, 2 wt % carbon black (DENKA BLACK (registered trademark), Denka Co., Ltd.) as a conductive additive, and 2 wt % polyvinylidene fluoride as a binder. At this time, pressing was performed with a roller press machine to increase the density of the positive electrode active material layer over the positive electrode current collector. The conditions of the pressing were as follows: the first pressing (linear pressure: 210 kN/m) was followed by the second pressing (linear pressure: 1467 kN/m). Note that the temperature of each of an upper roll and a lower roll of the roller press machine was 120° C. The mass loading of the active material was approximately 14.5 mg/cm². The electrode density was approximately 3.9 g/cm³.

An electrolyte solution containing 1 M LiPF₆ dissolved in ethylene carbonate/diethyl carbonate (EC/DEC=3:7 in volume ratio) with 2 wt % vinylene carbonate (VC) was used.

Except for the above conditions, the half cells were fabricated in a manner similar to that in Example 1.

### <<Charge/Discharge Test>>

Charge/discharge tests were performed on the half cells that were fabricated as described above. A discharge rate test and a charge/discharge cycling test were successively performed in this order.

The conditions of the discharge rate test are described. In the first charge/discharge cycle, constant current charging at 0.2 C was performed up to approximately 4.6 V, constant voltage charging was performed until the current value reached 0.05 C, and then, constant current discharging at 0.2 C was performed up to 3.0 V. In the second charge/discharge cycle, constant current charging at 0.5 C was performed up to approximately 4.6 V, constant voltage charging was performed until the current value reached 0.05 C, and then, constant current discharging at 0.1 C was performed up to 3.0 V. In the third charge/discharge cycle, constant current charging at 0.5 C was performed up to approximately 4.6 V, constant voltage charging was performed until the current value reached 0.05 C, and then, constant current discharging at 1.0 C was performed up to 3.0 V. In the fourth charge/discharge cycle, constant current charging at 0.5 C was performed up to approximately 4.6 V, constant voltage charging was performed until the current value reached 0.05 C, and then, constant current discharging at 2.0 C was performed up to 3.0 V. Note that here, 1 C was set to 200 mA/g. The environmental temperature of the measurement was 25° C. A post-charging rest period from the completion of charging to the start of discharging and a post-discharging rest period from the completion of discharging to the start of charging were each 10 minutes.

The conditions of the charge/discharge cycling test are described. Constant current charging at 0.5 C was performed up to approximately 4.6 V, and then, constant voltage charging was performed until the current value reached 0.05 C. In the discharging, constant current discharging at 1 C was performed up to 3.0 V. Note that here, 1 C was set to 200 mA/g. The environmental temperature of the measurement was 45° C. A post-charging rest period from the completion of charging to the start of discharging and a post-discharging rest period from the completion of discharging to the start of charging were each 10 minutes. Note that the termination conditions of each of the charging and discharging include a termination time of 20 hours in addition to the above-described voltage and current values.

### <<Ex Situ XRD>>

In the charge/discharge cycles described above, whether the positive electrode active material of one embodiment of the present invention had the crystal structure of lithium cobalt oxide in a discharged state and whether the positive electrode active material had the O3′ phase in a charged state were examined.

For analysis of discharged states, a plurality of half cells that underwent the discharge rate test were prepared. Then, the following three post-discharging XRD measurements were performed: an XRD measurement of the half cell disassembled after one charge/discharge cycle under the conditions of the above charge/discharge cycling test; an XRD measurement of the half cell disassembled after five charge/discharge cycles under the conditions of the above charge/discharge cycling test; and an XRD measurement of the half cell disassembled after 30 charge/discharge cycles under the conditions of the above charge/discharge cycling test.

For post-charging XRD measurements, a plurality of half cells that underwent the discharge rate test were prepared. Charging and discharging similar to those in the above discharge rate test were performed. Then, the following three post-charging XRD measurements were performed: an XRD measurement of the half cell disassembled after charging following one charge/discharge cycle under the conditions of the above charge/discharge cycling test; an XRD measurement of the half cell disassembled after charging following five charge/discharge cycles under the conditions of the above charge/discharge cycling test; and an XRD measurement of the half cell disassembled after charging following 30 charge/discharge cycles under the conditions of the above charge/discharge cycling test.

For each measurement, the half cell was disassembled within one hour after the completion of charging or discharging. Specifically, the half cells in the charged states were disassembled carefully; the positive electrodes were extracted as they are in the high-voltage charged states, by using an insulating tool to avoid a short circuit. For the disassembly, an argon-filled glove box in which the dew point and the oxygen concentration were controlled was used. Note that the dew point of the glove box is preferably lower than or equal to −70° C., and the oxygen concentration is preferably lower than or equal to 5 ppm. Since the crystal structure of the positive electrode active material might be changed by self-discharging after a long time elapses from the above charging, disassembly and analysis are preferably performed as early as possible.

In the glove box, the above positive electrode obtained by disassembling the half cell was put in a sealable sample holder for XRD measurement. The sample holder was set on a stage of the XRD apparatus, so that the positive electrode was kept in an argon atmosphere during the XRD measurement.

After that, the XRD measurements were started within 15 minutes. The XRD apparatus and conditions are as follows.
XRD apparatus: D8 ADVANCE produced by Bruker AXS
X-ray: Cu Kα₁ radiation
Output: 40 kV, 40 mA
Angle of divergence: Div. Slit, 0.5°
Detector: LynxEye
Scanning method: 2010 continuous scan
Measurement range (2θ): from 15° to 75°
Step width (2θ): 0.01°
Counting time: one sec/step
Rotation of sample stage: 15 rpm

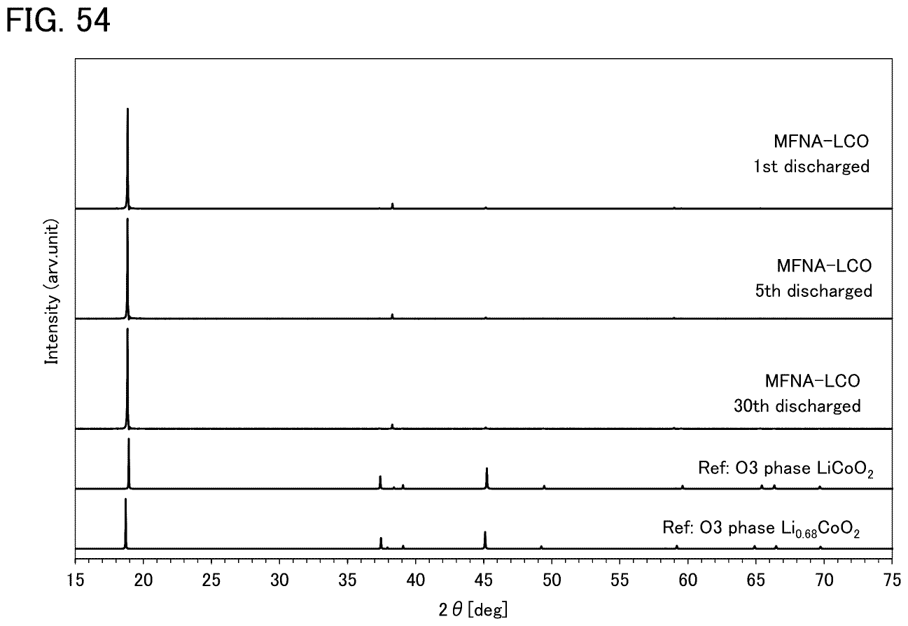

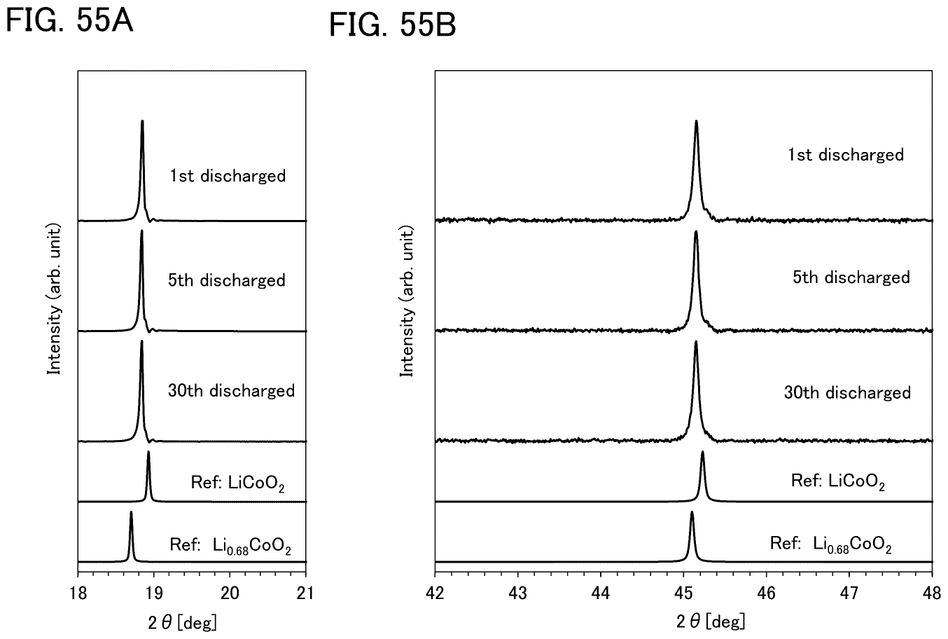

FIG. 54 shows XRD patterns of the positive electrodes after discharging. The patterns of lithium cobalt oxide LiCoO₂, which is the stoichiometric O3 phase, and Li_{0.68}CoO₂, which is a lithium-deficient O3 phase, are also shown as references. FIG. 55A shows an enlarged graph within the range of 18° to 21° in FIG. 54, and FIG. 55B shows an enlarged graph within the range of 42° to 48° in FIG. 54. The results suggest that the positive electrode including the positive electrode active material of one embodiment of the present invention exhibits a sharp peak even after 30 cycles at 45° C., and that the crystallinity is not lowered by discharging.

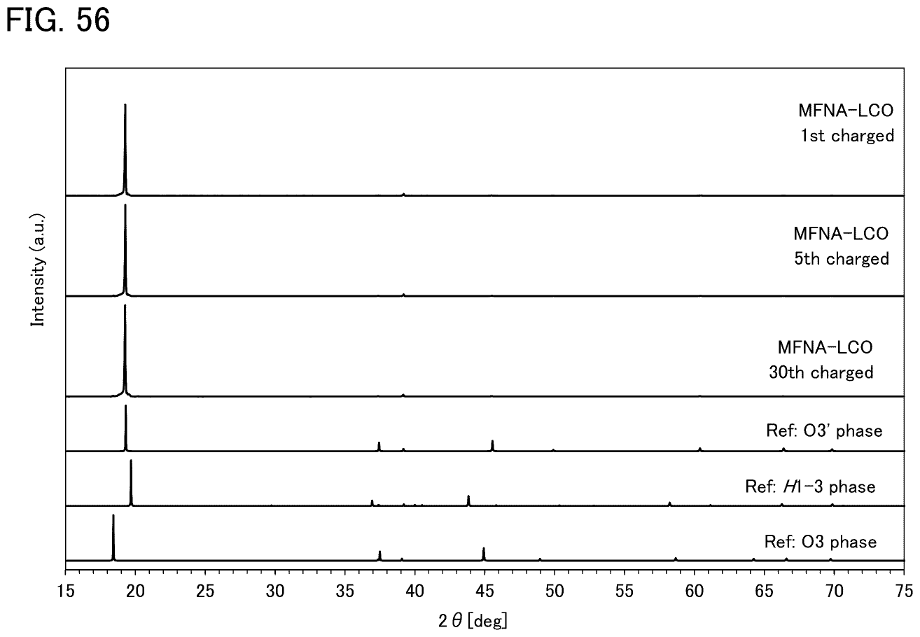

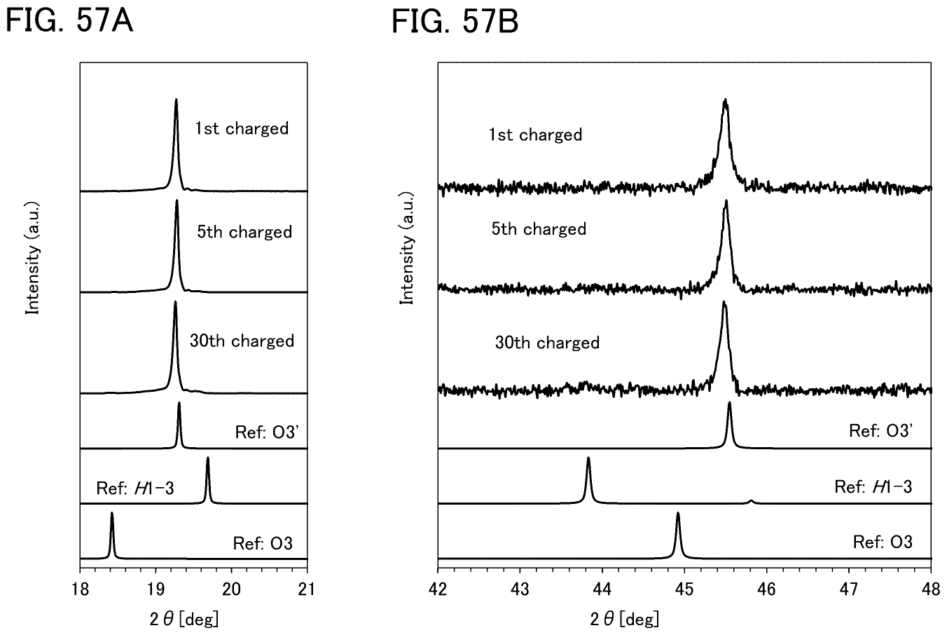

FIG. 56 shows XRD patterns of the positive electrodes after charging. Patterns of the O3′ phase, the H1-3 phase, and the O3 (Li_{0.35}CoO₂) phase are also shown as references. FIG. 57A shows an enlarged graph within the range of 18° to 21° in FIG. 56, and FIG. 57B shows an enlarged graph within the range of 42° to 48° in FIG. 56. The patterns of the positive electrode including the positive electrode active material of one embodiment of the present invention in the high-voltage charged states are substantially the same as the reference pattern of the O3′ phase (O3′). That is, it is confirmed that the positive electrode active material of one embodiment of the present invention has the O3′ phase after charging following one cycle, after charging following five cycles, and after charging following 30 cycles. Thus, in a battery including the positive electrode active material of one embodiment of the present invention, the O3′ phase can be maintained even when charge/discharge cycles are repeated a large number of times, which is presumably a factor in enabling the battery to have high charge/discharge cycling performance.

This application is based on Japanese Patent Application Serial No. 2023-186796 filed with Japan Patent Office on Oct. 31, 2023, Japanese Patent Application Serial No. 2023-200455 filed with Japan Patent Office on Nov. 28, 2023, Japanese Patent Application Serial No. 2024-022686 filed with Japan Patent Office on Feb. 19, 2024, and Japanese Patent Application Serial No. 2024-063843 filed with Japan Patent Office on Apr. 11, 2024, the entire contents of which are hereby incorporated by reference.

What is claimed is:

1. A positive electrode active material comprising:
a positive electrode active material particle comprising a surface portion and a bulk region,
wherein the positive electrode active material particle comprises lithium cobalt oxide, magnesium, fluorine, nickel, and aluminum,
wherein the positive electrode active material in a discharged state has a layered rock salt crystal structure belonging to an R-3m space group,
wherein the layered rock salt crystal structure in the discharged state has a c lattice parameter greater than 14.055 Å and has GOF less than or equal to 1.4 when fitted as LiCoO₂ with the R-3m space group and subjected to Rietveld refinement,
wherein the surface portion comprises a magnesium-rich rock salt structure region, and
wherein the magnesium-rich rock salt structure region is coherently bonded to the bulk region.

2. The positive electrode active material according to claim 1, wherein the c lattice parameter is less than 14.060 Å.

3. The positive electrode active material according to claim 1, wherein magnesium, fluorine, nickel, and aluminum are in the surface portion.

4. The positive electrode active material according to claim 1,
wherein volumetric energy density calculated using true density of the positive electrode active material is higher than or equal to 4250 Wh/L, and
wherein gravimetric energy density calculated using true density of the positive electrode active material is higher than or equal to 865 Wh/kg.

5. A secondary battery comprising:
the positive electrode active material according to claim 4; and
an electrolyte solution,
wherein the electrolyte solution comprises 1 M LiPF₆ dissolved in FEC/MTFP at a volume ratio of 2:8 with 5 wt % PS.

6. The positive electrode active material according to claim 1, wherein when a cross section of the positive electrode active material particle is analyzed with an electron probe microanalyzer, an atomic ratio Mg/Co is greater than or equal to 0.005 and less than or equal to 0.015 and an atomic ratio Al/Co is less than or equal to 0.005.

7. A positive electrode active material comprising:
a positive electrode active material particle comprising lithium cobalt oxide, magnesium, fluorine, nickel, and aluminum,
wherein a narrow-scan spectrum of Mg 1s of the positive electrode active material obtained by X-ray photoelectron spectroscopy exhibits a maximum intensity at a binding energy between a binding energy at which a narrow-scan spectrum of Mg 1s of magnesium oxide obtained by X-ray photoelectron spectroscopy exhibits a maximum intensity and a binding energy at which a narrow-scan spectrum of Mg 1s of magnesium fluoride obtained by X-ray photoelectron spectroscopy exhibits a maximum intensity.

8. The positive electrode active material according to claim 7, wherein the narrow-scan spectrum of Mg 1s of the positive electrode active material obtained by X-ray photoelectron spectroscopy exhibits the maximum intensity at a binding energy greater than 1303.3 eV and less than 1306.3 eV.

9. The positive electrode active material according to claim 8, wherein when a cross section of the positive electrode active material particle is analyzed with an electron probe microanalyzer, an atomic ratio Mg/Co is greater than or equal to 0.005 and less than or equal to 0.015 and an atomic ratio Al/Co is less than or equal to 0.005.

10. The positive electrode active material according to claim 7,
wherein the positive electrode active material comprises a surface portion and a bulk region, and
wherein magnesium, fluorine, nickel, and aluminum are in the surface portion.

11. The positive electrode active material according to claim 7,
wherein volumetric energy density calculated using true density of the positive electrode active material is higher than or equal to 4250 Wh/L, and
wherein gravimetric energy density calculated using true density of the positive electrode active material is higher than or equal to 865 Wh/kg.

12. A secondary battery comprising:
the positive electrode active material according to claim 11; and
an electrolyte solution,
wherein the electrolyte solution comprises 1 M LiPF₆ dissolved in FEC/MTFP at a volume ratio of 2:8 with 5 wt % PS.

13. A positive electrode active material comprising:
a positive electrode active material particle comprising lithium cobalt oxide, magnesium, fluorine, nickel, and aluminum,
wherein the positive electrode active material in a discharged state has a layered rock salt crystal structure belonging to an R-3m space group,
wherein when a positive electrode comprising the positive electrode active material in a discharged state is analyzed by powder X-ray diffraction using Cu Kα₁ radiation after a charge/discharge cycling test, a peak with a half width less than or equal to 0.08° is detected within a 2θ range of 18.7° to 19.0°, and a peak with a half width less than or equal to 0.12° is detected within a 2θ range of 45.0° to 45.3°, the charge/discharge cycling test being conducted under a 25° C.-environment on a cell which comprises the positive electrode, lithium metal as a negative electrode, and a mixture of lithium hexafluorophosphate, ethylene carbonate, and diethyl carbonate with 2 wt % vinylene carbonate as an electrolyte solution,
wherein, in the charge/discharge cycling test, a charge/discharge cycle in which constant current charging at a current value of 0.5 C is performed up to a voltage of 4.7 V, constant voltage charging is performed until the current value reaches 0.05 C, a rest period of 10 minutes is allowed, constant current discharging at a current value of 0.5 C is performed up to a voltage of 2.5 V, and then, a rest period of 10 minutes is allowed is repeated 100 times, and
wherein 1 C=200 mA/g.

14. The positive electrode active material according to claim 13,
wherein the positive electrode active material comprises a surface portion and a bulk region, and
wherein magnesium, fluorine, nickel, and aluminum are in the surface portion.

15. The positive electrode active material according to claim 13,
wherein volumetric energy density calculated using true density of the positive electrode active material is higher than or equal to 4250 Wh/L, and
wherein gravimetric energy density calculated using true density of the positive electrode active material is higher than or equal to 865 Wh/kg.

16. A secondary battery comprising:
the positive electrode active material according to claim 15; and
an electrolyte solution,
wherein the electrolyte solution comprises 1 M LiPF₆ dissolved in FEC/MTFP at a volume ratio of 2:8 with 5 wt % PS.
